(19) United States
(12) Patent Application Publication
(10) Pub. No.: US 2026/0268846 A1
(43) Pub. Date: Sep. 10, 2026

(54) PIXEL CIRCUIT AND DRIVING METHOD THEREOF, DISPLAY APPARATUS

(71) Applicants: HEFEI BOE JOINT TECHNOLOGY CO., LTD., Hefei (CN); BOE TECHNOLOGY GROUP CO.,LTD., Beijing (CN)

(72) Inventors: Xuehuan FENG, Beijing (CN); Gen LI, Beijing (CN); Xiaoqiang XIONG, Beijing (CN); Wei LI, Beijing (CN); Heng YANG, Beijing (CN); Zhengxing DU, Beijing (CN); Yinglong HUANG, Beijing (CN); Yongqian LI, Beijing (CN)

(21) Appl. No.: 18/994,907

(22) PCT Filed: Mar. 22, 2024
(86) PCT No.: PCT/CN2024/083283

§ 371 Date: Jan. 15, 2025

(30) Foreign Application Priority Data
Aug. 17, 2023 (WO) PCT/CN2023/113514

(51) Int. Cl. G09G 3/3233

(52) U.S. Cl. CPC G09G 3/3233; G09G 2300/0819; G09G 2300/0852; G09G 2300/0861; G09G 2310/08; G09G 2320/0233; G09G 2320/0257; G09G 2330/021

(57) ABSTRACT

A pixel circuit, a driving method thereof and a display apparatus are provided, the pixel circuit includes a driving circuit, a first compensation circuit, a light-emitting element, a second light-emitting control circuit and a reset control circuit, the first compensation circuit includes a first storage capacitor; a control terminal of the reset control circuit is configured to receive a reset control signal, a first terminal of the reset control circuit is electrically connected to the first terminal of the driving circuit, a second terminal of the reset control circuit is electrically connected to a reset signal terminal to receive the reset signal, a third terminal of the reset control circuit is electrically connected to the first electrode of the light-emitting element, and the reset control circuit is configured to apply the reset signal to the first electrode of the light-emitting element and/or the first terminal of the driving circuit.

The present application claims the priority of the Patent Application No. PCT/CN2023/113514 filed on Aug. 17, 2023, the entire contents disclosed by the above patent application are hereby incorporated by reference.

### TECHNICAL FIELD

At least one embodiment of the present disclosure relates to a pixel circuit and a driving method thereof, and a display apparatus.

### BACKGROUND

With continuous development of display technology, Organic Light-Emitting Diodes (OLED) and Quantum-dot Light-Emitting Diodes (QLED) are active light-emitting display devices with advantages of self-luminescence, wide viewing angle, high contrast, low power consumption, extremely high response speed, light weight, bendability and low cost.

### SUMMARY

At least one embodiment of the disclosure provides a pixel circuit and a driving method thereof, and a display apparatus.

At least one embodiment of the disclosure provides a pixel circuit, which includes a driving circuit, a first compensation circuit, a light-emitting element, a second light-emitting control circuit and a reset control circuit, the driving circuit includes a control terminal, a first terminal and a second terminal, and is configured to control a magnitude of a driving current flowing through the first terminal and the second terminal; the first compensation circuit is configured to apply a reference signal to the control terminal of the driving circuit in response to a first compensation control signal, the first compensation circuit includes a first storage capacitor, a first electrode of the first storage capacitor is electrically connected to the control terminal of the driving circuit, and a second electrode of the first storage capacitor is electrically connected to the first terminal of the driving circuit; the light-emitting element is configured to emit light driven by the driving current, a second electrode of the light-emitting element is electrically connected to a second voltage terminal to receive a second power supply voltage; a control terminal of the second light-emitting control circuit is configured to receive a second light-emitting control signal, a first terminal of the second light-emitting control circuit is electrically connected to the first terminal of the driving circuit, a second terminal of the second light-emitting control circuit is electrically connected to a first electrode of the light-emitting element, and the second light-emitting control circuit is configured to apply the driving current to the light-emitting element in response to the second light-emitting control signal and allow a reset signal to be applied to the first terminal of the driving circuit; a control terminal of the reset control circuit is configured to receive a reset control signal, a first terminal of the reset control circuit is electrically connected to the first terminal of the driving circuit, a second terminal of the reset control circuit is electrically connected to a reset signal terminal to receive the reset signal, a third terminal of the reset control circuit is electrically connected to the first electrode of the light-emitting element, and the reset control circuit is configured to apply the reset signal to the first electrode of the light-emitting element and/or the first terminal of the driving circuit in response to the reset control signal.

For example, in the pixel circuit according to at least one embodiment of the disclosure, the reset control circuit includes a second compensation circuit and a reset circuit, the second compensation circuit includes a second storage capacitor, the second storage capacitor is electrically connected between the first terminal of the driving circuit and the reset signal terminal; and a control terminal of the reset circuit serves as the control terminal of the reset control circuit and is configured to receive the reset control signal, a first terminal of the reset circuit serves as the third terminal of the reset control circuit and is electrically connected to the first electrode of the light-emitting element, and a second terminal of the reset circuit serves as the second terminal of the reset control circuit and is electrically connected to the reset signal terminal to receive the reset signal.

For example, in the pixel circuit according to at least one embodiment of the disclosure, a value of the reset signal is adjustable.

For example, in the pixel circuit according to at least one embodiment of the disclosure, the reset signal includes at least a first reset signal and a second reset signal, the first reset signal corresponds to a first display temperature, the second reset signal corresponds to a second display temperature, the first display temperature is lower than the second display temperature, and a value of the first reset signal is lower than a value of the second reset signal.

For example, in the pixel circuit according to at least one embodiment of the disclosure, the first reset signal is adjusted to the second reset signal during a reset signal adjustment period, and the pixel circuit corresponds to a plurality of display frame cycles, the reset signal adjustment period is located between two adjacent display frame cycles of the plurality of display frame cycles; or the reset signal adjustment period is located within one display frame cycle of the plurality of display frame cycles; the one display frame cycle includes at least a reset phase, a compensation phase, a data writing phase and a light-emitting phase; and the reset signal adjustment period overlaps at least partially or does not overlap with any one selected from a group consisting of the reset phase, the compensation phase, the data writing phase and the light-emitting phase.

For example, in the pixel circuit according to at least one embodiment of the disclosure, a value of the reference signal is adjustable.

For example, in the pixel circuit according to at least one embodiment of the disclosure, a first electrode of the second storage capacitor serves as the first terminal of the reset control circuit and is electrically connected to the first terminal of the driving circuit, and a second electrode of the second storage capacitor is electrically connected to the first terminal of the reset circuit.

For example, the pixel circuit according to at least one embodiment of the disclosure further includes a first light-emitting control circuit, a control terminal of the first light-emitting control circuit is configured to receive a first light-emitting control signal, a first terminal of the first light-emitting control circuit is electrically connected to the second terminal of the driving circuit, a second terminal of the first light-emitting control circuit is electrically connected to a first voltage terminal to receive a first power supply voltage, and the first light-emitting control circuit is configured to apply the first power supply voltage to the second terminal of the driving circuit in response to the first light-emitting control signal.

For example, in the pixel circuit according to at least one embodiment of the disclosure, the first light-emitting control circuit includes a first light-emitting control transistor, a gate electrode of the first light-emitting control transistor is electrically connected to a first light-emitting control terminal to receive the first light-emitting control signal, a first electrode of the first light-emitting control transistor is electrically connected to the second terminal of the driving circuit, and a second electrode of the first light-emitting control transistor is electrically connected to the first voltage terminal to receive the first power supply voltage.

For example, in the pixel circuit according to at least one embodiment of the disclosure, the second terminal of the driving circuit is directly electrically connected to a first voltage terminal to receive a first power supply voltage.

For example, in the pixel circuit according to at least one embodiment of the disclosure, the reset circuit includes a reset transistor, a gate electrode of the reset transistor is electrically connected to a reset control terminal to receive the reset control signal, a first electrode of the reset transistor is electrically connected to the second electrode of the second storage capacitor and the first terminal of the driving circuit, and a second electrode of the reset transistor is electrically connected to the reset signal terminal to receive the reset signal.

For example, in the pixel circuit according to at least one embodiment of the disclosure, the second light-emitting control circuit includes a second light-emitting control transistor, a gate electrode of the second light-emitting control transistor is electrically connected to a second light-emitting control terminal to receive the second light-emitting control signal, a first electrode of the second light-emitting control transistor is electrically connected to the first terminal of the driving circuit, and a second electrode of the second light-emitting control transistor is electrically connected to the first electrode of the light-emitting element.

For example, the pixel circuit according to at least one embodiment of the disclosure further includes an auxiliary compensation circuit, a control terminal of the auxiliary compensation circuit is configured to receive an auxiliary compensation signal, a first terminal of the auxiliary compensation circuit is electrically connected to the second electrode of the second storage capacitor, and a second terminal of the auxiliary compensation circuit is electrically connected to the first electrode of the light-emitting element.

For example, in the pixel circuit according to at least one embodiment of the disclosure, the first terminal of the auxiliary compensation circuit is also electrically connected to the second terminal of the second light-emitting control circuit and the first terminal of the reset circuit.

For example, in the pixel circuit according to at least one embodiment of the disclosure, the auxiliary compensation circuit includes an auxiliary compensation transistor, a gate electrode of the auxiliary compensation transistor serves as the control terminal of the auxiliary compensation circuit to receive the auxiliary compensation control signal, a first electrode of the auxiliary compensation transistor is electrically connected to the second electrode of the second compensation capacitor and the second electrode of the second light-emitting control transistor, and a second electrode of the auxiliary compensation transistor is electrically connected to the first electrode of the light-emitting element.

For example, in the pixel circuit according to at least one embodiment of the disclosure, the first terminal of the auxiliary compensation circuit is also electrically connected to the first terminal of the reset circuit, and the second terminal of the auxiliary compensation circuit is also electrically connected to the second terminal of the second light-emitting control circuit.

For example, in the pixel circuit according to at least one embodiment of the disclosure, the auxiliary compensation circuit includes an auxiliary compensation transistor, a gate electrode of the auxiliary compensation transistor is electrically connected to an auxiliary compensation control terminal to receive the auxiliary compensation control signal, a first electrode of the auxiliary compensation transistor is electrically connected to the second electrode of the second compensation capacitor and the first electrode of the reset transistor, and a second electrode of the auxiliary compensation transistor is electrically connected to the first electrode of the light-emitting element.

For example, in the pixel circuit according to at least one embodiment of the disclosure, the gate electrode of the auxiliary compensation transistor is electrically connected to the gate electrode of the second light-emitting control transistor, the auxiliary compensation transistor and the second light-emitting control transistor share a gate electrode, the second light-emitting control signal serves as the auxiliary compensation control signal, and a type of the auxiliary compensation transistor is same as a type of the second light-emitting control transistor; or the gate electrode of the auxiliary compensation transistor and the gate electrode of the second light-emitting control transistor are independent of each other and not electrically connected.

For example, in the pixel circuit according to at least one embodiment of the disclosure, the gate electrode of the auxiliary compensation transistor is electrically connected to the gate electrode of the reset transistor, the auxiliary compensation transistor and the reset transistor share a gate electrode, the reset control signal serves as the auxiliary compensation control signal, and a type of the auxiliary compensation transistor is same as a type of the reset transistor; or the gate electrode of the auxiliary compensation transistor and the gate electrode of the reset transistor are independent of each other and not electrically connected.

For example, in the pixel circuit according to at least one embodiment of the disclosure, the driving circuit includes a driving transistor, a gate electrode of the driving transistor serves as the control terminal of the driving circuit and is electrically connected to a first node, a first electrode of the driving transistor serves as the first terminal of the driving circuit and is electrically connected to a first electrode of the second storage capacitor at a second node, and a second electrode of the driving transistor serves as the second terminal of the driving circuit and is electrically connected to a first voltage terminal to receive a first power supply voltage; the pixel circuit further includes: a data writing circuit, a control terminal of the data writing circuit is configured to receive a data scanning signal, a first terminal of the data writing circuit is electrically connected to a data signal terminal to receive a data signal, a second terminal of the data writing circuit is electrically connected to the first node, and the data writing circuit is configured to write the data signal to the control terminal of the driving circuit in response to the data scanning signal.

For example, in the pixel circuit according to at least one embodiment of the disclosure, a control terminal of the first compensation circuit is configured to receive the first compensation control signal, a first terminal of the first compensation circuit is electrically connected to a reference signal terminal to receive the reference signal, and a second terminal of the first compensation circuit is electrically connected to the second node, the first compensation circuit further includes a first compensation transistor, a gate electrode of the first compensation transistor serves as the control terminal of the first compensation circuit and is electrically connected to a first compensation control signal terminal to receive the first compensation control signal, a first electrode of the first compensation transistor serves as the first terminal of the first compensation circuit and is electrically connected to the reference signal terminal to receive the reference signal, and a second electrode of the first compensation transistor is electrically connected to the first node, the data writing circuit includes a data writing transistor, a gate electrode of the data writing transistor is electrically connected to a data scanning signal terminal to receive the data scanning signal, a first electrode of the data writing transistor is electrically connected to the data signal terminal to receive the data signal, and a second electrode of the data writing transistor is electrically connected to the first node.

For example, in the pixel circuit according to at least one embodiment of the disclosure, the data writing transistor and the first compensation transistor are transistors controlled independently of each other, the data scanning signal terminal and the first compensation control signal terminal are different signal terminals independent of each other, and the data signal terminal and the reference signal terminal are different signal terminals independent of each other; or the data writing transistor also serves the first compensation transistor, the data scanning signal also serves the first compensation control signal, the first electrode of the data writing transistor is also electrically connected to the reference signal terminal to receive the reference signal, and the data signal terminal also serves the reference signal terminal and is configured to provide the data signal or the reference signal in different time periods.

At least one embodiment of the disclosure further provides a display apparatus, which includes the pixel circuit according to any embodiments as mentioned above.

At least one embodiment of the disclosure further provides a driving method, which is applicable to the pixel circuit according to any embodiments as mentioned above, the driving method includes: setting the reset control signal as an On signal so that the reset signal is applied to the first electrode of the light-emitting element and/or the first terminal of the driving circuit through the reset control circuit.

For example, in the driving method according to at least one embodiment of the disclosure, the reset control circuit includes a second compensation circuit and a reset circuit, and the second compensation circuit includes a second storage capacitor, a first electrode of the second storage capacitor serves as the first terminal of the reset control circuit and is electrically connected to the first terminal of the driving circuit, and a second electrode of the second storage capacitor is electrically connected to a first terminal of the reset circuit; a control terminal of the reset circuit serves as the control terminal of the reset control circuit and is configured to receive the reset control signal, a first terminal of the reset circuit serves as the third terminal of the reset control circuit and is electrically connected to the first electrode of the light-emitting element, a second terminal of the reset circuit serves as the second terminal of the reset control circuit and is electrically connected to the reset signal terminal to receive the reset signal, the driving method includes a reset phase, a compensation phase, a data writing phase and a light-emitting phase, in the reset phase, the reset control signal is set to be an ON signal in at least part of a time period so that the first terminal and the second terminal of the reset circuit are turned on, and the reset signal is applied to the second electrode of the second storage capacitor, the first terminal of the driving circuit and the first electrode of the light-emitting element through the second terminal and the first terminal of the reset circuit in sequence; in the compensation phase and the data writing phase, the reset control signal is set to be an ON signal, and the reset signal is applied to the second electrode of the second storage capacitor and the first electrode of the light-emitting element through the second terminal and the first terminal of the reset circuit in sequence; and in the light-emitting phase, the reset control signal is set to be an OFF signal in at least part of a time period of the light-emitting phase, so that the second electrode of the second storage capacitor is electrically disconnected from the reset signal terminal.

For example, in the driving method according to at least one embodiment of the disclosure, the pixel circuit further includes a data writing circuit and a first light-emitting control circuit; a control terminal of the data writing circuit is configured to receive a data scanning signal, a first terminal of the data writing circuit is electrically connected to a data signal terminal to receive a data signal, and a second terminal of the data writing circuit is electrically connected to the control terminal of the driving circuit; a control terminal of the first light-emitting control circuit is configured to receive a first light-emitting control signal, a first terminal of the first light-emitting control circuit is electrically connected to the second terminal of the driving circuit, and a second terminal of the first light-emitting control circuit is electrically connected to a first voltage terminal so that the second terminal of the driving circuit receives a first power supply voltage; in the light-emitting phase, the driving method includes sequentially performing steps S101 to S104; step S101: setting the data scanning signal as an OFF signal to turn off the data writing circuit; step S102: setting the second light-emitting control signal to an ON signal to turn on the second light-emitting control circuit, and keeping the first light-emitting control signal as an OFF signal to turn off the first light-emitting control circuit; and step S104: setting the first light-emitting control signal to an ON signal to turn on the first light-emitting control circuit, so that the second terminal of the driving circuit receives the first power supply voltage from the first voltage terminal through the first light-emitting control circuit.

For example, in the driving method according to at least one embodiment of the disclosure, the pixel circuit further includes a data writing circuit and a first light-emitting control circuit; a control terminal of the data writing circuit is configured to receive a data scanning signal, a first terminal of the data writing circuit is electrically connected to a data signal terminal to receive a data signal, and a second terminal of the data writing circuit is electrically connected to the control terminal of the driving circuit; a control terminal of the first light-emitting control circuit is configured to receive a first light-emitting control signal, a first terminal of the first light-emitting control circuit is electrically connected to the second terminal of the driving circuit, and a second terminal of the first light-emitting control circuit is electrically connected to a first voltage terminal so that the second terminal of the driving circuit receives a first power supply voltage; in the reset phase, the driving method includes sequentially performing steps S1010 to S1030; step S1010: electrically disconnecting the second terminal of the driving circuit from the first voltage terminal; step S1020: setting the reset control signal as an ON signal to turn on the reset circuit; and step S1030: setting the first compensation control signal as an ON signal to turn on the first compensation circuit, and, in the reset phase, the data scanning signal remains as an OFF signal to turn off the data writing circuit, and the second light-emitting control signal remains as an ON signal to turn on the second light-emitting control circuit.

For example, in the driving method according to at least one embodiment of the disclosure, in the compensation phase, the driving method includes sequentially performing steps S2010 to S2020; step S2010: setting the second light-emitting control signal as an OFF signal to turn off the second light-emitting control circuit, and keeping the first light-emitting control signal as an OFF signal to turn off the first light-emitting control circuit; step S2020: setting the first light-emitting control signal as an ON signal to turn on the first light-emitting control circuit, and keeping the second light-emitting control signal as an OFF signal; and, in the compensation phase, the data scanning signal remains as an OFF signal to keep the data writing circuit turned off, and the first compensation control signal remains as an ON signal to keep the first compensation circuit turned on.

For example, in the driving method according to at least one embodiment of the disclosure, the pixel circuit further includes a data writing circuit, a control terminal of the data writing circuit is configured to receive a data scanning signal, a first terminal of the data writing circuit is electrically connected to a data signal terminal to receive a data signal, and a second terminal of the data writing circuit is electrically connected to the control terminal of the driving circuit, in the data writing phase, the driving method includes sequentially performing steps S3010 to S3030; step S3010: setting the first compensation control signal as an OFF signal to turn off the first compensation circuit, and keeping the second terminal of the driving circuit receiving a first power supply voltage; step S3030: setting the data scanning signal as an ON signal to turn on the data writing circuit; and, in the data writing phase, the second light-emitting control signal remains as an OFF signal to keep the second light-emitting control circuit turned off.

For example, in the driving method according to at least one embodiment of the disclosure, the pixel circuit further includes a first light-emitting control circuit, a control terminal of the first light-emitting control circuit is configured to receive a first light-emitting control signal, a first terminal of the first light-emitting control circuit is electrically connected to the second terminal of the driving circuit, and a second terminal of the first light-emitting control circuit is electrically connected to a first voltage terminal so that the second terminal of the driving circuit receives a first power supply voltage; and the step S3030 further includes: setting the first light-emitting control signal as an ON signal to turn on the first light-emitting control circuit, so that the second terminal of the driving circuit receives the first power supply voltage.

### BRIEF DESCRIPTION OF DRAWINGS

In order to more clearly illustrate the technical solutions of the embodiments of the present disclosure, the accompanying drawings of the embodiments will be briefly described below, and it will be apparent that the accompanying drawings in the following description relate only to some of the embodiments of the present disclosure and are not a limitation of the present disclosure.

FIG. 1 is a schematic block diagram of a pixel circuit provided by at least one embodiment of the present disclosure.

FIG. 2 is a circuit diagram of an implementation example of the pixel circuit shown in FIG. 1.

FIG. 3 is a signal timing diagram of a driving method provided by at least one embodiment of the present disclosure.

FIG. 4A is a schematic diagram of the pixel circuit in FIG. 2 in a third sub-reset phase.

FIG. 4B is a schematic diagram of the pixel circuit in FIG. 2 in a second sub-compensation phase.

FIG. 4C is a schematic diagram of the pixel circuit in FIG. 2 in a third sub-data writing phase.

FIG. 4D is a schematic diagram of the pixel circuit in FIG. 2 in a fourth sub-light-emitting phase.

FIG. 4E is a signal timing diagram of another driving method provided by at least one embodiment of the present disclosure.

FIG. 5 is a schematic diagram of another pixel circuit provided by an embodiment of the present disclosure.

FIG. 6 is a signal timing diagram corresponding to the pixel circuit shown in FIG. 5.

FIG. 7A is a schematic diagram of the pixel circuit in FIG. 5 in a third sub-reset phase.

FIG. 7B is a schematic diagram of the pixel circuit in FIG. 5 in a second sub-compensation phase.

FIG. 7C is a schematic diagram of the pixel circuit in FIG. 5 in a third sub-data writing phase.

FIG. 7D is a schematic diagram of the pixel circuit in FIG. 5 in a fourth sub-light-emitting phase.

FIG. 8 is a schematic block diagram of another pixel circuit provided by at least one embodiment of the present disclosure.

FIG. 9 is a circuit diagram of an implementation example of the pixel circuit shown in FIG. 8.

FIG. 10 is a signal timing diagram corresponding to the pixel circuit shown in FIG. 9.

FIG. 11A is a schematic diagram of the pixel circuit shown in FIG. 9 in a third sub-reset phase.

FIG. 11B is a schematic diagram of the pixel circuit shown in FIG. 9 in a second sub-compensation phase.

FIG. 11C is a schematic diagram of the pixel circuit shown in FIG. 9 in a third sub-data writing phase.

FIG. 11D is a schematic diagram of the pixel circuit shown in FIG. 9 in a fourth sub-light-emitting phase.

FIG. 12 is a schematic diagram of another pixel circuit provided by an embodiment of the present disclosure.

FIG. 13 is a signal timing diagram corresponding to the pixel circuit shown in FIG. 12.

FIG. 14A is a schematic diagram of the pixel circuit in FIG. 12 in a second sub-compensation phase.

FIG. 14B is a schematic diagram of the pixel circuit in FIG. 12 in a third sub-data writing phase.

FIG. 14C is a schematic diagram of the pixel circuit in FIG. 12 in a fourth sub-light-emitting phase.

FIG. 15 is a schematic block diagram of another pixel circuit provided by at least one embodiment of the present disclosure.

FIG. 16 is a circuit diagram of an implementation example of the pixel circuit shown in FIG. 15.

FIG. 17 is a signal timing diagram of another driving method provided by at least one embodiment of the present disclosure.

FIG. 18A is a schematic diagram of the pixel circuit shown in FIG. 15 in a third sub-reset phase.

FIG. 18B is a schematic diagram of the pixel circuit shown in FIG. 15 in a second sub-compensation phase.

FIG. 18C is a schematic diagram of the pixel circuit shown in FIG. 15 in a third sub-data writing phase.

FIG. 18D is a schematic diagram of the pixel circuit shown in FIG. 15 in a fourth sub-light-emitting phase.

FIG. 19 is a schematic block diagram of another pixel circuit provided by at least one embodiment of the present disclosure.

FIG. 20 is a circuit diagram of an implementation example of the pixel circuit shown in FIG. 19.

FIG. 21 is a signal timing diagram of another driving method provided by at least one embodiment of the present disclosure.

FIG. 22A is a schematic diagram of the pixel circuit in FIG. 20 in a third sub-reset phase.

FIG. 22B is a schematic diagram of the pixel circuit in FIG. 20 in a second sub-compensation phase.

FIG. 22C is a schematic diagram of the pixel circuit in FIG. 20 in a third sub-data writing phase.

FIG. 22D is a schematic diagram of the pixel circuit in FIG. 20 in a fourth sub-light-emitting phase.

FIG. 23 is a schematic block diagram of another pixel circuit provided by at least one embodiment of the present disclosure.

FIG. 24 is a circuit diagram of an implementation example of the pixel circuit shown in FIG. 23.

FIG. 25 is a signal timing diagram of another driving method provided by at least one embodiment of the present disclosure.

FIG. 26A is a schematic diagram of the pixel circuit in FIG. 24 in a third sub-reset phase.

FIG. 26B is a schematic diagram of the pixel circuit in FIG. 24 in a second sub-compensation phase.

FIG. 26C is a schematic diagram of the pixel circuit in FIG. 24 in a third sub-data writing phase.

FIG. 26D is a schematic diagram of the pixel circuit in FIG. 24 in a fourth sub-light-emitting phase.

FIG. 27 is a schematic diagram of a reset voltage changing with temperature in at least one embodiment of the present disclosure.

FIG. 28 is a schematic diagram of brightness of a light-emitting element changing with grayscale in at least one embodiment of the present disclosure.

FIG. 29 is a schematic diagram of a reset voltage changing with temperature in at least one embodiment of the present disclosure.

FIG. 30 is a schematic diagram of a reference voltage changing with temperature in at least one embodiment of the present disclosure.

FIG. 31 is a structural schematic diagram of another pixel driving circuit provided in an embodiment of the present disclosure.

FIG. 32 is an equivalent circuit diagram 1 including a third control sub-circuit shown in FIG. 31.

FIG. 33 is an equivalent circuit diagram 2 including the third control sub-circuit shown in FIG. 31.

FIG. 34 is an equivalent circuit diagram 3 including the third control sub-circuit shown in FIG. 31.

FIG. 35 is an equivalent circuit diagram 4 including the third control sub-circuit shown in FIG. 31.

FIG. 36 is an equivalent circuit diagram 5 including the third control sub-circuit shown in FIG. 31.

FIG. 37 is an equivalent circuit diagram 6 including the third control sub-circuit shown in FIG. 31.

FIG. 38 is a partial equivalent circuit diagram of another pixel driving circuit provided in an embodiment of the present disclosure.

FIG. 39 is an equivalent circuit diagram 1 of the pixel driving circuit shown in FIG. 38.

FIG. 40 is an equivalent circuit diagram 2 of the pixel driving circuit shown in FIG. 38.

FIG. 41 is an equivalent circuit diagram 3 of the pixel driving circuit shown in FIG. 38.

FIG. 42 is an equivalent circuit diagram 4 of the pixel driving circuit shown in FIG. 38.

FIG. 43 is an equivalent circuit diagram 5 of the pixel driving circuit shown in FIG. 38.

FIG. 44 is an equivalent circuit diagram 6 of the pixel driving circuit shown in FIG. 38.

FIG. 45 is an operating timing diagram of the pixel driving circuits provided in FIG. 39 and FIG. 40.

FIG. 46 is an operating timing diagram of the pixel driving circuit provided in FIG. 41.

FIG. 47 is an operating timing diagram of the pixel driving circuit provided in FIG. 42.

FIG. 48 is an operating timing diagram of the pixel driving circuits provided in FIG. 43 and FIG. 44.

### DETAILED DESCRIPTION

In order to make the purpose, technical solutions and advantages of the embodiments of the present disclosure clearer, the technical solutions of the embodiments of the present disclosure will be described clearly and completely in the following in conjunction with the accompanying drawings of the embodiments of the present disclosure. Obviously, the described embodiments are a part of the embodiments of the present disclosure, and not all of the embodiments. Based on the described embodiments of the present disclosure, all other embodiments obtained by a person of ordinary skill in the art without the need for creative labor fall within the scope of protection of the present disclosure.

Unless otherwise defined, technical or scientific terms used in the present disclosure shall have the ordinary meaning understood by a person of ordinary skill in the art to which the present disclosure belongs. The terms “first”, “second”, and the like as used in the present disclosure do not indicate any order, number, or significance, but are only used to distinguish different components. Words such as “including” or “comprising” and the like are intended to mean that the component or object preceded by the word encompasses the component or object enumerated after the word and its equivalents, and does not exclude other components or objects.

Features such as “perpendicular”, “parallel”, and “the same” as used in embodiments of the present disclosure include “perpendicular”, “parallel”, and “identical” in the strict sense, as well as “substantially perpendicular”, “substantially parallel”, “approximately the same”, etc. that include a certain amount of error, taking into account the measurement and the error associated with the measurement of the particular quantity (i.e., the limitations of the measurement system), which indicates being within a range of acceptable deviations for the particular value as determined by a person of ordinary skill in the art. “Center” in embodiments of the present disclosure may include a location strictly at the geometric center as well as a location approximately at the center within a small area around the geometric center.

In some cases, display apparatus may experience short-term residual images when displaying, meaning that after displaying the same image for a period of time, when the image currently displayed is switched to a next image, the original image partially remains and emerges in the next image, and then after a period of time, the short-term residual image will disappear. The short-term residual image may be caused by a lag effect in the driving transistor of the pixel circuit. The lag effect is mainly due to the shifting of a threshold voltage (Vth) caused by movable ions remaining in holes. When the display apparatus switches images, the Vgs (a voltage difference between the gate electrode and the source electrode of the driving transistor) of the driving transistor in the initialization stage may be different, causing the threshold voltage of the driving transistor to shift.

For example, after the display apparatus has displayed an initial image for a period of time, when the display apparatus switches to a new image, the initial image is partially retained for several hours, thereby affecting the display. Therefore, there is an urgent need to solve a problem of the threshold voltage (Vth) shifting of the driving transistor.

A pixel circuit using oxide has been increasingly applied in display apparatuses. The pixel circuit features a high refresh rate and a manufacturing process with high uniformity. In some pixel circuits, a first electrode of the driving transistor is directly connected to a reset signal terminal, causing fluctuation of a reset signal to affect voltage stability of the first electrode of the driving circuit. In other pixel circuits, the first electrode of the driving transistor is electrically connected to a first light-emitting control transistor, a second electrode of the driving transistor is electrically connected to a light-emitting element through a second light-emitting control transistor, a first electrode of a storage capacitor is electrically connected to the first electrode of the driving transistor, and a second electrode of the storage capacitor is electrically connected to a constant signal terminal to receive a constant signal, for example, the constant signal may be a reset signal. When the above constant signal is unstable, it is easy to cause a voltage of the second electrode of the storage capacitor to fluctuate, thereby causing external noise to be introduced into the pixel circuit. For example, when the pixel circuit enters a light-emitting phase from a data writing phase, the reset signal needs to be switched from an ON signal to an OFF signal, which easily increases a risk of introducing noise into the pixel circuit, thereby causing the driving current to be unstable and affecting a display effect.

At least one embodiment of the present disclosure provides a pixel circuit and a driving method thereof, and a display apparatus.

At least one embodiment of the present disclosure provides a pixel circuit including a driving circuit, a first compensation circuit, a light-emitting element, a second light-emitting control circuit and a reset control circuit, in which the driving circuit includes a control terminal, a first terminal and a second terminal, and is configured to control a magnitude of a driving current flowing through the first terminal and the second terminal; the first compensation circuit is configured to apply a reference signal to the control terminal of the driving circuit in response to a first compensation control signal, the first compensation circuit includes a first storage capacitor, a first electrode of the first storage capacitor is electrically connected to the control terminal of the driving circuit, and a second electrode of the first storage capacitor is electrically connected to the first terminal of the driving circuit; the light-emitting element is configured to emit light driven by the driving current, and a second electrode of the light-emitting element is electrically connected to a second voltage terminal to receive a second power supply voltage; a control terminal of the second light-emitting control circuit is configured to receive a second light-emitting control signal, a first terminal of the second light-emitting control circuit is electrically connected to the first terminal of the driving circuit, a second terminal of the second light-emitting control circuit is electrically connected to a first electrode of the light-emitting element, and the second light-emitting control circuit is configured to apply the driving current to the light-emitting element in response to the second light-emitting control signal and allow a reset signal to be applied to the first terminal of the driving circuit; a control terminal of the reset control circuit is configured to receive a reset control signal, a first terminal of the reset control circuit is electrically connected to the first terminal of the driving circuit, a second terminal of the reset control circuit is electrically connected to a reset signal terminal to receive a reset signal, a third terminal of the reset control circuit is electrically connected to the first electrode of the light-emitting element, and the reset control circuit is configured to apply the reset signal to the first electrode of the light-emitting element and/or the first terminal of the driving circuit in response to the reset control signal.

The pixel circuit provided by at least one embodiment of the present disclosure is provided with the reset control circuit, and the first terminal of the reset control circuit is electrically connected to the first terminal of the driving circuit, and the second terminal of the reset control circuit is electrically connected to the reset signal terminal, so that the reset signal needs to pass through the reset control circuit before it may be applied to the first electrode of the light-emitting element and/or to the first terminal of the driving circuit, thereby reducing impact of the fluctuation of the reset signal on the voltage of the first electrode of the light-emitting element and the first terminal of the driving circuit, and reducing the risk of introducing noise into the pixel circuit, so as to cause the driving current to be more stable to improve the display effect.

The pixel circuit and the driving method thereof, and the display apparatus provided by the embodiments of the present disclosure are described below in conjunction with the accompanying drawings.

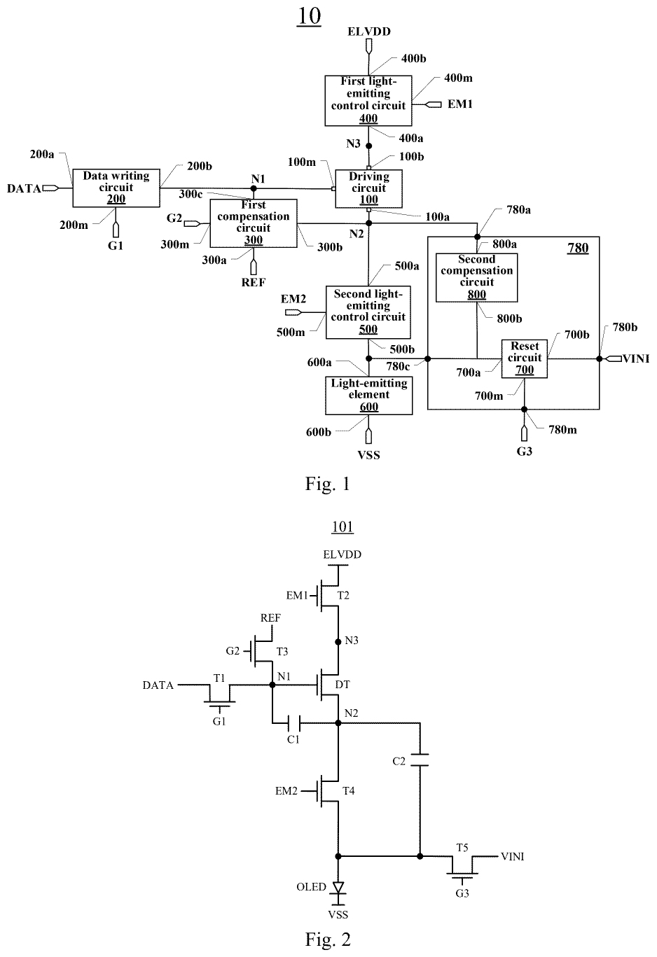

FIG. 1 is a schematic block diagram of a pixel circuit provided by at least one embodiment of the present disclosure.

As shown in FIG. 1, a pixel circuit 10 includes a driving circuit 100, a first compensation circuit 300, a second light-emitting control circuit 500, a light-emitting element 600 and a reset control circuit 780.

As shown in FIG. 1, the driving circuit 100 includes a control terminal 100m, a first terminal 100a, and a second terminal 100b. The control terminal 100m of the driving circuit 100 is electrically connected to a first node N1, the first terminal 100a of the driving circuit 100 is electrically connected to a second node N2, and the second terminal 100b of the driving circuit 100 is electrically connected to a third node N3. The driving circuit 100 is configured to control a magnitude of a driving current flowing through the first terminal 100a and the second terminal 100b. For example, the driving current may be used to drive the light-emitting element 600 to emit light. For example, in a light-emitting phase, the driving circuit 100 may provide the light-emitting element 600 with the driving current to drive the light-emitting element 600 to emit light.

As shown in FIG. 1, the first compensation circuit 300 includes a control terminal 300m, a first terminal 300a, a second terminal 300b, and a third terminal 300c. The control terminal 300m of the first compensation circuit 300 is configured to receive a first compensation control signal G2, the first terminal 300a of the first compensation circuit 300 is electrically connected to a reference signal terminal REF to receive a reference signal REF, the second terminal 300b of the first compensation circuit 300 is electrically connected to the second node N2, and the third terminal 300c of the first compensation circuit 300 is electrically connected to the first node N1. The first compensation circuit 300 is configured to apply the reference signal REF to the control terminal 100m of the driving circuit 100 in response to the first compensation control signal G2. For example, the first compensation circuit 300 may include a first storage capacitor C1 (see FIG. 2), a first electrode of the first storage capacitor C1 is electrically connected to the control terminal 100m of the driving circuit 100, and a second electrode of the first storage capacitor C1 is electrically connected to the first terminal 100a of the driving circuit 100. However, the embodiments of the present disclosure are not limited thereto.

For example, as shown in FIG. 1, the second light-emitting control circuit 500 includes a control terminal 500m, a first terminal 500a, and a second terminal 500b. The control terminal 500m of the second light-emitting control circuit 500 is configured to receive a second light-emitting control signal EM2, the first terminal 500a of the second light-emitting control circuit 500 is electrically connected to the first terminal 100a of the driving circuit 100, the second terminal 500b of the second light-emitting control circuit 500 is electrically connected to a first electrode 600a of the light-emitting element 600, and the second light-emitting control circuit 500 is configured to apply a driving current to the light-emitting element 600 in response to the second light-emitting control signal EM2 and allow a reset signal VINI to be applied to the first terminal 100a of the driving circuit 100. For example, in a light-emitting phase, the second light-emitting control circuit 500 is turned on in response to the second light-emitting control signal EM2, so that the driving circuit 100 may apply the driving current to the light-emitting element 600 through the second light-emitting control circuit 500 to enable it to emit light.

For example, as shown in FIG. 1, the light-emitting element 600 includes a first electrode 600a and a second electrode 600b, the first electrode 600a of the light-emitting element 600 is electrically connected to the first terminal 100a of the driving circuit 100, the second electrode 600b of the light-emitting element 600 is electrically connected to a second voltage terminal VSS to receive a second power supply voltage VSS, and the light-emitting element 600 is configured to emit light driven by the driving current. For example, the second voltage terminal VSS may be grounded, that is, the second power supply voltage VSS may be OV. For example, the second power supply voltage VSS may be a negative voltage. For example, the light-emitting element 600 may use an Organic Light-Emitting Diode (OLED). In the embodiments described below, the light-emitting element 600 is taken as an OLED as an example. For example, the light-emitting element 600 may also be an electroluminescent device of any other type, such as an inorganic light-emitting diodes, a quantum-dot light-emitting element, etc. The embodiments of the present disclosure do not limit the type of the light-emitting element.

As shown in FIG. 1, the reset control circuit 780 includes a control terminal 780m, a first terminal 780a, a second terminal 780b, and a third terminal 780c. The control terminal 780m of the reset control circuit 780 is configured to receive a reset control signal G3, the first terminal 780a of the reset control circuit 780 is electrically connected to the first terminal 100a of the driving circuit 100, the second terminal 780b of the reset control circuit 780 is electrically connected to the reset signal terminal VINI to receive the reset signal VINI, the third terminal 780c of the reset control circuit 780 is electrically connected to the first electrode 600a of the light-emitting element 600, and the reset control circuit 780 is configured to apply the reset signal VINI to the first electrode 600a of the light-emitting element 600 and/or the first terminal 100a of the driving circuit 100 in response to the reset control signal G3. For example, in a reset phase, the second light-emitting control circuit 500 may be turned on in response to the second light-emitting control signal EM2, so that it may be combined with other circuit elements (for example, a reset circuit 700 described in the following embodiment) to allow the reset signal VINI to be applied to the first terminal 100a of the driving circuit 100, thereby implementing a reset operation and other operations of the driving circuit 100 and the light-emitting element 600. For example, in a compensation phase and a data writing phase, the second light-emitting control circuit 500 is turned off in response to the second light-emitting control signal EM2, and the reset signal VINI is applied to the first electrode of the light-emitting element 600, and the light-emitting element 600 may be prevented from emitting light in this phase to meet a display requirement of the display apparatus. For example, the reset signal VINI may be the reset voltage VINI.

As shown in FIG. 1, the first terminal 780a of the reset control circuit 780 is electrically connected to the first terminal 100a of the driving circuit 100, and the second terminal 780b of the reset control circuit 780 is electrically connected to the reset signal terminal VINI. Thus, the reset signal from the reset signal terminal VINI needs to pass through the reset control circuit 780 before it may be applied to the first electrode 600a of the light-emitting element 600 and/or the first terminal of the driving circuit 100, thereby reducing the impact of the fluctuation of the reset signal on the voltage of the first electrode 600a of the light-emitting element 600 and the first terminal 100a of the driving circuit 100, and reducing the risk of introducing noise into the pixel circuit 10, thereby causing the driving current to be more stable to improve the display effect.

For example, as shown in FIG. 1, the reset control circuit 780 includes a reset circuit 700 and a second compensation circuit 800, and the reset signal VINI is applied to the first electrode 600a of the light-emitting element 600 and/or the first terminal 100a of the driving circuit 100 through the reset circuit 700 and the second compensation circuit 800. For example, in some embodiments of the present disclosure, the reset control circuit 780 may also include other sub-circuits, and the embodiments of the present disclosure do not limit a specific structure of the reset control circuit 780.

For example, as shown in FIG. 1, the second compensation circuit 800 includes a first terminal 800a and a second terminal 800b, the second compensation circuit 800 includes a second storage capacitor C2, and the second storage capacitor C2 is electrically connected between the first terminal 100a of the driving circuit 100 and the reset signal terminal VINI. For example, the reset circuit 700 includes a control terminal 700m, a first terminal 100a, and a second terminal 700b. The control terminal 700m of the reset circuit 700 serves as the control terminal 780m of the reset control circuit 780 and is configured to receive the reset control signal G3, the first terminal 100a of the reset circuit 700 serves as the third terminal 780c of the reset control circuit 780 and is electrically connected to the first electrode 600a of the light-emitting element 600, and the second terminal 700b of the reset circuit 700 serves as the second terminal 780b of the reset control circuit 780 and is electrically connected to the reset signal terminal VINI to receive the reset signal VINI. For example, in conjunction with FIG. 1 and FIG. 2, a first electrode of the second storage capacitor C2 serves as the first terminal 780a of the reset control circuit 780 and is electrically connected to the first terminal 100a of the driving circuit 100, and a second electrode of the second storage capacitor C2 is electrically connected to the first terminal 700a of the reset circuit 700, so that in this solution, the second electrode of the second storage capacitor C2 is indirectly electrically connected to the reset signal terminal VINI through the reset circuit 700.

Because the second electrode of the second storage capacitor C2 is connected to the first terminal 700a of the reset circuit 700 instead of the second terminal 700b of the reset circuit 700, the reset signal VINI needs to pass through the second terminal 700b and the first terminal 700a of the reset circuit 700 in sequence before it may be applied to the second electrode of the second storage capacitor C2 and the first electrode 600a of the light-emitting element 600, thereby reducing the risk of introducing noise into a pixel circuit 101 because of the fluctuation of the reset signal VINI.

Of course, in some other embodiments of the present disclosure, the second electrode of the second storage capacitor C2 may also be directly electrically connected to the reset signal terminal VINI, so that a structural design form of the pixel circuit is more flexible, and the embodiments of the present disclosure are not limited thereto.

For example, as shown in FIG. 1, the pixel circuit 10 further includes a data writing circuit 200 and a first light-emitting control circuit 400.

For example, as shown in FIG. 1, the data writing circuit 200 includes a control terminal 200m, a first terminal 200a and a second terminal 200b. The control terminal 200m of the data writing circuit 200 is configured to receive a data scanning signal G1, the first terminal 200a of the data writing circuit 200 is electrically connected to a data signal terminal DATA to receive a data signal DATA, the second terminal 200b of the data writing circuit 200 is electrically connected to the first node N1, and the data writing circuit 200 is configured to write the data signal DATA to the control terminal 100m of the driving circuit 100 in response to the data scanning signal G1. For example, in the data writing phase, the data writing circuit 200 is turned on in response to the data scanning signal G1, so that the data signal DATA may be written into the control terminal 100m of the driving circuit 100 through the data writing circuit 200.

As shown in FIG. 1, the first light-emitting control circuit 400 includes a control terminal 400m, a first terminal 400a, and a second terminal 400b. The control terminal 400m of the first light-emitting control circuit 400 is configured to receive a first light-emitting control signal EM1, the first terminal 400a of the first light-emitting control circuit 400 is electrically connected to the second terminal 100b of the driving circuit 100, the second terminal 400b of the first light-emitting control circuit 400 is electrically connected to a first voltage terminal ELVDD to receive a first power supply voltage ELVDD, and the first light-emitting control circuit 400 is configured to apply the first power supply voltage ELVDD to the second terminal 100b of the driving circuit 100 in response to the first light-emitting control signal EM1. For example, in the compensation phase, the first light-emitting control circuit 400 may be turned on in response to the first light-emitting control signal EM1, so that the first power supply voltage ELVDD may be applied to the second terminal 100b of the driving circuit 100 through the first light-emitting control circuit 400. The second electrode 600b of the light-emitting element 600 receives the second power supply voltage VSS, for example, the first power supply voltage ELVDD may be a high voltage, and the second power supply voltage VSS may be a low voltage, but the embodiments of the present disclosure are not limited thereto.

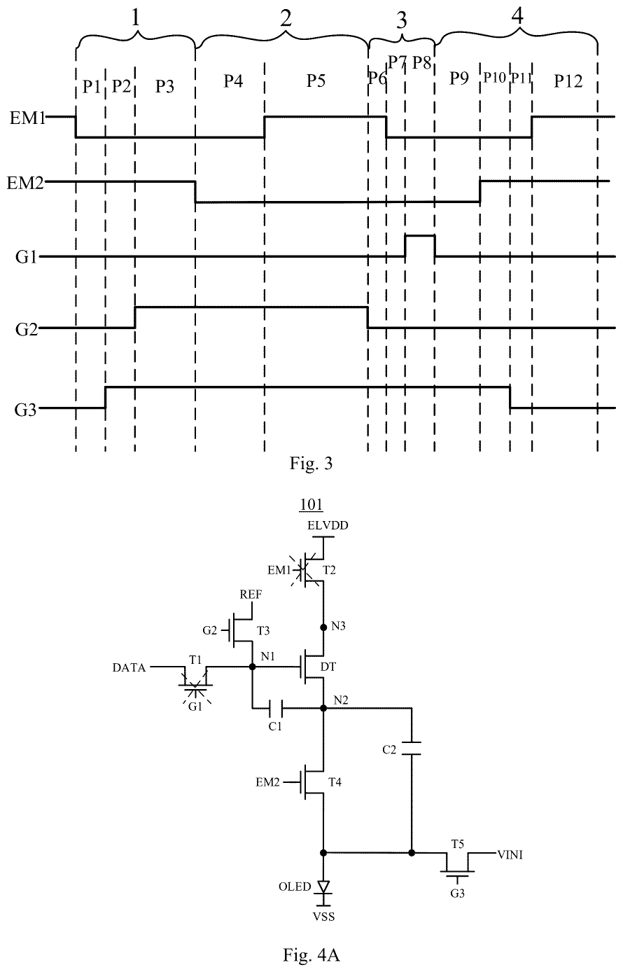

FIG. 2 is a circuit diagram of an implementation example of the pixel circuit shown in FIG. 1; and FIG. 3 is a signal timing diagram of a driving method provided by at least one embodiment of the present disclosure.

For example, the pixel circuit shown in FIG. 1 may be implemented as a pixel circuit structure shown in FIG. 2. As shown in FIG. 2, the pixel circuit 101 includes: a driving transistor DT, a data writing transistor T1, a first light-emitting control transistor T2, a first compensation transistor T3, a second light-emitting control transistor T4, a reset transistor T5, a first storage capacitor C1, a second storage capacitor C2, and a light-emitting element OLED. For example, the data writing transistor T1, the first light-emitting control transistor T2, the first compensation transistor T3, the second light-emitting control transistor T4, and the reset transistor T5 are used as switching transistors. For example, the light-emitting element is an OLED, which may be of various types, such as a top emission type, a bottom emission type, etc., and may emit red light, green light, blue light or white light, etc. The embodiments of the present disclosure are not limited thereto.

As shown in FIG. 1 and FIG. 2, the driving circuit 100 includes a driving transistor DT, and a gate electrode of the driving transistor DT serves as the control terminal 100m of the driving circuit 100 and is electrically connected to the first node N1. A first electrode of the driving transistor DT serves as the first terminal 100a of the driving circuit 100, and is electrically connected to the first electrode of the second storage capacitor C2 at the second node N2. A second electrode of the driving transistor DT serves as the second terminal 100b of the driving circuit 100 and is electrically connected to the first voltage terminal ELVDD to receive the first power supply voltage ELVDD.

As shown in FIG. 1 and FIG. 2, the first compensation circuit 300 includes a first compensation transistor T3 and a first storage capacitor C1. A gate electrode of the first compensation transistor T3 serves as the control terminal 300m of the first compensation circuit 300 and is electrically connected to the first compensation control signal terminal G2 to receive the first compensation control signal G2. A first electrode of the first compensation transistor T3 serves as the first terminal 300a of the first compensation circuit 300 and is electrically connected to the reference signal terminal REF to receive the reference signal REF; and a second electrode of the first compensation transistor T3 is electrically connected to the first node N1. A first electrode of the first compensation capacitor C1 is electrically connected to the gate electrode of the driving transistor DT, and a second electrode of the first storage capacitor C1 is electrically connected to the first electrode of the driving transistor DT.

For example, as shown in FIG. 1 and FIG. 2, the second light-emitting control circuit 500 includes a second light-emitting control transistor T4, and a gate electrode of the second light-emitting control transistor T4 is electrically connected to the second light-emitting control terminal EM2 to receive the second light-emitting control signal EM2. A first electrode of the second light-emitting control transistor T4 is electrically connected to the first terminal 100a of the driving circuit 100. A second electrode of the second light-emitting control transistor T4 is electrically connected to the first electrode 600a of the light-emitting element 600.

As shown in FIG. 1 and FIG. 2, the reset circuit 700 includes a reset transistor T5, and a gate electrode of the reset transistor T5 is electrically connected to the reset control terminal G3 to receive the reset control signal G3. A first electrode of the reset transistor T5 is electrically connected to the second electrode of the second storage capacitor C2 and the first terminal 100a of the driving circuit 100, and a second electrode of the reset transistor T5 is electrically connected to the reset signal terminal VINI to receive the reset signal VINI.

As shown in FIG. 1 and FIG. 2, in the pixel circuit provided by at least one embodiment of the present disclosure, the first electrode of the reset transistor T5 is indirectly electrically connected to the first terminal 100a of the driving circuit 100, that is, the first electrode of the reset transistor T5 is electrically connected to the first terminal 100a of the driving circuit 100 through the second light-emitting control transistor T4.

As shown in FIG. 1 and FIG. 2, the reset signal from the reset signal terminal VINI needs to pass through the first electrode and the second electrode of the reset transistor T5 before it may be applied to the first electrode of the light-emitting element OLED and/or the first terminal of the driving circuit 100, thereby reducing the impact of the fluctuation of the reset signal on the voltage of the first electrode of the light-emitting element OLED and the first terminal 100a of the driving circuit 100, and reducing the risk of introducing noise into the pixel circuit 10, so as to cause the driving current to be more stable to improve the display effect.

For example, as shown in FIG. 1 and FIG. 2, the second compensation circuit 800 includes a second storage capacitor C2, and a first electrode of the second storage capacitor C2 serves as the first terminal 800a of the second compensation circuit 800 and is electrically connected to the first terminal 100a of the driving circuit 100 (i.e., the first electrode of the driving transistor DT). A second electrode of the second storage capacitor C2 serves as the second terminal 800b of the second compensation circuit 800 and is electrically connected to the first terminal 700a of the reset circuit 700 (i.e., the first electrode of the reset transistor T5).

In a technical solution of this embodiment, because the second electrode of the second storage capacitor C2 is electrically connected to the first electrode of the reset transistor T5 instead of the second electrode of the reset transistor T5, the reset signal VINI is applied to the second electrode of the second storage capacitor C2 and the first electrode 600a of the light-emitting element 600 through the second electrode and the first electrode of the reset transistor T5 in sequence, thereby reducing the risk of introducing noise to the pixel circuit 101 because of the fluctuation of the reset signal VINI.

For example, as shown in FIG. 1 and FIG. 2, the data writing circuit 200 includes a data writing transistor T1, a gate electrode of the data writing transistor T1 is electrically connected to the data scanning signal terminal G1 to receive the data scanning signal G1, a first electrode of the data writing transistor T1 is electrically connected to the data signal terminal DATA to receive the data signal DATA, and a second electrode of the data writing transistor T1 is electrically connected to the first node N1.

For example, as shown in FIG. 1 and FIG. 2, the first light-emitting control circuit 400 includes a first light-emitting control transistor T2, a gate electrode of the first light-emitting control transistor T2 is electrically connected to the first light-emitting control terminal EM1 to receive the first light-emitting control signal EM1. A first electrode of the first light-emitting control transistor T2 is electrically connected to the second terminal 100b of the driving circuit 100. A second electrode of the first light-emitting control transistor T2 is electrically connected to the first voltage terminal ELVDD to receive the first power supply voltage ELVDD.

It should be noted that in description of the embodiments of the present disclosure, the first node N1, the second node N2 and the third node N3 do not necessarily represent actual components but rather denote junctions of circuit connection in the circuit diagram. In the description of the embodiments of the present disclosure, the reference sign DATA may represent both the data signal terminal and the data signal; similarly, the reference sign G1 may represent both the data scanning signal terminal and the data scanning signal; the reference sign REF may represent both the reference signal terminal and the reference signal; the reference sign G2 may represent both the first compensation control signal terminal and the first compensation control signal; the reference sign EM1 may represent both the first light-emitting control terminal and the first light-emitting control signal; the reference sign ELVDD may represent both the first voltage terminal and the first power supply voltage; the reference sign EM2 may represent both the second light-emitting control terminal and the second light-emitting control signal; the reference sign G3 may represent both the reset control terminal and the reset control signal; the reference sign VINI may represent both the reset signal terminal and the reset signal, and may also represent the reset voltage; the reference sign VSS may represent both the second voltage terminal and the second power supply voltage. The same applies to subsequent embodiments and will not be repeated.

It should be noted that transistors used in the embodiments of the present disclosure may be thin-film transistors, field-effect transistors or other switching devices with same characteristics. The embodiments of the present disclosure are all described by taking thin-film transistors as examples. The source electrode and the drain electrode of the transistor used here may be symmetrical in structure, so the source electrode and the drain electrode may be structurally indistinguishable. In the embodiments of the present disclosure, in order to distinguish the two electrodes of the transistor other than the gate electrode, one of the electrodes is directly described as the first electrode and the other electrode is the second electrode.

In addition, the transistors may be divided into an N-type transistor and a P-type transistor according to characteristics of the transistors. When the transistor is a P-type transistor, a turn-on voltage is a low-level voltage (for example, 0V, −5V, −10V or other suitable voltages), and a turn-off voltage is a high-level voltage (for example, 5V, 10V or other suitable voltages). When the transistor is an N-type transistor, the turn-on voltage is a high-level voltage (for example, 5V, 10V or other suitable voltages), and the turn-off voltage is a low-level voltage (for example, 0V, −5V, −10V or other suitable voltages). However, the embodiments of the present disclosure do not limit the type of transistor. When the type of transistor changes, a connection relationship in the circuit may be adjusted accordingly.

An operating principle of the pixel circuit 101 shown in FIG. 2 is described below in conjunction with the signal timing diagram shown in FIG. 3. As shown in FIG. 3, a display process of each frame of an image includes four phases, namely, a reset phase 1, a compensation phase 2, a data writing phase 3 and a light-emitting phase 4.

For example, in the pixel circuit 101 shown in FIG. 2, the driving transistor DT, the data writing transistor T1, the first light-emitting control transistor T2, the first compensation transistor T3, the second light-emitting control transistor T4, and the reset transistor T5 are all N-type transistors. That is, a gate electrode of each transistor is turned on when a high-level signal is connected, and is turned off when a low-level signal is connected. Of course, in other embodiments, the above transistors may also be P-type transistors. The embodiments of the present disclosure do not limit the type of each transistor, which may be selected as needed. Here, the N-type transistors are taken as an example.

As shown in FIG. 1 to FIG. 3, an embodiment of the present disclosure provides a driving method, including: setting the reset control signal G3 as an ON signal, so that the reset signal VINI is applied to the first electrode 600a of the light-emitting element 600 and/or the first terminal 100a of the driving circuit 100 through the reset control circuit 780 in sequence.

For example, as shown in FIG. 1 to FIG. 3, the first terminal 100a of the driving circuit 100 is not directly connected to the reset signal terminal VINI, that is, the two are electrically connected through the reset control circuit 780. For example, when the reset control signal G3 is an OFF signal, the first terminal 100a of the driving circuit 100 is disconnected from the reset signal terminal VINI.

In this way, the reset signal from the reset signal terminal needs to pass through the reset control circuit before it may be applied to the first electrode of the light-emitting element and/or the first terminal of the driving circuit, thereby reducing the impact of the fluctuation of the reset signal on the voltage of the first electrode of the light-emitting element and the first terminal of the driving circuit, reducing the risk of introducing noise into the pixel circuit, so as to cause the driving current to be more stable to improve the display effect.

For example, as shown in FIG. 1 to FIG. 3, in the reset phase 1, the driving method of the pixel circuit includes: setting the reset control signal G3 as an ON signal in at least part of the time period so that the first terminal 700a and the second terminal 700b of the reset circuit 700 are turned on, and the reset signal VINI is applied to the second electrode of the second storage capacitor C2, the first terminal 100a of the driving circuit 100, and the first electrode 600a of the light-emitting element 600 through the second terminal 700b and the first terminal 700a of the reset circuit 700 in sequence, thereby implementing a reset operation. For example, the above at least part of the time period may be an entire time period of the reset phase 1, or may be a part of the time period in the reset phase 1, and the embodiments of the present disclosure are not limited thereto.

Correspondingly, as shown in FIG. 1 to FIG. 3, in the reset phase 1, the reset control signal G3 is a high-level signal in the at least part of the time period to turn on the reset transistor T5, so that the reset signal VINI may be applied to the second electrode of the second storage capacitor C2 and the first electrode 600a of the light-emitting element 600. In this phase, the second light-emitting control signal EM2 is a high-level signal to turn on the second light-emitting control transistor T4, and then the reset signal VINI is applied to the first terminal 100a of the driving circuit 100 through the second light-emitting control transistor T4.

For example, as shown in FIG. 1 to FIG. 3, in the compensation phase 2 and the data writing phase 3, the driving method of the pixel circuit includes: setting the reset control signal G3 as an ON signal, and the reset signal VINI is applied to the second electrode of the second storage capacitor C2 and the first electrode 600a of the light-emitting element 600 through the second terminal 700b and the first terminal 700a of the reset circuit 700 in sequence.

Correspondingly, as shown in FIG. 1 to FIG. 3, in the compensation phase 2 and the data writing phase 3, the reset control signal G3 is a high-level signal in at least part of the time period to turn on the reset transistor 5. For example, the second light-emitting control signal EM2 is a low-level signal to turn off the second light-emitting control transistor T4. Therefore, a voltage of the second electrode of the second storage capacitor C2 and a voltage of the first electrode 600a of the light-emitting element 600 may remain as a reset voltage VINI.

For example, as shown in FIG. 1 to FIG. 3, in the light-emitting phase 4, the driving method of the pixel circuit includes: setting the reset control signal G3 as an OFF signal in at least part of the time period, so that the second electrode of the second storage capacitor C2 is disconnected from the reset signal terminal VINI. For example, the above at least part of the time period may be an entire time period of the light-emitting phase 4, or may be a part of the time period in the light-emitting phase 4, and the embodiments of the present disclosure are not limited thereto.

Correspondingly, as shown in FIG. 1 to FIG. 3, in the light-emitting phase 4, the reset control signal G3 is a low-level signal in at least part of the time period to turn off the reset transistor T5, so that the second electrode of the second storage capacitor C2 and the first electrode of the light-emitting element OLED are disconnected from the reset signal terminal VINI, so as to facilitate a voltage of the first electrode of the light-emitting element OLED to remain as a voltage when the light-emitting element OLED is in a light-emitting state.

In this way, as shown in FIG. 1 to FIG. 3, when the reset control signal G3 is an ON signal, the reset signal VINI enters an interior of the pixel circuit 101 through the reset control circuit 780, for example, it is applied to the first electrode 600a of the light-emitting element 600 and the second electrode of the second storage capacitor C2. When the reset control signal G3 is an OFF signal, the reset signal VINI is disconnected from the first electrode 600a of the light-emitting element 600, the second electrode of the second storage capacitor C2, and the first terminal 100a of the driving circuit 100. While an operating requirement of each phase is satisfied, the impact of the fluctuation of the reset signal VINI on the voltage of the first terminal 100a of the driving circuit 100 may be reduced, and the risk of introducing noise into the pixel circuit 101 may be reduced, so as to cause the driving current to be more stable to improve the display effect.

For example, as shown in FIG. 3, the reset phase 1 includes a first sub-reset phase P1, a second sub-reset phase P2 and a third sub-reset phase P3 which are performed in sequence. For example, the compensation phase 2 includes a first sub-compensation phase P4 and a second sub-compensation phase P5 which are performed in sequence. For example, the data writing phase 3 includes a first sub-data writing phase P6, a second sub-data writing phase P7 and a third sub-data writing phase P8 which are performed in sequence. For example, the light-emitting phase 4 includes a first sub-light-emitting phase P9, a second sub-light-emitting phase P10, a third sub-light-emitting phase P11 and a fourth sub-light-emitting phase P12 which are performed in sequence.

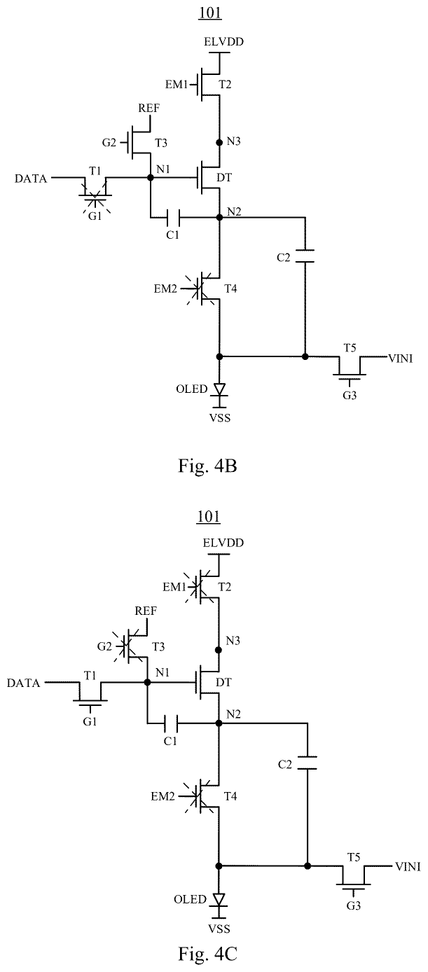

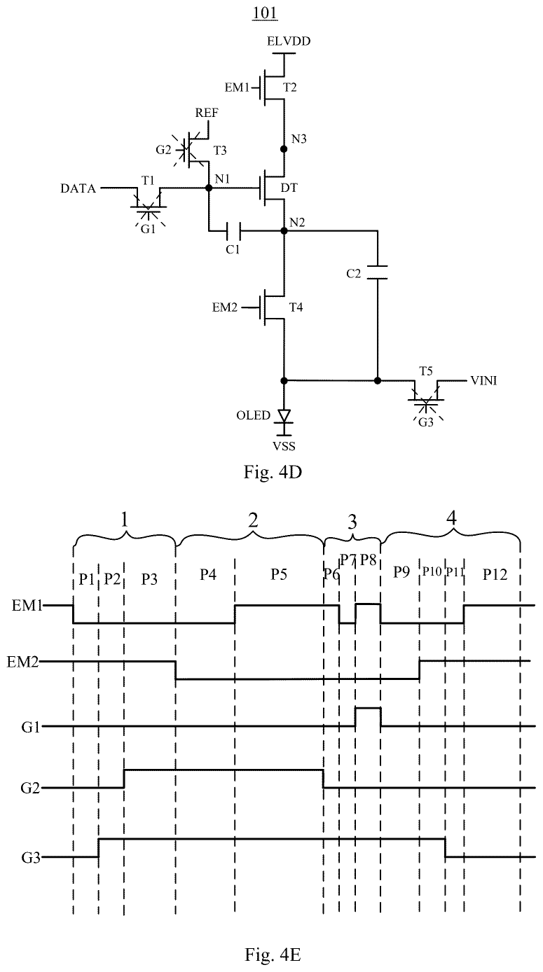

FIG. 4A is a schematic diagram of the pixel circuit in FIG. 2 in a third sub-reset phase; FIG. 4B is a schematic diagram of the pixel circuit in FIG. 2 in a second sub-compensation phase; FIG. 4C is a schematic diagram of the pixel circuit in FIG. 2 in a third sub-data writing phase; and FIG. 4D is a schematic diagram of the pixel circuit in FIG. 2 in a fourth sub-light-emitting phase. In addition, transistors marked with dotted lines in FIG. 4A to FIG. 4D are all in an OFF state in a corresponding phase.

Specifically, for example, as shown in FIG. 1 and FIG. 3, in the reset phase 1, the driving method of the pixel circuit includes:
Step S1010: disconnecting the second terminal 100b of the driving circuit 100 from the first voltage terminal ELVDD;
Step S1020: setting the reset control signal G3 as an ON signal to turn on the reset circuit 700; and
Step S1030: setting the first compensation control signal G2 as an ON signal to turn on the first compensation circuit 300.

In the reset phase, the data scanning signal G1 remains as an OFF signal to turn off the data writing circuit 200, and the second light-emitting control signal EM2 remains as an ON signal to turn on the second light-emitting control circuit 500.

For example, as shown in FIG. 1 and FIG. 3, in the first sub-reset phase P1, the data scanning signal G1 remains as an OFF signal to turn off the data writing circuit 200; the second light-emitting control signal EM2 remains as an ON signal to turn off the second light-emitting control circuit 500; the first compensation control signal G2 and the reset control signal G3 both remain as OFF signals, so that the first compensation circuit 300 and the reset circuit 700 are both in an OFF state; in addition, corresponding to the step S1010, the first light-emitting control signal EM1 is switched to an OFF signal to turn off the first light-emitting control circuit 400, so that the second terminal 100b of the driving circuit 100 is disconnected from the first voltage terminal ELVDD.

For example, as shown in FIG. 1 and FIG. 3, in the second sub-reset phase P2, the data scanning signal G1 remains as an OFF signal to turn off the data writing circuit 200; the second light-emitting control signal EM2 remains as an ON signal to turn on the second light-emitting control circuit 500; the first light-emitting control signal EM1 remains as an OFF signal to turn off the first light-emitting control circuit 400; the first compensation control signal G2 remains as an OFF signal to cause the first compensation circuit 300 to be in an OFF state; in addition, corresponding to the step S1020, the reset control signal G3 is switched to an ON signal to turn on the reset circuit 700, so that the reset signal VINI may be applied to the second electrode of the second storage capacitor C2, the first electrode 600a of the light-emitting element 600 and the first terminal 100a of the driving circuit 100.

For example, as shown in FIG. 1 and FIG. 3, in the third sub-reset phase P3, the data scanning signal G1 remains as an OFF signal to turn off the data writing circuit 200; the second light-emitting control signal EM2 remains as an ON signal to turn on the second light-emitting control circuit 500; the first light-emitting control signal EM1 remains as an OFF signal to turn off the first light-emitting control circuit 400; the reset control signal G3 remains as an ON signal to turn on the reset circuit 700; in addition, corresponding to the step S1030, the first compensation control signal G2 is switched to an ON signal to turn on the first compensation circuit 300, so that the reference signal REF may be applied to the control terminal 100m of the driving circuit 100.

For example, as shown in FIG. 1 and FIG. 3, by activating the reset circuit 700 when the first light-emitting control circuit 400 is turned off, that is, when the first light-emitting control circuit 400 is turned off in the first sub-reset phase P1, the reset circuit 700 is turned on in the second sub-reset phase P2, thereby preventing the first light-emitting control circuit 400 from being turned on with the reset circuit 700 through the driving circuit 100 and the second light-emitting control circuit 500, so that the driving current may be more stable, which is beneficial to safety of the device.

Correspondingly, as shown in FIG. 2 and FIG. 3, in the first sub-reset phase P1, the data scanning signal G1 remains as a low-level signal to turn off the data writing transistor T1; the second light-emitting control signal EM2 remains as a high-level signal to turn on the second light-emitting control transistor T4; the first compensation control signal G2 and the reset control signal G3 both remain as low-level signals, so that the first compensation transistor T3 and the reset transistor T5 are both in an ON state; in addition, corresponding to the step S1010, the first light-emitting control signal EM1 is switched to a low-level signal to turn off the first light-emitting control transistor T2, so that the second electrode of the driving transistor DT is disconnected from the first voltage terminal ELVDD.

Correspondingly, as shown in FIG. 2 and FIG. 3, in the second sub-reset phase P2, the data scanning signal G1 remains as a low-level signal to turn off the data writing transistor T1; the second light-emitting control signal EM2 remains as a high-level signal to turn on the second light-emitting control transistor T4; the first light-emitting control signal EM1 remains as a low-level signal to turn off the first light-emitting control transistor T2; the first compensation control signal G2 remains as a low-level signal to turn off the first compensation transistor T3; in addition, corresponding to the step S1020, the reset control signal G3 is switched to a high-level signal to turn on the reset transistor T5, so that the reset signal VINI may be applied to the second electrode of the second storage capacitor C2, the first electrode of the light-emitting element OLED, and the first electrode of the driving transistor DT.

Correspondingly, as shown in FIG. 3 and FIG. 4A, in the third sub-reset phase P3, the data scanning signal G1 remains as a low-level signal to turn off the data writing transistor T1; the second light-emitting control signal EM2 remains as a high-level signal to turn on the second light-emitting control transistor T4; the first light-emitting control signal EM1 remains as a low-level signal to turn off the first light-emitting control transistor T2; the reset control signal G3 remains as a high-level signal to turn on the reset transistor T5; in addition, corresponding to the step S1030, the first compensation control signal G2 is switched to a high-level signal to turn on the first compensation transistor T3, so that the reference signal REF may be applied to the gate electrode of the driving transistor DT.

Therefore, as shown in FIG. 3 and FIG. 4A, the reset transistor T5 is turned on when the first light-emitting control transistor T2 is turned off, thereby preventing the first light-emitting control transistor T2 from being turned on to the reset transistor T5 through the driving transistor DT and the second light-emitting control transistor T4, so that the driving current may be more stable, which is beneficial to the safety of the device.

For example, as shown in FIG. 3 and FIG. 4A, the reference signal REF is a reference voltage, and a value thereof is V_{REF}; the reset signal VINI is a reset voltage, and a value thereof is V_{INI}. A difference between a voltage value of the gate electrode of the driving transistor DT and a voltage value of the first electrode of the driving transistor DT is a gate-source voltage Vgs, and a threshold voltage of the driving transistor DT is Vth. When steps in the first sub-reset phase P1, the second sub-reset phase P2, and the third sub-reset phase P3 are completed, Vgs≥Vth, that is, V_{REF}−V_{INI}≥Vth. For example, when Vgs>Vth, the driving transistor DT is in an ON state.

It should be noted that the steps corresponding to the first sub-reset phase P1, the second sub-reset phase P2 and the third sub-reset phase P3 are performed in sequence, so that the driving current in the pixel circuit can be well controlled, but the embodiments of the present disclosure are not limited thereto. For example, in some embodiments, the steps corresponding to at least two of the first sub-reset phase P1, the second sub-reset phase P2 and the third sub-reset phase 3 may be performed synchronously. For example, the steps corresponding to the first sub-reset phase P1, the second sub-reset phase P2 and the third sub-reset phase P3 may be performed synchronously, and the embodiments of the present disclosure are not limited thereto.

For example, as shown in FIG. 1 and FIG. 3, in the compensation phase 2, the driving method of the pixel circuit includes:
Step S2010: setting the second light-emitting control signal EM2 as an OFF signal to turn off the second light-emitting control circuit 500, and setting the first light-emitting control signal EM1 as an OFF signal to turn off the first light-emitting control circuit 400; and
Step S2020: setting the first light-emitting control signal EM1 as an ON signal to turn on the first light-emitting control circuit 400, and keeping the second light-emitting control signal EM2 as an OFF signal.

For example, in the compensation phase 2, the data scanning signal G1 remains as an OFF signal to keep the data writing circuit 200 turned off, the first compensation control signal G2 remains as an ON signal to keep the first compensation circuit 300 turned on, and the reset control signal G3 is an ON signal to turn on the reset circuit 700.

For example, as shown in FIG. 1 and FIG. 3, in the first sub-compensation phase P4, the data scanning signal G1 remains as an OFF signal to turn off the data writing circuit 200; the first compensation control signal G2 and the reset control signal G3 both remain as ON signals, so that the first compensation circuit 300 and the reset circuit 700 are both in an ON state; the first light-emitting control signal EM1 remains as an OFF signal to turn off the first light-emitting control circuit 400; in addition, corresponding to the step S2010, the second light-emitting control signal EM2 is switched to an OFF signal to turn off the second light-emitting control circuit 500.

For example, as shown in FIG. 1 and FIG. 3, in the second sub-compensation phase P5, the data scanning signal G1 remains as an OFF signal to turn off the data writing circuit 200; the first compensation control signal G2 and the reset control signal G3 both remain as ON signals, so that the first compensation circuit 300 and the reset circuit 700 are both in the ON state; the second light-emitting control signal EM2 remains as an OFF signal to turn off the second light-emitting control circuit 500; in addition, corresponding to the step S2020, the first light-emitting control signal EM1 is switched to an ON signal to turn on the first light-emitting control circuit 400.

For example, as shown in FIG. 1 and FIG. 3, when the second light-emitting control circuit 500 is turned off in the first sub-compensation phase P4 and remains turned off in the second sub-compensation phase P5, the first light-emitting control circuit 400 is turned on in the second sub-compensation phase P5, so that when the reset circuit 700 is in the ON state, the first light-emitting control circuit 400 may be prevented from being turned on to the reset circuit 700 through the driving circuit 100 and the second light-emitting control circuit 500, so that the driving current may be more stable, which is beneficial to the safety of the device.

Correspondingly, as shown in FIG. 2 and FIG. 3, in the first sub-compensation phase P4, the data scanning signal G1 remains as an OFF signal to turn off the data writing transistor T1; the first compensation control signal G2 and the reset control signal G3 both remain as ON signals, so that the first compensation transistor T3 and the reset transistor T5 are both in an ON state; the first light-emitting control signal EM1 remains as an OFF signal to turn off the first light-emitting control transistor T2; in addition, corresponding to the step S2010, the second light-emitting control signal EM2 is switched to an OFF signal to turn off the second light-emitting control transistor T4.

Correspondingly, as shown in FIG. 3 and FIG. 4B, in the second sub-compensation phase P5, the data scanning signal G1 remains as an OFF signal to turn off the data writing transistor T1; the first compensation control signal G2 and the reset control signal G3 both remain as ON signals, so that the first compensation transistor T3 and the reset transistor T5 are both in the ON state; the second light-emitting control signal EM2 remains as an OFF signal to turn off the second light-emitting control transistor T4; in addition, corresponding to the step S2020, the first light-emitting control signal EM1 is switched to an ON signal to turn on the first light-emitting control transistor T2, so that the first power supply voltage ELVDD is applied to the second electrode of the driving transistor DT.

For example, as shown in FIG. 2, FIG. 3 and FIG. 4B, when the second light-emitting control transistor T4 is turned off in the first sub-compensation phase P4 and remains turned off in the second sub-compensation phase P5, the first light-emitting control transistor T2 is turned on in the second sub-compensation phase P5. Therefore, when the reset transistor T5 is in the ON state, the first light-emitting control transistor T2 may be prevented from being turned on to the reset transistor T5 through the driving transistor DT and the second light-emitting control transistor T4, so that the driving current may be more stable, which is beneficial to the safety of the device.

For example, as shown in FIG. 3 and FIG. 4B, at a beginning of the compensation phase 2, the voltage value of the first electrode of the driving transistor DT is equal to a value of the reset voltage Vini, and Vgs−Vth>0. When the steps in the first sub-compensation phase P4 and the second sub-compensation phase P5 are completed, the voltage value of the gate electrode of the driving transistor DT is V_{REF}, and the voltage of the second electrode of the driving transistor DT is the first power supply voltage ELVDD. Because the value of the first power supply voltage ELVDD is greater than the voltage value of the first electrode of the driving transistor DT (that is, Vini), the driving transistor DT may be charged by the first power supply voltage ELVDD until the driving transistor DT is turned off, so that a voltage value Vs of the first electrode of the driving transistor DT is equal to Vref−Vth.

It should be noted that the steps corresponding to the first sub-reset phase P4 and the second sub-compensation phase P5 are performed in sequence so that the driving current in the pixel circuit can be well controlled, but the embodiments of the present disclosure are not limited thereto. For example, in some embodiments, the steps corresponding to the first sub-reset phase P4 and the second sub-compensation phase P5 may also be performed synchronously, and the embodiments of the present disclosure are not limited thereto.

For example, as shown in FIG. 1 and FIG. 3, in the data writing phase 3, the driving method of the pixel circuit includes:
Step S3010: setting the first compensation control signal G2 as an OFF signal to turn off the first compensation circuit 300, and keeping the second terminal of the driving circuit 100 receiving the first power supply voltage ELVDD;
Step S3020: setting the first light-emitting control signal EM1 as an OFF signal to turn off the first light-emitting control circuit 400, so that the second terminal of the driving circuit 100 is disconnected from the first voltage terminal ELVDD; and
Step S3030: setting the data scanning signal G1 as an ON signal to turn on the data writing circuit 200.

In the data writing phase 3, the second light-emitting control signal EM2 remains as an OFF signal to keep the second light-emitting control circuit 500 turned off, and the reset control signal G3 remains as an ON signal to keep the reset circuit 700 turned on.

For example, as shown in FIG. 1 and FIG. 3, in the first sub-data writing phase P6, the data scanning signal G1 remains as an OFF signal to turn off the data writing circuit 200; the first light-emitting control signal EM1 remains as an ON signal to turn on the first light-emitting control circuit 400, so that the second terminal of the driving circuit 100 continues to receive the first power supply voltage ELVDD; the second light-emitting control signal EM2 remains as an OFF signal to turn off the second light-emitting control circuit 500; the reset control signal G3 remains as an ON signal, so that the reset circuit 700 is in the ON state; in addition, corresponding to the step S3010, the first compensation control signal G2 is switched to an OFF signal to turn off the first compensation circuit 300, so that the reference signal REF stops being applied to the control electrode 100m of the driving circuit 100.

For example, as shown in FIG. 1 and FIG. 3, in the second sub-data writing phase P7, the data scanning signal G1 remains as an OFF signal to turn off the data writing circuit 200; the second light-emitting control signal EM2 remains as an OFF signal to turn off the second light-emitting control circuit 500; the reset control signal G3 remains as an ON signal to keep the reset circuit 700 in the ON state; the first compensation control signal G2 is an OFF signal to turn off the first compensation circuit 300; in addition, corresponding to the step S3020, the first light-emitting control signal EM1 is switched to an OFF signal to turn off the first light-emitting control circuit 400, so that the second terminal of the driving circuit 100 stops receiving the first power supply voltage ELVDD.

For example, as shown in FIG. 1 and FIG. 3, in the third sub-data writing phase P8, the second light-emitting control signal EM2 remains as an OFF signal to turn off the second light-emitting control circuit 500; the reset control signal G3 remains as an ON signal, so that the reset circuit 700 is in the ON state; the first compensation control signal G2 is an OFF signal to turn off the first compensation circuit 300; the first light-emitting control signal EM1 remains as an OFF signal to turn off the first light-emitting control circuit 400; in addition, corresponding to the step S3030, the data scanning signal G1 is switched to an ON signal to turn on the data writing circuit 200, so that the data signal DATA is applied to the control electrode 100m of the driving circuit 100.

For example, as shown in FIG. 1 and FIG. 3, a step corresponding to the third sub-data writing phase P8 is performed after a step corresponding to the first sub-data writing phase P6, that is, after the first compensation circuit 300 is turned off, the data writing circuit 200 is turned on. By adopting this driving method, it is possible to avoid the data writing circuit 200 applying the data signal DATA to the control terminal 100m of the driving circuit 100 while the first compensation circuit 300 applies the reference signal REF to the control terminal 100m of the driving circuit 100, so that a controlling manner of the driving circuit is more reliable and the driving current is more stable.

Correspondingly, as shown in FIG. 2 and FIG. 3, in the first sub-data writing phase P6, the data scanning signal G1 remains as an OFF signal to turn off the data writing transistor T1; the first light-emitting control signal EM1 remains as an ON signal to turn on the first light-emitting control transistor T2, so that the second electrode of the driving transistor DT continues to receive the first power supply voltage ELVDD; the second light-emitting control signal EM2 remains as an OFF signal to turn off the second light-emitting control transistor T4; the reset control signal G3 remains as an ON signal, so that the reset transistor T5 is in the ON state; in addition, corresponding to the step S3010, the first compensation control signal G2 is switched to an OFF signal to turn off the first compensation transistor T3.

Correspondingly, as shown in FIG. 2 and FIG. 3, in the second sub-data writing phase P7, the data scanning signal G1 remains as an OFF signal to turn off the data writing transistor T1; the second light-emitting control signal EM2 remains as an OFF signal to turn off the second light-emitting control transistor T4; the reset control signal G3 remains as an ON signal to turn on the reset transistor T5; and the first compensation control signal G2 remains as an OFF signal to turn off the first compensation transistor T3. In addition, corresponding to the step S3020, the first light-emitting control signal EM1 is switched to an OFF signal to turn off the first light-emitting control transistor T2, thereby disconnecting the second electrode of the driving transistor DT from the first power supply voltage terminal ELVDD.

Correspondingly, as shown in FIG. 3 and FIG. 4C, in the third sub-data writing phase P8, the second light-emitting control signal EM2 remains as an OFF signal to turn off the second light-emitting control transistor T4; the reset control signal G3 remains as an ON signal to turn on the reset transistor T5; the first compensation control signal G2 remains as an OFF signal to turn off the first compensation transistor T3; the first light-emitting control signal EM1 remains as an OFF signal to turn off the first light-emitting control transistor T2, so that the second electrode of the driving transistor DT is disconnected from the first power supply voltage terminal ELVDD. In addition, corresponding to the step S3030, the data scanning signal G1 is switched to an ON signal to turn on the data writing transistor T1, so that the data signal DATA is written into the gate electrode of the driving transistor DT.

For example, as shown in FIG. 2, FIG. 3 and FIG. 4C, after the first compensation transistor T3 is turned off in the first sub-data writing phase P6, the data writing transistor T1 is turned on. By adopting this driving method, it is possible to avoid the data writing transistor T1 applying the data signal DATA to the gate electrode of the driving transistor DT while the first compensation transistor T3 applies the reference signal REF to the gate electrode of the driving transistor DT, so that a controlling manner of the driving circuit is more reliable and the driving current is more stable.

For example, as shown in FIG. 3 and FIG. 4C, after the steps in the first sub-data writing phase P6, the second sub-data writing phase P7 and the third sub-data writing phase P8 are completed, the voltage value of the gate electrode of the driving transistor DT and the voltage value of the first electrode of the first storage capacitor C1 are both equal to a value Vdata of the data voltage DATA, and the voltage value of the first electrode of the driving transistor DT is Vref−Vth+C1/(C1+C2)×(Vdata−Vref). Here, for clarity, a capacitance value of the first storage capacitor and the first storage capacitor use a same reference sign C1, and a capacitance value of the second storage capacitor and the second storage capacitor use a same reference sign C2.

It should be noted that the steps corresponding to the first sub-data writing phase P6, the second sub-data writing phase P7, and the third sub-data writing phase P8 are performed in sequence so that the driving current in the pixel circuit can be well controlled, but the embodiments of the present disclosure are not limited thereto. For example, in some embodiments, the steps corresponding to at least two of the first sub-data writing phase P6, the second sub-data writing phase P7, and the third sub-data writing phase P8 may be performed synchronously. For example, the steps corresponding to the first sub-data writing phase P6, the second sub-data writing phase P7, and the third sub-data writing phase P8 may be performed synchronously, and the embodiments of the present disclosure do not limit this.

For example, as shown in FIG. 2 and FIG. 3, in the light-emitting phase 4, the driving method of the pixel circuit includes:
Step S101: setting the data scanning signal G1 as an OFF signal to turn off the data writing circuit 200;
Step S102: setting the second light-emitting control signal EM2 as an ON signal to turn on the second light-emitting control circuit 500, and keeping the first light-emitting control signal EM1 as an OFF signal to turn off the first light-emitting control circuit 400;
Step S103: setting the reset control signal G3 as an OFF signal to turn off the reset circuit 700;
Step S104: setting the first light-emitting control signal EM1 as an ON signal to turn on the first light-emitting control circuit 400, so that the second terminal 100b of the driving circuit 100 receives the first power supply voltage ELVDD through the first light-emitting control circuit 400.

In the light-emitting phase 4, the first compensation control signal G2 remains as an OFF signal to turn off the first compensation circuit 300.

For example, as shown in FIG. 1 and FIG. 3, in the first sub-light-emitting phase P9, the first light-emitting control signal EM1 is an OFF signal to turn off the first light-emitting control circuit 400; the second light-emitting control signal EM2 is an OFF signal to turn off the second light-emitting control circuit 500; the first compensation control signal G2 is an OFF signal to turn off the first compensation circuit 300; the reset control signal G3 is an ON signal to turn on the reset circuit 700. In addition, corresponding to the step S101, the data scanning signal G1 is switched to an OFF signal to turn off the data writing circuit 200, so that the data writing circuit 200 stops applying the data signal DATA to the control terminal 100m of the driving circuit 100.

For example, as shown in FIG. 1 and FIG. 3, in the second sub-light-emitting phase P10, the first light-emitting control signal EM1 is an OFF signal to turn off the first light-emitting control circuit 400; the first compensation control signal G2 is an OFF signal to turn off the first compensation circuit 300; the reset control signal G3 is an ON signal to turn on the reset circuit 700; the data scanning signal G1 is an OFF signal to turn off the data writing circuit 200. In addition, corresponding to the step S102, the second light-emitting control signal EM2 is switched to an ON signal to turn on the second light-emitting control circuit 500.

For example, as shown in FIG. 1 and FIG. 3, in the third sub-light-emitting phase P11, the first light-emitting control signal EM1 is an OFF signal to turn off the first light-emitting control circuit 400; the first compensation control signal G2 is an OFF signal to turn off the first compensation circuit 300; the data scanning signal G1 is an OFF signal to turn off the data writing circuit 200; the second light-emitting control signal EM2 is an ON signal to turn on the second light-emitting control circuit 500. In addition, corresponding to the step S103, the reset control signal G3 is switched to an OFF signal to turn off the reset circuit 700.

For example, as shown in FIG. 1 and FIG. 3, in the fourth sub-light-emitting phase P12, the first compensation control signal G2 is an OFF signal to turn off the first compensation circuit 300; the data scanning signal G1 is an OFF signal to turn off the data writing circuit 200; the second light-emitting control signal EM2 is an ON signal to turn on the second light-emitting control circuit 500; the reset control signal G3 is an OFF signal to turn off the reset circuit 700. In addition, corresponding to the step S104, the first light-emitting control signal EM1 is switched to an ON signal to turn on the first light-emitting control circuit 400.

For example, as shown in FIG. 1 and FIG. 3, the step corresponding to the fourth sub-light-emitting phase P12 is performed after the step corresponding to the second sub-light-emitting phase P10. For example, when the second light-emitting control circuit 500 is turned on, the voltage of the first terminal 100a of the driving circuit 100, the voltage of the first electrode 600a of the light-emitting element 600, and the voltage of the second electrode of the second storage capacitor C2 are all reset voltage VINI, the voltage value of the first terminal 100a of the driving circuit 100 has a first variation, and the voltage of the first electrode of the first storage capacitor C1 also has the first variation. Because a voltage between the two electrodes of the first storage capacitor C1 will not change suddenly, the voltage of the second electrode of the first storage capacitor C1 (that is, the voltage of the control terminal 100m of the driving circuit 100) will also produce the above-first variation accordingly, so that the gate-source voltage Vgs of the driving transistor DT (as shown in FIG. 4D) in the driving circuit 100 remains unchanged. Then, in the fourth sub-light-emitting phase P12, the first light-emitting control circuit 400 is turned on to allow the light-emitting element 600 to emit light. By adopting this driving method, when the light-emitting element 600 emits light, a voltage difference between the first terminal 100a of the driving circuit 100 and the first electrode 600a of the light-emitting element 600 may be eliminated, so as to reduce a risk of voltage jump at the first terminal 100a of the driving circuit 100.

Correspondingly, as shown in FIG. 2 and FIG. 3, in the first sub-light-emitting phase P9, the first light-emitting control signal EM1 is an OFF signal to turn off the first light-emitting control transistor T2; the second light-emitting control signal EM2 is an OFF signal to turn off the second light-emitting control transistor T4; the first compensation control signal G2 is an OFF signal to turn off the first compensation transistor T3; the reset control signal G3 is an ON signal to turn on the reset transistor T5. In addition, corresponding to the step S101, the data scanning signal G1 is switched to an OFF signal to turn off the data writing transistor T1, so that the data signal DATA stops being applied to the control terminal 100m of the driving circuit 100.

Correspondingly, as shown in FIG. 2 and FIG. 3, in the second sub-light-emitting phase P10, the first light-emitting control signal EM1 is an OFF signal to turn off the first light-emitting control transistor T2; the first compensation control signal G2 is an OFF signal to turn off the first compensation transistor T3; the reset control signal G3 is an ON signal to turn on the reset transistor T5; the data scanning signal G1 is an OFF signal to turn off the data writing transistor T1. In addition, corresponding to the step S102, the second light-emitting control signal EM2 is switched to an ON signal to turn on the second light-emitting control transistor T4.

Correspondingly, as shown in FIG. 2 and FIG. 3, in the third sub-light-emitting phase P11, the first light-emitting control signal EM1 is an OFF signal to turn off the first light-emitting control transistor T2; the first compensation control signal G2 is an OFF signal to turn off the first compensation transistor T3; the data scanning signal G1 is an OFF signal to turn off the data writing transistor T1; the second light-emitting control signal EM2 is an ON signal to turn on the second light-emitting control transistor T4. In addition, corresponding to the step S103, the reset control signal G3 is switched to an OFF signal to turn off the reset transistor T5.

Correspondingly, as shown in FIG. 3 and FIG. 4D, in the fourth sub-light-emitting phase P12, the first compensation control signal G2 is an OFF signal to turn off the first light-emitting control transistor T3; the data scanning signal G1 is an OFF signal to turn off the data writing transistor T1; the second light-emitting control signal EM2 is an ON signal to turn on the second light-emitting control transistor T4; the reset control signal G3 is an OFF signal to turn off the reset transistor T5. In addition, corresponding to the step S104, the first light-emitting control signal EM1 is switched to an ON signal to turn on the first light-emitting control transistor T2.

For example, as shown in FIG. 2, FIG. 3 and FIG. 4D, the step corresponding to the fourth sub-light-emitting phase P12 is performed after the step corresponding to the second sub-light-emitting phase P10. For example, when the second light-emitting control transistor T4 is turned on, the voltage of the first electrode of the driving transistor DT, the voltage of the first electrode of the light-emitting element OLED, and the voltage of the second electrode of the second storage capacitor C2 are all reset voltage VINI, the voltage value of the first electrode of the driving transistor DT has a first variation, and the voltage of the first electrode of the first storage capacitor C1 also has the first variation, and then the voltage of the second electrode of the first storage capacitor C1 (that is, the voltage of the gate electrode of the driving transistor DT) will also produce the above first variation accordingly, so that the gate-source voltage Vgs of the driving transistor DT remains unchanged. Then, in the fourth sub-light-emitting phase P12, the first light-emitting control transistor T3 is turned on to allow the light-emitting element OLED to emit light. By adopting this driving method, when the light-emitting element OLED emits light, the voltage difference between the first electrode of the driving transistor DT and the first electrode of the light-emitting element OLED may be eliminated to reduce the risk of voltage jump of the first electrode of the driving transistor DT.

For example, as shown in FIG. 3 and FIG. 4D, when the steps in the first sub-light-emitting phase P9, the second sub-light-emitting phase P10, the third sub-light-emitting phase P11 and the fourth sub-light-emitting phase P12 are completed, because the voltage value of the first electrode of the driving transistor DT is Vini, a variation thereof is ΔV=Vini−[Vref−Vth+(Vdata−Vref)×C1/(C1+C2)], so that the voltage value of the gate electrode of the driving transistor DT and the voltage value of the first electrode of the first storage capacitor C1 are both equal to Vdata−[Vref−Vth+C1/(C1+C2)×(Vdata−Vref)−Vini], and the gate-source voltage Vgs of the driving transistor DT is Vdata−Vref+Vth−C1/(C1+C2)×(Vdata−Vref).

A value I of the driving current flowing through the light-emitting element may be obtained according to a formula below:
I=K×(Vgs−Vth)², where K is a conductivity coefficient of the driving transistor DT.

That is:

I=K×[(Vdata−Vref)×C2/(C1+C2)]²

According to the above formula, the value I of the driving current flowing through the light-emitting element is no longer related to the threshold voltage Vth of the driving transistor, so that compensation for the pixel circuit may be implemented, the problem of a drift of the threshold voltage Vth caused by a technological process and long-term operation of the driving transistor can be solved, and its impact on the driving current can be eliminated, thereby improving the display effect of the display apparatus using the pixel circuit.

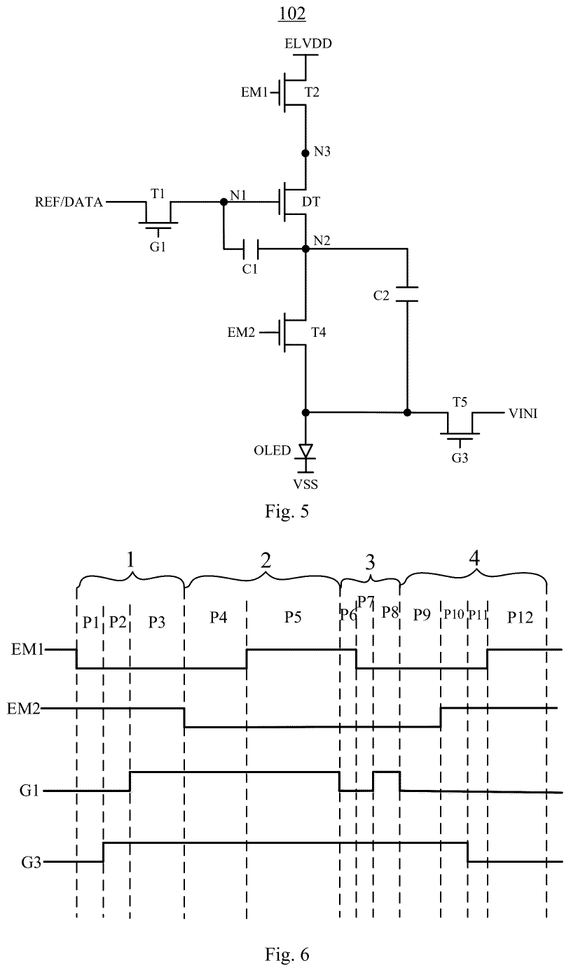

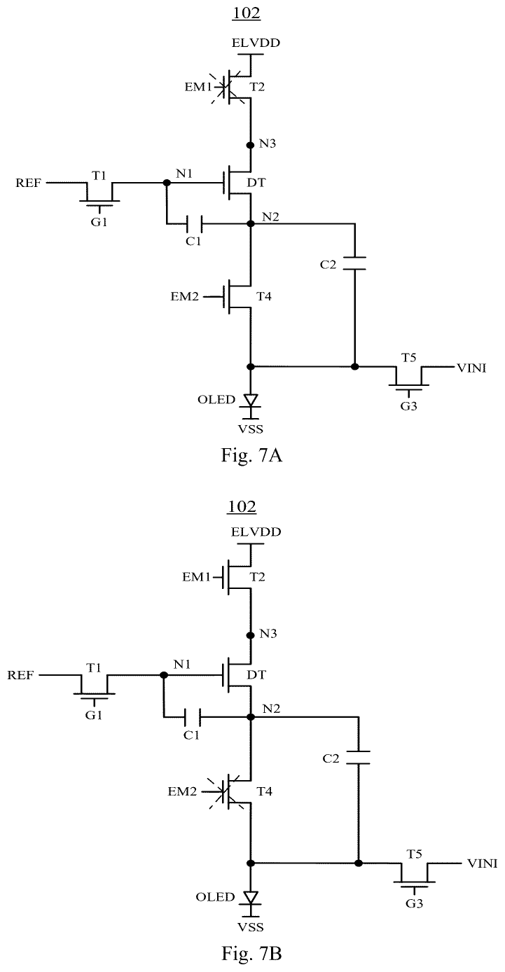

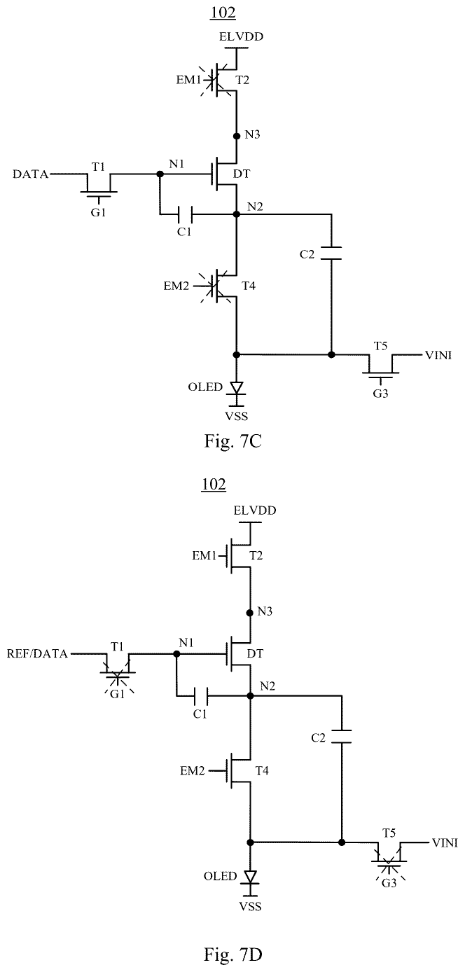

FIG. 5 is a schematic diagram of another pixel circuit provided by an embodiment of the present disclosure; FIG. 6 is a signal timing diagram corresponding to the pixel circuit shown in FIG. 5; FIG. 7A is a schematic diagram of the pixel circuit in FIG. 5 in a third sub-reset phase; FIG. 7B is a schematic diagram of the pixel circuit in FIG. 5 in a second sub-compensation phase; FIG. 7C is a schematic diagram of the pixel circuit in FIG. 5 in a third sub-data writing phase; FIG. 7D is a schematic diagram of the pixel circuit in FIG. 5 in a fourth sub-light-emitting phase. In addition, transistors marked with dotted lines in FIG. 7A to FIG. 7D are all in an OFF state in a corresponding phase.

For example, as shown in FIG. 5, a difference between the pixel circuit 102 and the pixel circuit 101 shown in FIG. 2 is that the data transistor T1 and the first compensation transistor T3 are different in terms of structure. For other structures in the pixel circuit 102, please refer to a relevant description of FIG. 2 in the above embodiment, which will not be repeated here.

For example, in the pixel circuit 101 shown in FIG. 2, the data writing transistor T1 and the first compensation transistor T3 are transistors controlled independently of each other, the data scanning signal terminal G1 and the first compensation control signal terminal G2 are different signal terminals independent of each other, and the data signal terminal DATA and the reference signal terminal REF are different signal terminals independent of each other. For example, the data writing transistor T1 is turned on or off under control of the data scanning signal G1, the first compensation transistor T3 is turned on or off under control of the first compensation control signal G2, and the data writing transistor T1 and the first compensation transistor T3 are controlled independently.

For example, as shown in FIG. 5, the data writing transistor T1 also serves the first compensation transistor T3, the data scanning signal G1 also serves the first compensation control signal G2, the first electrode of the data writing transistor T1 is also electrically connected to the reference signal terminal REF to receive the reference signal REF, the data signal terminal DATA also serves the reference signal terminal REF, and is configured to provide the data signal DATA or the reference signal REF in different time periods respectively.

For example, as shown in FIG. 6, during a driving process of the pixel circuit 102, an operating state (for example, the ON or OFF state) of each transistor is same as that of the pixel circuit 101 shown in FIG. 2. Compared with the timing diagram shown in FIG. 3, timing states of the first light-emitting control signal EM1, the second light-emitting control signal EM2 and the reset control signal G3 in the timing diagram in FIG. 6 remain unchanged, except that a timing distribution of the first compensation control signal G2 is omitted, and a timing state of the data scanning signal G1 is different.

For example, as shown in FIG. 6 and FIG. 7A, in the first sub-reset phase P1 and the second sub-reset phase P2, the data scanning signal G1 is an OFF signal so that the data writing transistor T1 is in the OFF state. In the third sub-reset phase P3, the data scanning signal G1 is an ON signal so that the data writing transistor T1 is in the ON state, and the first electrode of the data writing transistor T1 is electrically connected to the reference signal terminal REF to receive the reference signal REF, and the reference signal REF is applied to the gate electrode of the driving transistor DT.

For example, as shown in FIG. 6 and FIG. 7B, in the first sub-compensation phase P4 and the second sub-compensation phase P5, the data scanning signal G1 remains as an ON signal so that the data writing transistor T1 is in the ON state, and the first electrode of the data writing transistor T1 is electrically connected to the reference signal terminal REF to receive the reference signal REF, and the reference signal REF is applied to the gate electrode of the driving transistor DT.

For example, as shown in FIG. 6 and FIG. 7C, in the first sub-data writing phase P6 and the second sub-data writing phase P7, the data scan signal G1 is an OFF signal so that the data writing transistor T1 is in the OFF state. In the third sub-data writing phase P8, the data scanning signal G1 is an ON signal to turn on the data writing transistor T1, and the first electrode of the data writing transistor T1 is electrically connected to the data signal terminal DATA to receive the data signal DATA, and the data signal DATA is applied to the gate electrode of the driving transistor DT.

For example, as shown in FIG. 6 and FIG. 7D, in the light-emitting phase 4, the data scanning signal G1 is an OFF signal so that the data writing transistor T1 is in the OFF state.

As described above, by allowing the data writing transistor multiplexed as the first compensation transistor, the data signal terminal may receive different signals in different operating phases, so as to simplify a structure of the pixel circuit while satisfying an operating requirement of the pixel circuit and causing a controlling manner thereof to be more flexible.

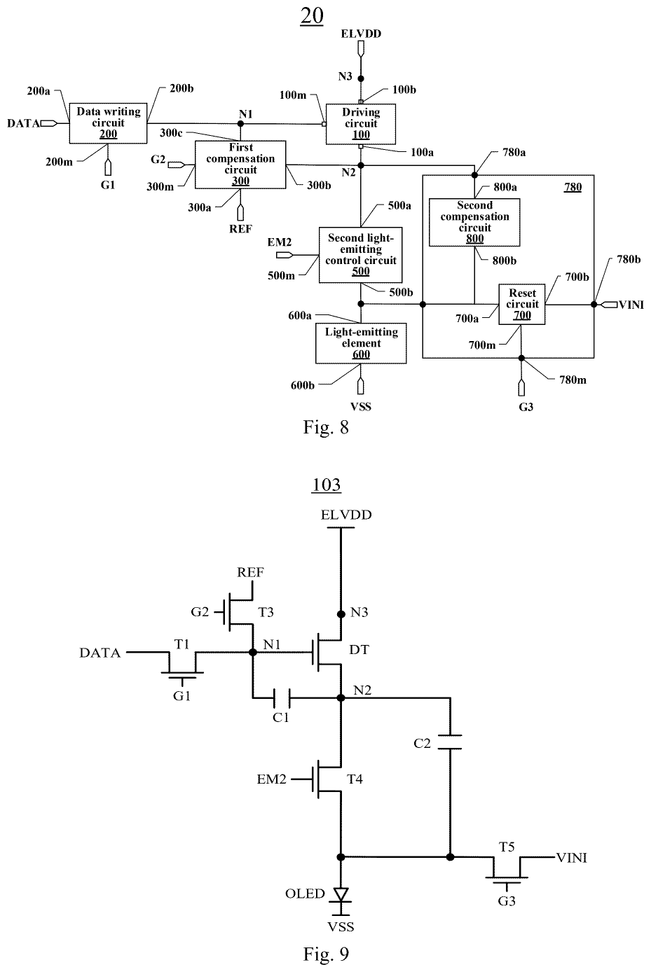

FIG. 8 is a schematic block diagram of another pixel circuit provided by at least one embodiment of the present disclosure.

For example, as shown in FIG. 8, compared with the pixel circuit 10 shown in FIG. 1, the pixel circuit 20 is different in that the first light-emitting control circuit 400 is removed. For other structures in the pixel circuit 20, please refer to a relevant description of FIG. 1 in the above embodiment, which will not be repeated here.

For example, as shown in FIG. 8, the second terminal of the driving circuit 100 is directly electrically connected to the first voltage terminal ELVDD to receive the first power supply voltage ELVDD, that is, no other transistors or capacitors are provided between the second terminal of the driving circuit 100 and the first voltage terminal ELVDD, and the second terminal of the driving circuit 100 is electrically connected to the first voltage terminal ELVDD through a wire.

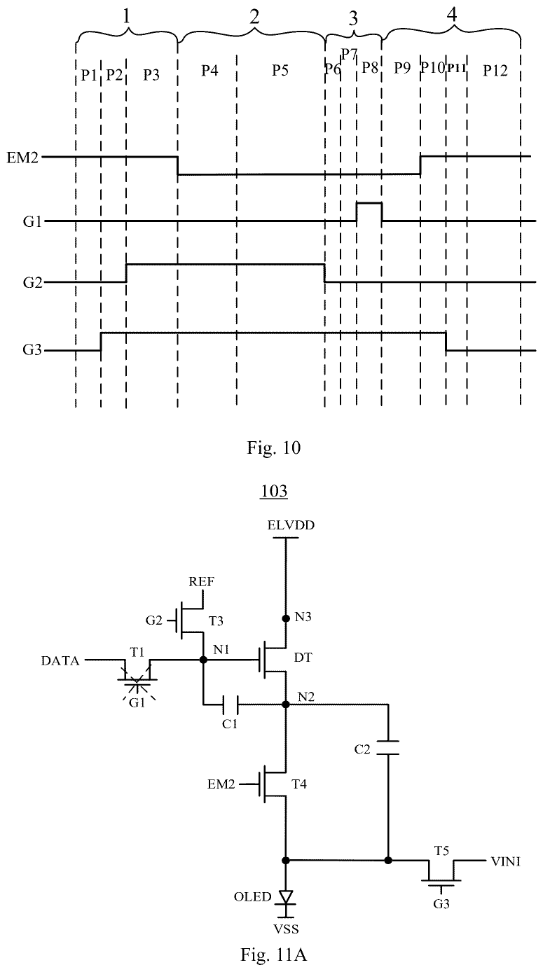

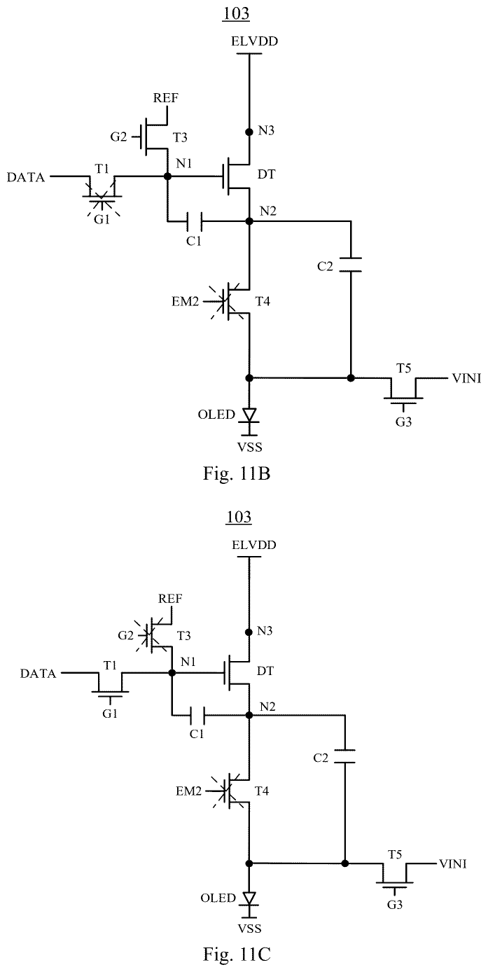

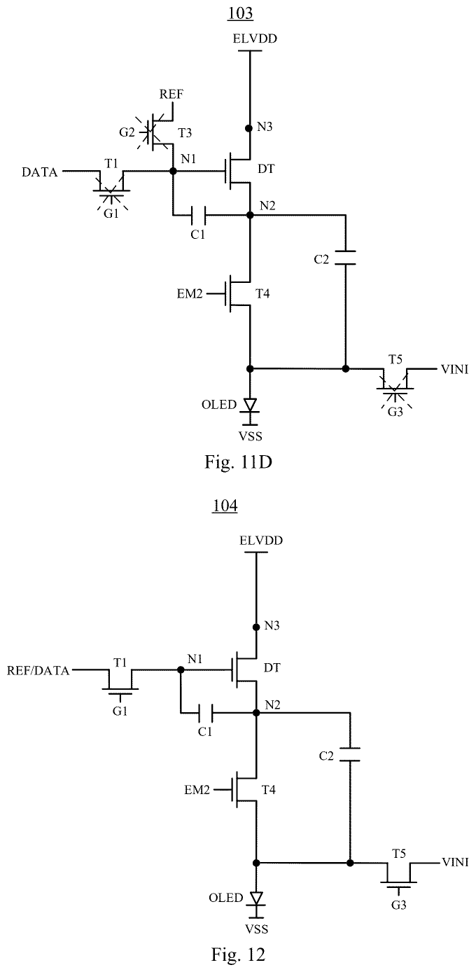

FIG. 9 is a circuit diagram of an implementation example of the pixel circuit shown in FIG. 8; FIG. 10 is a signal timing diagram corresponding to the pixel circuit shown in FIG. 9; FIG. 11A is a schematic diagram of the pixel circuit shown in FIG. 9 in a third sub-reset phase; FIG. 11B is a schematic diagram of the pixel circuit shown in FIG. 9 in a second sub-compensation phase; FIG. 11C is a schematic diagram of the pixel circuit shown in FIG. 9 in a third sub-data writing phase; and FIG. 11D is a schematic diagram of the pixel circuit shown in FIG. 9 in a fourth sub-light-emitting phase. In addition, transistors marked with dotted lines in FIG. 11A to FIG. 11D are all in an OFF state in a corresponding phase.

For example, as shown in FIG. 9, a difference between the pixel circuit 103 and the pixel circuit 101 shown in FIG. 1 is that the first light-emitting control transistor T2 is omitted, and other structures are the same.

For example, as shown in FIG. 9 and FIG. 10, in a driving process of the pixel circuit 103, an operating state (for example, the ON or OFF state) of each transistor is same as the pixel circuit 101 shown in FIG. 2. Compared with the timing diagram shown in FIG. 3, a timing distribution corresponding to the first light-emitting control signal EM1 is omitted in the timing diagram shown in FIG. 10.

For example, as shown in FIG. 10 and FIG. 11A, in the third sub-reset phase P3, the data scanning signal G1 remains as a low-level signal to turn off the data writing transistor T1; the second light-emitting control signal EM2 is a high-level signal to turn on the second light-emitting control transistor T4; the reset control signal G3 is a high-level signal, so that the reset transistor T5 is in the ON state; the first compensation control signal G2 is a high-level signal to turn on the first compensation transistor T3. Because the gate-source voltage Vgs of the driving transistor DT is greater than its threshold voltage Vth in this phase, the driving transistor DT is in the ON state. In addition, the second terminal of the driving transistor DT receives the first power supply voltage ELVDD, so that the driving transistor DT is charged.

For example, as shown in FIG. 10 and FIG. 11B, in the second sub-compensation phase P5, the data scanning signal G1 remains as an OFF signal to turn off the data writing circuit 200; the first compensation control signal G2 and the reset control signal G3 are both ON signals, so that the first compensation circuit 300 and the reset circuit 700 are both in an ON state; the second light-emitting control signal EM2 remains as an OFF signal to turn off the second light-emitting control circuit 500. The first power supply voltage ELVDD charges the driving transistor DT until the driving transistor DT is turned off, and the voltage value Vs at the first electrode of the driving transistor DT is equal to Vref−Vth.

For example, as shown in FIG. 10 and FIG. 11C, in the third sub-data writing phase P8, the second light-emitting control signal EM2 is an OFF signal to turn off the second light-emitting control transistor T4; the reset control signal G3 is an ON signal, so that the reset transistor T5 is in the ON state; the first compensation control signal G2 is an OFF signal to turn off the first compensation transistor T3; the data scanning signal G1 is switched to an ON signal to turn on the data writing transistor T1, so that the data signal DATA is written into the gate electrode of the driving transistor DT. In addition, the second terminal of the driving transistor DT receives the first power supply voltage ELVDD, so that the driving transistor DT is charged.

For example, as shown in FIG. 10 and FIG. 11D, in the fourth sub-light-emitting phase P12, the first compensation control signal G2 is an OFF signal to turn off the first light-emitting control transistor T3; the data scanning signal G1 is an OFF signal to turn off the data writing transistor T1; the second light-emitting control signal EM2 is an ON signal to turn on the second light-emitting control transistor T4; the reset control signal G3 is an OFF signal to turn off the reset transistor T5; the second terminal of the driving transistor DT keeps receiving the first power supply voltage ELVDD, so that the light-emitting element OLED emits light.

For example, as shown in FIG. 10 and FIG. 11C, mobility of the driving transistor is positively correlated with temperature, that is, when the temperature rises, the mobility increases; and the driving current is positively correlated with the gate-source voltage Vgs of the driving circuit. In the third sub-data writing phase P8, when the data signal DATA is written into the gate electrode of the driving transistor DT and the driving transistor DT is charged, for example, when the temperature of the pixel circuit 103 is high, the mobility is large, and accordingly, the voltage at the first electrode of the driving transistor DT may be high within a certain charging time, so that the gate-source voltage Vgs of the driving transistor DT is small, and thus the driving current is not too large. For example, when the temperature of the pixel circuit 103 is low, the mobility is small, and accordingly, the voltage at the first electrode of the driving transistor DT may be low within a certain charging time, so that the gate-source voltage Vgs of the driving transistor DT is large, and thus the driving current is not too small.

Therefore, in the third sub-data writing phase P8, by removing the first light-emitting control transistor T2 (that is, removing the first light-emitting control circuit), the second electrode of the driving transistor DT continues to receive the first power supply voltage ELVDD, the mobility of the driving transistor DT at different temperatures may be compensated to reduce the impact of temperature change on the driving current in the pixel circuit.

FIG. 4E is a signal timing diagram of another driving method provided by at least one embodiment of the present disclosure. For example, a difference between the signal timing diagram shown in FIG. 4E and the signal timing diagram shown in FIG. 3 is that a timing distribution of the first light-emitting control signal EM1 in the third sub-data writing phase P8 is different, and timing distributions of the other signals are the same.

For example, for some pixel circuits provided by the embodiments of the present disclosure, such as the pixel circuit in FIG. 2 and the pixel circuit in FIG. 5 mentioned above, the step S3030 in the driving method of the pixel circuit further includes: setting the first light-emitting control signal as an ON signal to turn on the first light-emitting control circuit, so that the second terminal of the driving circuit receives the first power supply voltage.

For example, as shown in FIG. 1 and FIG. 4E, in the third sub-data writing phase P8, when the data scanning signal G1 is an ON signal to turn on the data writing circuit 200, the first light-emitting control signal EM1 is an ON signal to turn on the first light-emitting control circuit 400, so that the second terminal 100b of the driving circuit 100 receives the first power supply voltage ELVDD; the second light-emitting control signal EM2 remains as an OFF signal to turn off the second light-emitting control circuit 500; the reset control signal G3 remains as an ON signal, so that the reset circuit 700 is in the ON state; the first compensation control signal G2 is an OFF signal to turn off the first compensation circuit 300.

Accordingly, as shown in FIG. 4C and FIG. 4E, in the third sub-data writing phase, the data scanning signal G1 is switched to an ON signal to turn on the data writing transistor T1, so that the data signal DATA is written into the gate electrode of the driving transistor DT; the first light-emitting control signal EM1 is switched to an ON signal to turn on the first light-emitting control transistor T2, and the first power supply voltage ELVDD is applied to the second terminal 100b of the driving circuit 100; and the second light-emitting control signal EM2 remains as an OFF signal to turn off the second light-emitting control transistor T4; the reset control signal G3 remains as an ON signal, so that the reset transistor T5 is in the ON state; the first compensation control signal G2 remains as an OFF signal to turn off the first compensation transistor T3.

In this way, when the temperature of the pixel circuit is high, the mobility is large, and accordingly, the voltage of the first electrode of the driving transistor may be made higher, so that the gate-source voltage Vgs of the driving transistor DT is small, and the driving current is not too large. On the contrary, when the temperature of the pixel circuit is low, the mobility is low, and accordingly, the voltage at the first electrode of the driving transistor may be low, so that the gate-source voltage Vgs of the driving transistor is large, and the driving current is not too small.

Therefore, in the third sub-data writing phase, by omitting the first light-emitting control transistor T2 and causing the second electrode of the driving transistor to continue to receive the first power supply voltage, the mobility of the driving transistor DT at different temperatures may be compensated to reduce the impact of temperature change on the driving current in the pixel circuit.

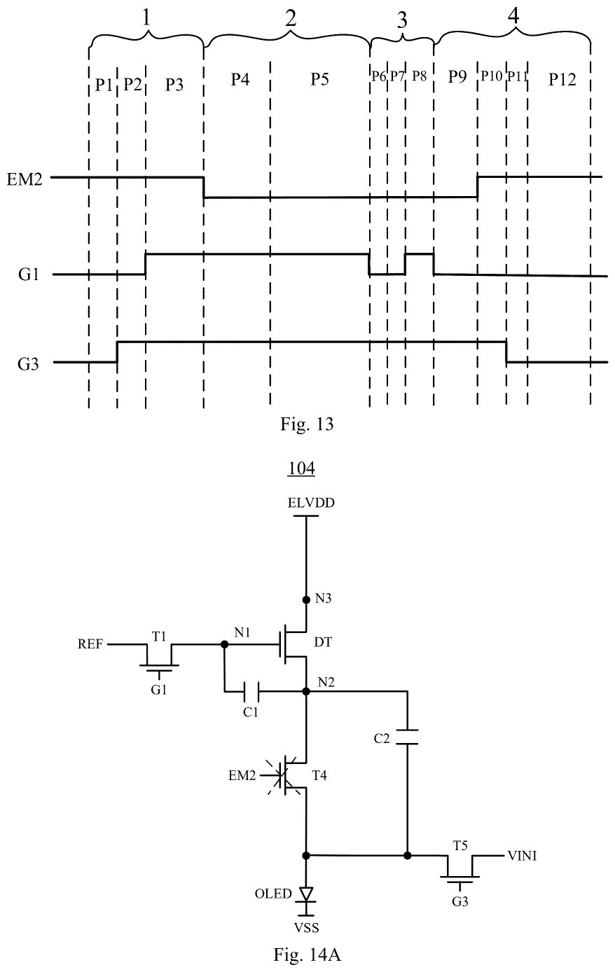

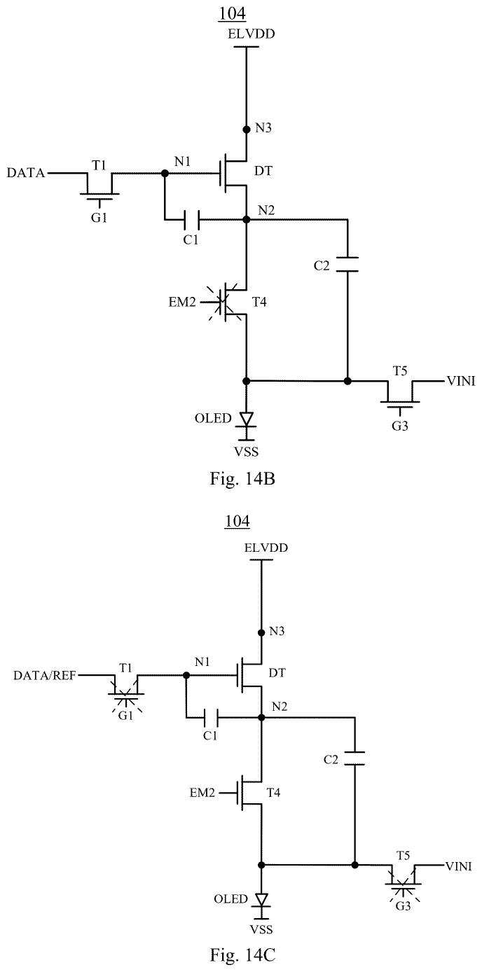

FIG. 12 is a schematic diagram of another pixel circuit provided by an embodiment of the present disclosure; FIG. 13 is a signal timing diagram corresponding to the pixel circuit shown in FIG. 12; FIG. 14A is a schematic diagram of the pixel circuit in FIG. 12 in a second sub-compensation phase; FIG. 14B is a schematic diagram of the pixel circuit in FIG. 12 in a third sub-data writing phase; and FIG. 14C is a schematic diagram of the pixel circuit in FIG. 12 in a fourth sub-light-emitting phase. In addition, transistors marked with dotted lines in FIG. 14A to FIG. 14C are all in an OFF state in a corresponding phase.

For example, as shown in FIG. 12, a difference between the pixel circuit 104 and the pixel circuit 103 shown in FIG. 9 is that the data transistor T1 and the first compensation transistor T3 are different in terms of structure. For other structures in the pixel circuit 104, please refer to a relevant description of FIG. 9 in the above embodiment, which will not be repeated here.

For example, in the pixel circuit 103 shown in FIG. 9, the data writing transistor T1 and the first compensation transistor T3 are transistors controlled independently of each other, the data scanning signal terminal G1 and the first compensation control signal terminal G2 are different signal terminals independent of each other, and the data signal terminal DATA and the reference signal terminal REF are different signal terminals independent of each other. For example, the data writing transistor T1 is turned on or off under control of the data scanning signal G1, the first compensation transistor T3 is turned on or off under control of the first compensation control signal G2, and the data writing transistor T1 and the first compensation transistor T3 are controlled independently.

For example, as shown in FIG. 12, the data writing transistor T1 also serves the first compensation transistor T3, the data scanning signal G1 also serves the first compensation control signal G2 (see FIG. 9), the first electrode of the data writing transistor T1 is also electrically connected to the reference signal terminal REF to receive the reference signal REF, the data signal terminal DATA also serves the reference signal terminal REF, and is configured to provide the data signal DATA or the reference signal REF in different time periods.

For example, as shown in FIG. 13, during a driving process of the pixel circuit 104, an operating state (for example, the ON or OFF state) of each transistor is same as that of the pixel circuit 103 shown in FIG. 9. Compared with the timing diagram shown in FIG. 10, timing states of the second light-emitting control signal EM2 and the reset control signal G3 in the timing diagram in FIG. 13 remain unchanged, except that a timing distribution of the first compensation control signal G2 is omitted, and a timing state of the data scanning signal G1 is different.

For example, as shown in FIG. 13 and FIG. 12, in the first sub-reset phase P1 and the second sub-reset phase P2, the data scanning signal G1 is an OFF signal so that the data writing transistor T1 is in the OFF state. In the third sub-reset phase P3, the data scanning signal G1 is an ON signal so that the data writing transistor T1 is in the ON state, and the first electrode of the data writing transistor T1 is electrically connected to the reference signal terminal REF to receive the reference signal REF, and the reference signal REF is applied to the gate electrode of the driving transistor DT.

For example, as shown in FIG. 13 and FIG. 14A, in the first sub-compensation phase P4 and the second sub-compensation phase P5, the data scanning signal G1 remains as an ON signal so that the data writing transistor T1 is in the ON state, and the first electrode of the data writing transistor T1 is electrically connected to the reference signal terminal REF to receive the reference signal REF, and the reference signal REF is applied to the gate electrode of the driving transistor DT.

For example, as shown in FIG. 13 and FIG. 14B, in the first sub-data writing phase P6 and the second sub-data writing phase P7, the data scanning signal G1 is an OFF signal so that the data writing transistor T1 is in the OFF state. In the third sub-data writing phase P8, the data scanning signal G1 is an ON signal to turn on the data writing transistor T1, and the first electrode of the data write transistor T1 is electrically connected to the data signal terminal DATA to receive the data signal DATA, and the data signal DATA is applied to the gate electrode of the driving transistor DT.

For example, as shown in FIG. 13 and FIG. 14C, in the light-emitting phase 4, the data scanning signal G1 is an OFF signal so that the data writing transistor T1 is in the OFF state.

As described above, by allowing the data writing transistor to be multiplexed as the first compensation transistor, the data signal terminal may receive different signals in different operating phases, so as to simplify the structure of the pixel circuit while satisfying an operating requirement of the pixel circuit and causing a controlling manner thereof to be more flexible. For other structures and technical effects of the pixel circuit 104 shown in FIG. 12, please refer to the relevant description of FIG. 9 in the above embodiment, which will not be repeated here.

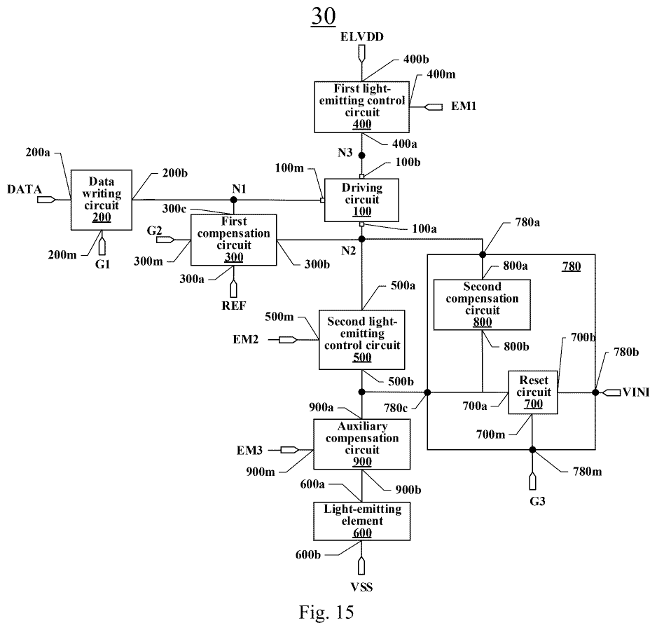

FIG. 15 is a schematic block diagram of another pixel circuit provided by at least one embodiment of the present disclosure.

For example, as shown in FIG. 15, compared with the pixel circuit 10 shown in FIG. 1, the pixel circuit 30 differs in that an auxiliary compensation circuit 900 is added. For other structures in the pixel circuit 30, please refer to the relevant description of FIG. 1 in the above embodiment, which will not be repeated here.

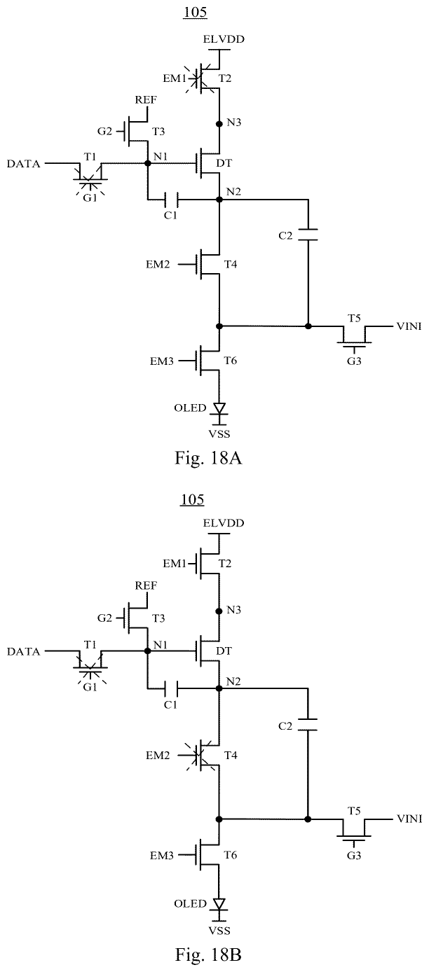

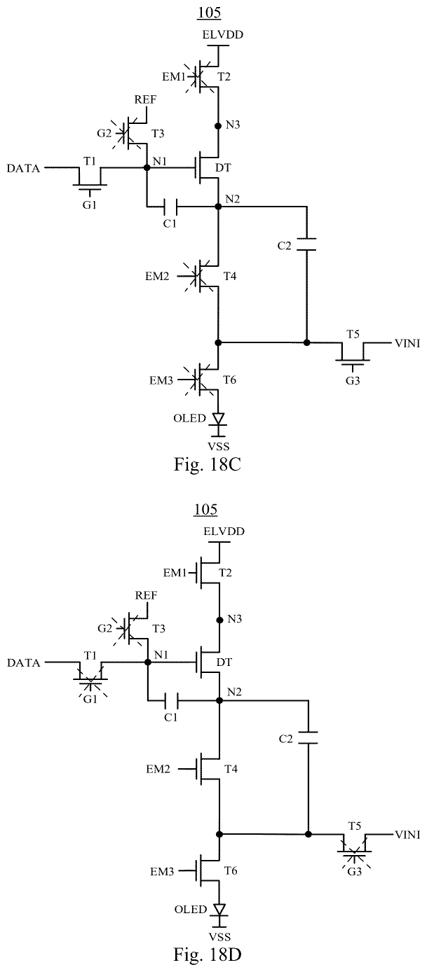

For example, as shown in FIG. 15 and FIG. 18A, the pixel circuit 30 includes an auxiliary compensation circuit 900, a control terminal 900m of the auxiliary compensation circuit 900 is configured to receive an auxiliary compensation signal EM3, a first terminal 900a of the auxiliary compensation circuit 900 is electrically connected to the second electrode of the second storage capacitor C2, the second terminal 500b of the second light-emitting control circuit 500, and the first terminal 700a of the reset circuit 700, and a second terminal 900b of the auxiliary compensation circuit 900 is electrically connected to the first electrode 600a of the light-emitting element 600.

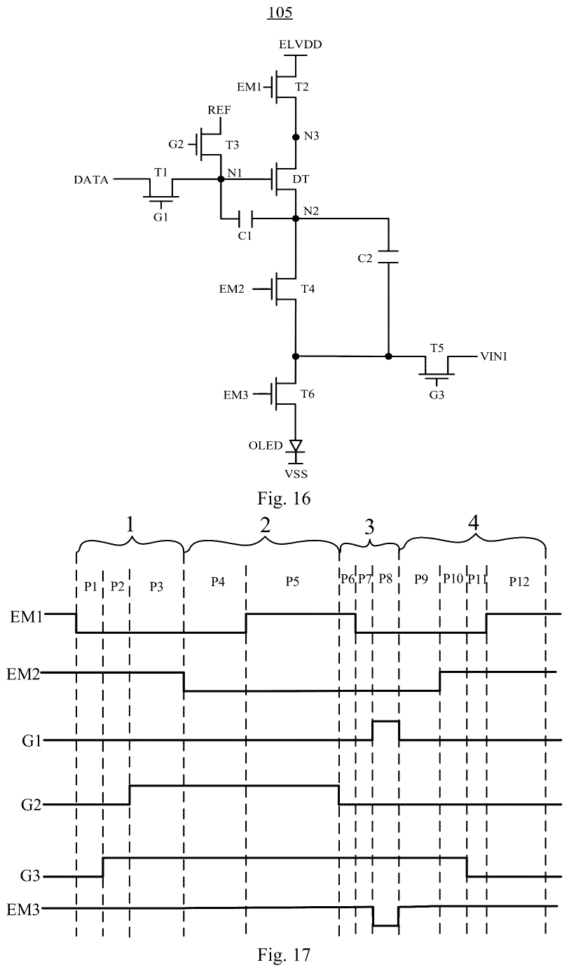

FIG. 16 is a circuit diagram of an implementation example of the pixel circuit shown in FIG. 15; FIG. 17 is a signal timing diagram of another driving method provided by at least one embodiment of the present disclosure; FIG. 18A is a schematic diagram of the pixel circuit shown in FIG. 15 in a third sub-reset phase; FIG. 18B is a schematic diagram of the pixel circuit shown in FIG. 15 in a second sub-compensation phase; FIG. 18C is a schematic diagram of the pixel circuit shown in FIG. 15 in a third sub-data writing phase; FIG. 18D is a schematic diagram of the pixel circuit shown in FIG. 15 in a fourth sub-light-emitting phase. In addition, transistors marked with dotted lines in FIG. 18A to FIG. 18D are all in an OFF state in a corresponding phase.

For example, as shown in FIG. 16, a difference between the pixel circuit 105 and the pixel circuit 101 shown in FIG. 2 is that an auxiliary compensation transistor T6 is added. For other structures and technical effects in the pixel circuit 105, please refer to the relevant description of FIG. 2 in the above embodiment, which will not be repeated here.

For example, as shown in FIG. 16, the auxiliary compensation circuit 900 (see FIG. 15) includes an auxiliary compensation transistor T6, a gate electrode of the auxiliary compensation transistor T6 is electrically connected to an auxiliary compensation control terminal EM3 to receive an auxiliary compensation control signal EM3, a first electrode of the auxiliary compensation transistor T6 is electrically connected to the second electrode of the second storage capacitor C2 and the second electrode of the second light-emitting control transistor T4, and a second electrode of the auxiliary compensation transistor T6 is electrically connected to the first electrode 600a of the light-emitting element 600. For example, the gate electrode of the auxiliary compensation transistor T6 and the gate electrode of the second light-emitting control transistor T4 are independent of each other and are not electrically connected. For example, the auxiliary compensation transistor T6 is turned on or off under control of the auxiliary compensation control signal EM3, the auxiliary compensation control terminal EM3 is an independent control terminal, and the auxiliary compensation control signal EM3 and the second light-emitting control signal EM2 are different signals. For example, the auxiliary compensation transistor T6 may be an N-type transistor, and a type thereof may be same or different from types of other transistors in the pixel circuit 105, and the embodiments of the present disclosure do not limit this.

For example, as shown in FIG. 17, during a driving process of the pixel circuit 105, an operating state (for example, the ON or OFF state) of each transistor is same as the pixel circuit 101 shown in FIG. 2. Compared with the timing diagram shown in FIG. 3, a timing distribution of the auxiliary compensation control signal EM3 is added to the timing diagram in FIG. 17.

For example, as shown in FIG. 17 to FIG. 18D, in the reset phase 1, the compensation phase 2, and the light-emitting phase 4, the auxiliary compensation control signal EM3 is an ON signal, so that the auxiliary compensation transistor T6 is in an ON state. For example, in the first sub-data writing phase P6 and the second sub-data writing phase P7, the auxiliary compensation control signal EM3 is an ON signal, but the embodiments of the present disclosure are not limited thereto. For example, in some embodiments, in the first sub-data writing phase P6 and the second sub-data writing phase P7, the auxiliary compensation control signal EM3 may also be an OFF signal.

For example, as shown in FIG. 17 and FIG. 18C, in the third sub-data writing phase P8, the auxiliary compensation control signal EM3 is an OFF signal, so that the auxiliary compensation transistor T6 is in an OFF state. Because the light-emitting element OLED has a capacitor, and when the auxiliary compensation transistor T6 is turned on, the capacitor in the light-emitting element OLED is connected in series with the second storage capacitor C2.

Therefore, as shown in FIG. 17 and FIG. 18C, in the third sub-data writing phase P8, when the data writing transistor T1 is turned on and the data signal DATA is written into the gate electrode of the driving transistor DT, the auxiliary compensation transistor T6 is turned off, so that the impact of the capacitance in the light-emitting element OLED on the voltage of the second terminal of the second storage capacitor C2 may be reduced, so that the voltage value of the second terminal of the second storage capacitor C2 is equal to the value of the reset voltage Vini, and the voltage of the first terminal of the driving transistor DT may be caused to be more stable.

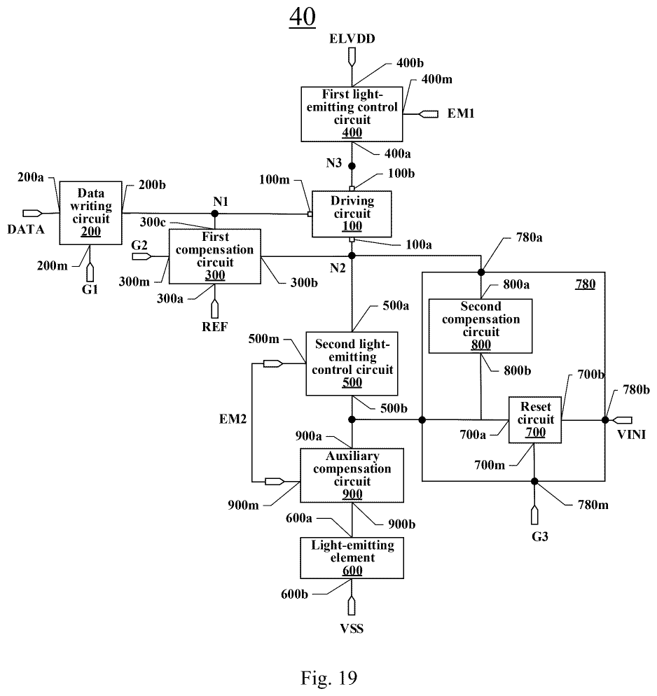

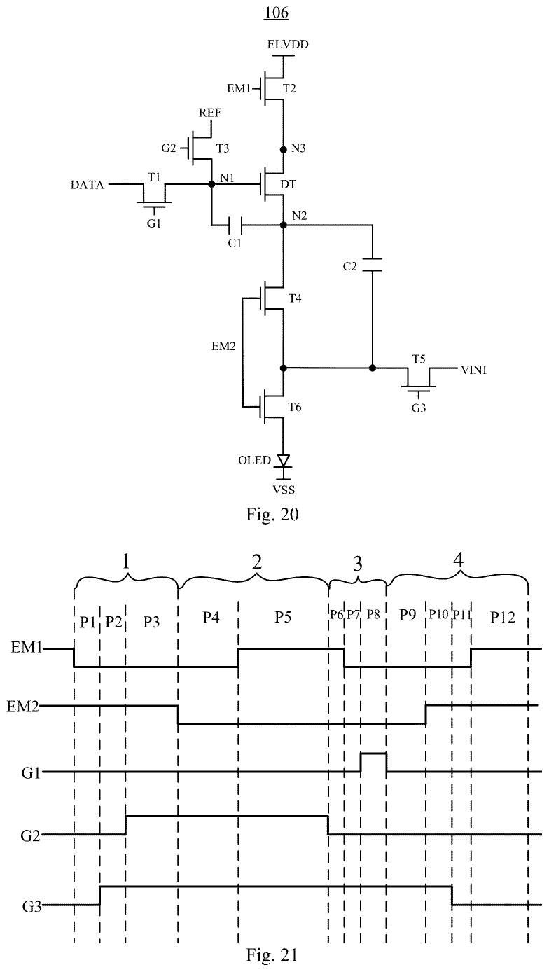

FIG. 19 is a schematic block diagram of another pixel circuit provided by at least one embodiment of the present disclosure. FIG. 20 is a circuit diagram of an implementation example of the pixel circuit shown in FIG. 19; FIG. 21 is a signal timing diagram of another driving method provided by at least one embodiment of the present disclosure.

For example, as shown in FIG. 19, compared with the pixel circuit 30 shown in FIG. 15, a pixel circuit 40 differs in that a connection manner of the control electrode 900m of the auxiliary compensation circuit 900 is different. For other structures in the pixel circuit 40, please refer to a relevant description of FIG. 15 in the above embodiment, which will not be repeated here.

For example, as shown in FIG. 20, the gate electrode of the auxiliary compensation transistor T6 is electrically connected to the gate electrode of the second light-emitting control transistor T4, the auxiliary compensation transistor T6 and the second light-emitting control transistor T4 share a gate electrode, the second light-emitting control signal EM2 is used as the auxiliary compensation control signal EM3, and a type of the auxiliary compensation transistor T6 is same as a type of the second light-emitting control transistor T4. Therefore, when the second light-emitting control signal EM2 is an ON signal, the auxiliary compensation transistor T6 and the second light-emitting control transistor T4 are both turned on in response to the second light-emitting control signal EM2; when the second light-emitting control signal EM2 is an OFF signal, the auxiliary compensation transistor T6 and the second light-emitting control transistor T4 are both turned off in response to the second light-emitting control signal EM2.

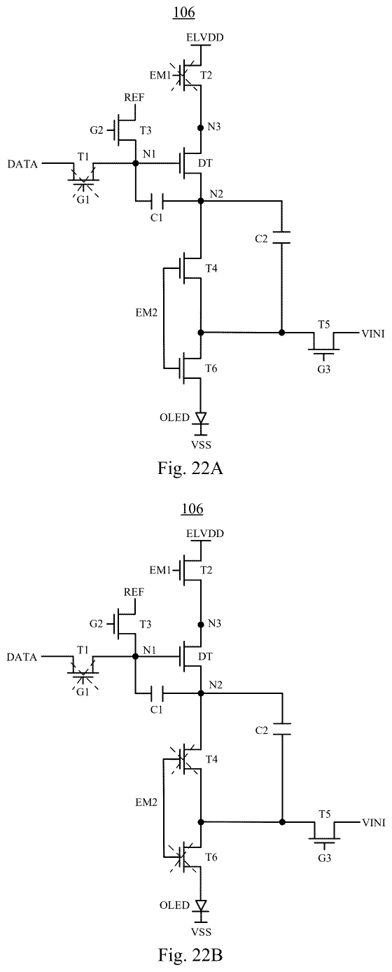

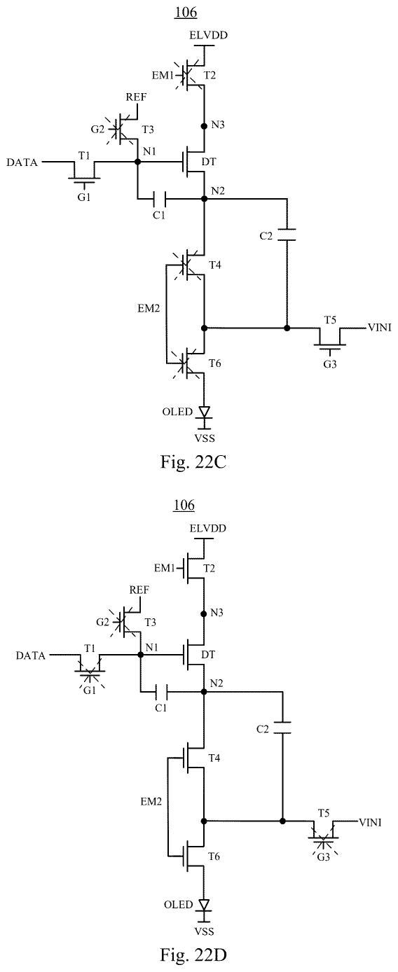

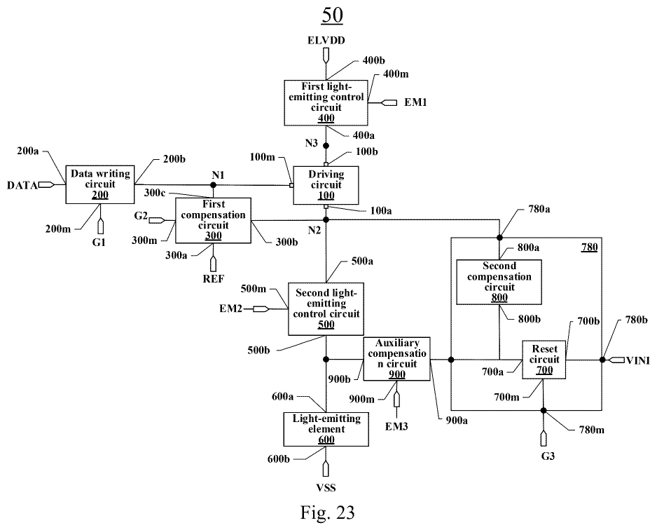

FIG. 22A is a schematic diagram of the pixel circuit in FIG. 20 in a third sub-reset phase; FIG. 22B is a schematic diagram of the pixel circuit in FIG. 20 in a second sub-compensation phase; FIG. 22C is a schematic diagram of the pixel circuit in FIG. 20 in a third sub-data writing phase; and FIG. 22D is a schematic diagram of the pixel circuit in FIG. 20 in a fourth sub-light-emitting phase.

For example, as shown in FIG. 21 and FIG. 22A, in the reset phase 1, the second light-emitting control signal EM2 is a high-level signal, and the auxiliary compensation transistor T6 and the second light-emitting control transistor T4 are both in an ON state, so that the reset signal VINI may be applied to the first terminal of the light-emitting element OLED through the auxiliary compensation transistor T6.

For example, as shown in FIG. 21 and FIG. 22B, in the compensation phase 2, the second light-emitting control signal EM2 is a low-level signal, and the auxiliary compensation transistor T6 and the second light-emitting control transistor T4 are both in an OFF state to prevent the light-emitting element OLED from emitting light in this phase.

For example, as shown in FIG. 21 and FIG. 22C, in the data writing phase 3, the second light-emitting control signal EM2 is a low-level signal, the auxiliary compensation transistor T6 and the second light-emitting control transistor T4 are both in the OFF state, and the voltage value of the second electrode of the second storage capacitor C2 is equal to the reset voltage value Vini, so that the voltage of the first electrode of the driving transistor DT may be more stable.

For example, as shown in FIG. 21 and FIG. 22D, in the first sub-light-emitting phase P9, the data scanning signal G1 is switched from a high-level signal in the third sub-data writing phase P8 to a low-level signal, and the data writing transistor T1 is switched from the ON state in the third sub-data writing phase P8 to the OFF state, so that the gate electrode of the driving transistor DT stops receiving the data signal DATA. The second light-emitting control signal EM2 remains a low-level signal, and the auxiliary compensation transistor T6 and the second light-emitting control transistor T4 are both in the OFF state.

In this way, the auxiliary compensation transistor T6 and the second light-emitting control transistor T4 may be controlled by the second light-emitting control signal EM2, which may simplify the pixel structure and cause the driving method to be more convenient. In the meantime, a risk of the auxiliary compensation transistor T6 being in the ON state may be reduced during a process of the data writing transistor T1 switching to the OFF state, thereby causing the voltage at the second electrode of the second storage capacitor C2 to be stable.

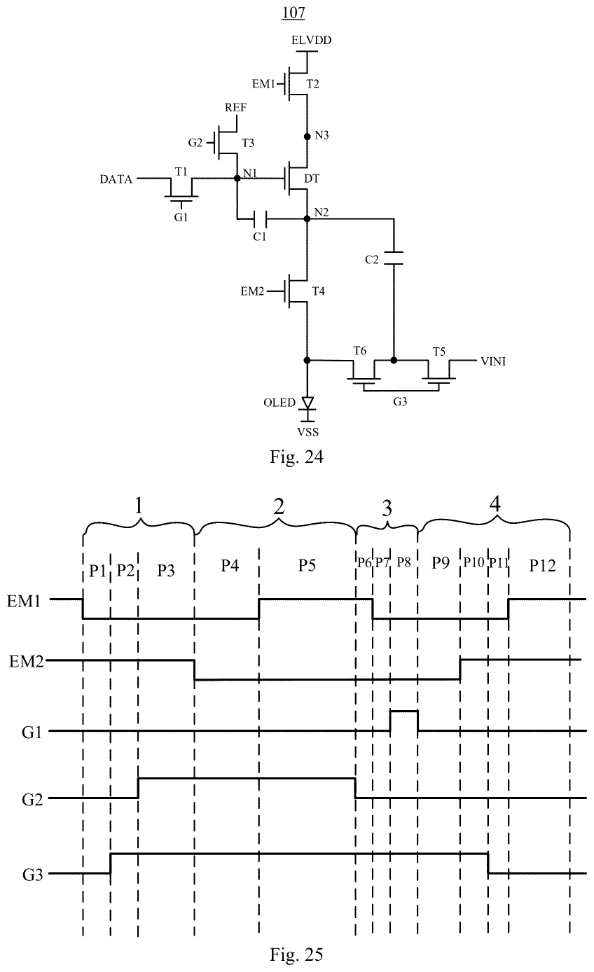

FIG. 23 is a schematic block diagram of another pixel circuit provided by at least one embodiment of the present disclosure. FIG. 24 is a circuit diagram of an implementation example of the pixel circuit shown in FIG. 23; and FIG. 25 is a signal timing diagram of another driving method provided by at least one embodiment of the present disclosure.

For example, as shown in FIG. 23, compared with the pixel circuit 30 shown in FIG. 15, a pixel circuit 50 differs in that a connection manner of the auxiliary compensation circuit 900 is different. For other structures of the pixel circuit 50, please refer to the relevant description of FIG. 15 in the above embodiment, which will not be repeated here.

For example, as shown in FIG. 23, the pixel circuit 50 includes an auxiliary compensation circuit 900, the control terminal 900m of the auxiliary compensation circuit 900 is configured to receive the auxiliary compensation signal EM3, the first terminal 900a of the auxiliary compensation circuit 900 is electrically connected to the second electrode of the second storage capacitor C2 and the first terminal 700a of the reset circuit 700, and the second terminal 900b of the auxiliary compensation circuit 900 is electrically connected to the first electrode 600a of the light-emitting element 600 and the second terminal 500b of the second light-emitting control circuit 500. For example, the control terminal 900m of the auxiliary compensation circuit 900 may be an independent control terminal, and the auxiliary compensation signal EM3 is an independent control signal to control activation or deactivation of the auxiliary compensation circuit 900, but the embodiments of the present disclosure are not limited thereto.

For example, as shown in FIG. 23 and FIG. 24, a difference between a pixel circuit 107 and a pixel circuit 105 shown in FIG. 16 is that a connection manner of the auxiliary compensation transistor T6 is different. For other structures and technical effects, please refer to relevant description of the above embodiments, which will not be repeated here.

For example, as shown in FIG. 23 and FIG. 24, the auxiliary compensation circuit 900 includes an auxiliary compensation transistor T6, a gate electrode of the auxiliary compensation transistor T6 is electrically connected to an auxiliary compensation control terminal EM3 to receive an auxiliary compensation control signal EM3, a first electrode of the auxiliary compensation transistor T6 is electrically connected to the second electrode of the second storage capacitor C2 and the first electrode of the reset transistor T5, and a second electrode of the auxiliary compensation transistor T6 is electrically connected to the first electrode 600a of the light-emitting element 600 and the second electrode of the second light-emitting control transistor T4.

For example, as shown in FIG. 24, the gate electrode of the auxiliary compensation transistor T6 is electrically connected to the gate electrode of the reset transistor T5, the auxiliary compensation transistor T6 and the reset transistor T5 share a gate electrode, the reset control signal G3 is used as the auxiliary compensation control signal EM3, and a type of the auxiliary compensation transistor T6 is same as a type of the reset transistor T5. For example, when the reset control signal G3 is an ON signal, the auxiliary compensation transistor T6 and the reset transistor T5 are both turned on in response to the reset control signal G3; when the reset control signal G3 is an OFF signal, the auxiliary compensation transistor T6 and the reset transistor T5 are both turned off in response to the reset control signal G3.

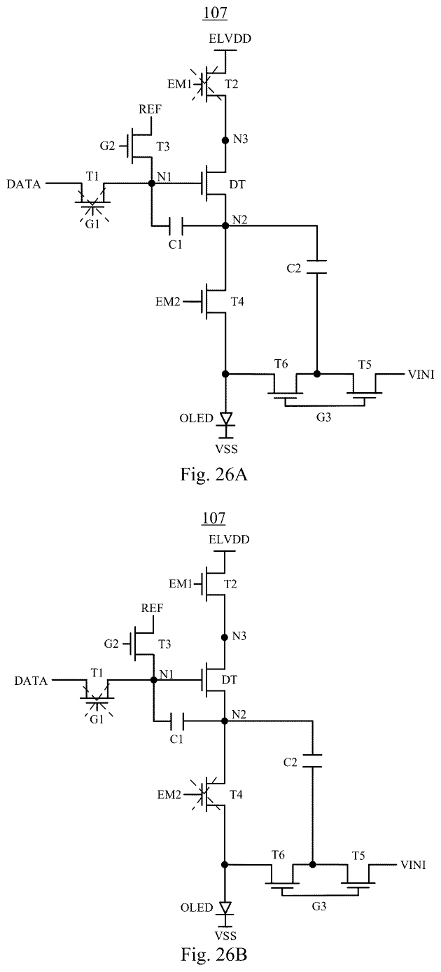

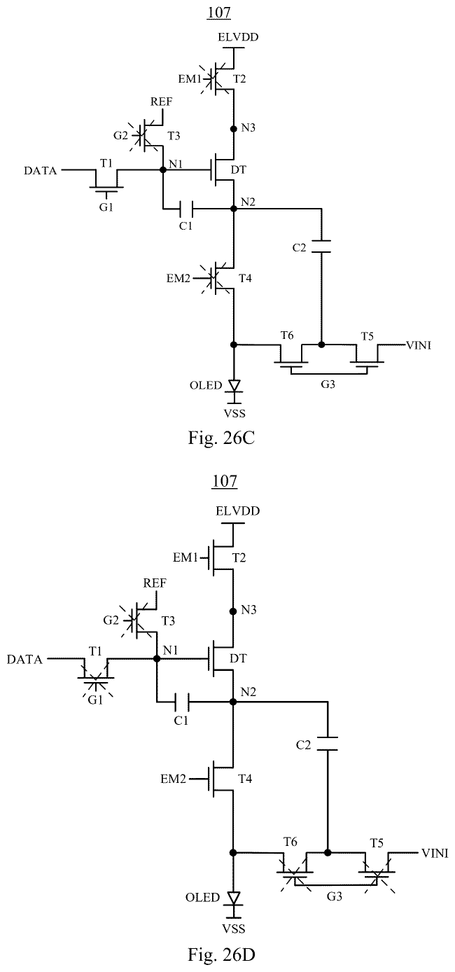

FIG. 26A is a schematic diagram of the pixel circuit in FIG. 24 in a third sub-reset phase; FIG. 26B is a schematic diagram of the pixel circuit in FIG. 24 in a second sub-compensation phase; FIG. 26C is a schematic diagram of the pixel circuit in FIG. 24 in a third sub-data writing phase; and FIG. 26D is a schematic diagram of the pixel circuit in FIG. 24 in a fourth sub-light-emitting phase.

For example, as shown in FIG. 25 and FIG. 26A, in the first sub-reset phase P1, the first light-emitting control signal EM1 is switched from a high-level signal in the fourth sub-light-emitting phase P12 to a low-level signal, and the reset control signal G3 remains as a low-level signal, thereby avoiding a risk of forming a current path from the second electrode of the driving transistor DT, through the second light-emitting control transistor T4 and the auxiliary compensation transistor T6, and then to the second electrode of the reset transistor T5 in this phase, thereby improving a device safety in the driving circuit 107. In the second sub-reset phase P2 and the third sub-reset phase P3, the reset control signal G3 is switched to a high-level signal to turn on the auxiliary compensation transistor T6 and the reset transistor T5, so that the reset voltage may be applied to the first electrode of the light-emitting element OLED.

For example, as shown in FIG. 25, FIG. 26B and FIG. 26C, in the compensation phase 2 and the data writing phase 3, the reset control signal G3 remains as a high-level signal, so that the auxiliary compensation transistor T6 and the reset transistor T5 are both in the ON state, so that a voltage at the second electrode of the second storage capacitor C2 remains as a reset voltage.

For example, as shown in FIG. 25 and FIG. 26D, in the first sub-light-emitting phase P9 and the second sub-light-emitting phase P10, the reset control signal G3 remains a high-level signal, so that the auxiliary compensation transistor T6 and the reset transistor T5 are both in the ON state. In the third sub-light-emitting phase P11 and the fourth sub-light-emitting phase P12, the reset control signal G3 is a low-level signal, so that the auxiliary compensation transistor T6 and the reset transistor T5 are both in the OFF state. In the first sub-light-emitting phase P9, the second sub-light-emitting phase P10 and the third sub-light-emitting phase P11, the first light-emitting control signal EM1 is a low-level signal, so that the first light-emitting control transistor T2 is in the OFF state; in the fourth sub-light-emitting phase P12, the first light-emitting control signal EM1 is switched to a high-level signal, so that the first power supply voltage ELVDD is applied to the second electrode of the driving transistor DT, and the light-emitting element OLED is in a light-emitting state.

By providing an auxiliary compensation transistor between the first electrode of the light-emitting element and the second electrode of the second storage capacitor, the impact of the capacitance of the light-emitting element on the voltage of the second electrode of the second storage capacitor may be reduced, so that the voltage of the second electrode of the second storage capacitor is more stable, and the voltage of the first electrode of the driving transistor is more stable.

For example, in some embodiments, when the first electrode of the auxiliary compensation transistor T6 is electrically connected to the second electrode of the second storage capacitor C2 and the first electrode of the reset transistor T5, and the second electrode of the auxiliary compensation transistor T6 is electrically connected to the first electrode 600a of the light-emitting element 600 and the second electrode of the second light-emitting control transistor T4, the gate electrode of the auxiliary compensation transistor T6 and the gate electrode of the reset transistor T5 may also be independent of each other and not electrically connected. For example, the auxiliary compensation transistor T6 may also share a gate electrode with the second light-emitting control transistor T4. In this way, when the data writing transistor T1 is turned on and the data signal DATA is written into the gate electrode of the driving transistor DT, the auxiliary compensation transistor T6 is turned off to reduce the impact of the capacitance in the light-emitting element OLED on the voltage of the second terminal of the second storage capacitor C2, so that the voltage value of the second terminal of the second storage capacitor C2 is equal to the value Vini of the reset voltage, and the voltage of the first terminal of the driving transistor DT may be more stable.

For example, in some embodiments of the present disclosure, when the first electrode of the auxiliary compensation transistor T6 is electrically connected to the second electrode of the second storage capacitor C2 and the first electrode of the reset transistor T5, and the second electrode of the auxiliary compensation transistor T6 is electrically connected to the first electrode 600a of the light-emitting element 600 and the second electrode of the second light-emitting control transistor T4, the gate electrode of the auxiliary compensation transistor T6 may be an independent electrode, and the embodiments of the present disclosure do not limit a setting manner of the gate electrode of the auxiliary compensation transistor T6.

An embodiment of the present disclosure further provides a method for reducing impact of temperature change on a magnitude of a driving current.

For example, as shown in FIG. 3 and FIG. 4A, after the reset phase 1 is completed, when the compensation phase 2 is entered, the voltage of the first electrode of the driving transistor DT is the reset voltage VINI. In the compensation phase 2, for example, in the second sub-compensation phase P5, the first light-emitting control transistor T2 is turned on, so that the driving transistor DT is charged until the driving transistor DT is turned off, thereby causing the gate-source voltage Vgs of the driving transistor DT to be equal to a threshold voltage Vth thereof, that is, causing the voltage of the first electrode of the driving transistor DT to be Vs=Vref−Vth.

However, in some cases, as shown in FIG. 3 and FIG. 4A, the pixel circuit may be interfered by some factors during an actual operation. For example, a charging time of the driving transistor DT may be insufficient, which may cause the driving transistor DT not to be completely turned off, and the voltage Vs of the first electrode of the driving transistor DT is less than a theoretical value Vref−Vth derived above, so that the driving current in the light-emitting phase is small. In addition, for the pixel circuit using an oxide material, a luminous brightness of the light-emitting element may be affected by temperature change, which is mainly due to mobility of an oxide transistor changing with temperature. For example, when the temperature rises, the mobility of the oxide transistor will increase accordingly, which will cause the driving current to increase; conversely, when the temperature decreases, the mobility of the oxide transistor will decrease accordingly, which will cause the driving current to increase. Therefore, when the compensation phase is completed, the voltage value of the first electrode of the driving transistor DT is crucial to the luminous brightness of the light-emitting element.

It should be noted that the method for reducing the impact of temperature change on the driving current provided in the embodiment of the present disclosure is applicable to the pixel circuit provided in the embodiment of the present disclosure, and the pixel circuit 101 shown in FIG. 2 is taken as an example for explanation below.

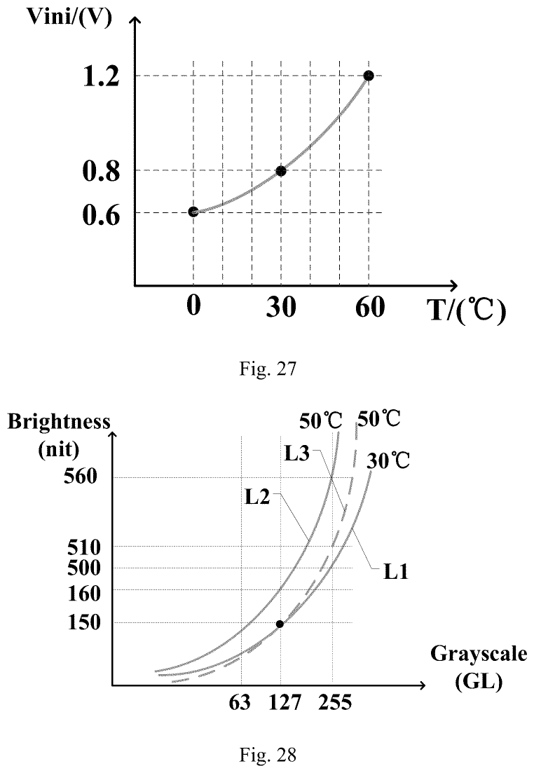

FIG. 27 is a schematic diagram of a reset voltage changing with temperature in at least one embodiment of the present disclosure.

For example, in at least one embodiment of the present disclosure, a value of the reset signal is adjustable. For example, the reset signal is a non-constant signal, which may be adjusted according to an operating requirement of the pixel circuit. For example, the reset signal may be a DC signal or may be a non-DC signal.

For example, as shown in FIG. 4A, the reset signal VINI is a reset voltage. The method for reducing the impact of temperature change on the driving current provided by the embodiment of the present disclosure includes: as an ambient temperature of the pixel circuit increases, setting the reset voltage Vini to increase accordingly.

For example, the reset signal VINI includes at least a first reset signal and a second reset signal, the first reset signal corresponds to a first display temperature, the second reset signal corresponds to a second display temperature, the first display temperature is lower than the second display temperature, and a value of the first reset signal is less than a value of the second reset signal. For example, when the temperature of the pixel circuit increases from the first display temperature to the second display temperature, the value of the reset signal increases from the value of the first reset signal to the value of the second reset signal.

For example, as shown in FIG. 4A and FIG. 27, the value of the first reset signal may be Vini1, the value of the second reset signal may be Vini2, the first display temperature may be 30° C., and the second display temperature may be 60° C. For example, when the temperature of the pixel circuit 102 increases, for example, from the first display temperature to the second display temperature, the value of the reset voltage may increase accordingly, that is, from Vini1 to Vini2. Thus, when the reset phase is completed, the voltage value of the first electrode of the driving transistor DT may be increased to Vini2 accordingly.

For example, as shown in FIG. 4B, before charging, when an initial value of the voltage of the first electrode of the driving transistor DT is Vini1, after a charging time D, the voltage value of the first electrode of the driving transistor DT is Vs1. For example, when the initial value of the voltage of the first electrode of the driving transistor DT is Vini2, after the charging time D, the voltage value of the first electrode of the driving transistor DT is Vs2, where Vs2 is greater than Vs1. Moreover, when the compensation phase is completed, and when the driving transistor DT is not completely turned off (for example, because of the aforementioned insufficient charging time, etc.), the voltage value of the first electrode of the driving transistor DT (that is, Vs1 and Vs2) is less than Vref-Vth.

For example, as shown in FIG. 4C, when the data writing phase is completed, the voltage value of the first electrode of the driving transistor DT increases from Vs1+(Vdata−Vref)×C1/(C1+C2) to Vs2+ (Vdata−Vref)×C1/(C1+C2). Thus, as shown in FIG. 4D, when entering the light-emitting phase, because the gate voltage value of the driving transistor DT is Vdata, the gate-source voltage Vgs of the driving transistor DT drops from Vdata−[Vs1+(Vdata−Vref)×C1/(C1+C2)] to Vdata−[Vs2+(Vdata−Vref)×C1/(C1+C2)].

A value I of the driving current flowing through the light-emitting element may be obtained according to a formula below:
I=K×(Vgs−Vth)², where K is a conductivity coefficient of the driving transistor DT.

That is, when the gate-source voltage Vgs of the driving transistor DT decreases, the value I of the driving current will decrease.

Therefore, when the temperature of the pixel circuit increases, the mobility of the driving transistor will increase, thereby increasing the driving current. By increasing the reset voltage, an increase of the driving current may be suppressed, and the magnitude of the driving current in the pixel circuit can be within a reasonable range, so that the driving current is more stable.

Table 1 shows a data distribution between the reset voltage and the driving current in the embodiments of the present disclosure. For example, as shown in Table 1, in the compensation phase, when the charging time of the driving transistor is 50 μs, when the reset voltage increases from 1.2V to 1.4V, the voltage value Vs of the second electrode of the driving transistor increases from 1.711V to 1.739V, and the stable driving current in the light-emitting phase decreases from 72.4 nA to 70.3 nA. When the reset voltage increases from 1.4V to 1.6V, the voltage value of the second electrode of the driving transistor increases from 1.739V to 1.784V, and the stable driving current in the light-emitting phase decreases from 70.3 nA to 67.3 nA. It can be seen that increasing the reset voltage can effectively suppress the increase of the driving current in the light-emitting phase.

TABLE 1

| | When charging time is | Stable driving current in the |
|---|---|---|
| Vini(V) | 50 μs, Vs(V) | light-emitting phase(nA) |
| 1.2 | 1.711 | 72.4 |
| 1.4 | 1.739 | 70.3 |
| 1.6 | 1.784 | 67.3 |

FIG. 28 is a schematic diagram of brightness of a light-emitting element changing with grayscale in at least one embodiment of the present disclosure.

For example, as shown in FIG. 28, a curve L1 represents a curve of change between the brightness and the grayscale of the light-emitting element at 30° C.; a curve L2 and a curve L3 represent curves of change between the brightness and the grayscale of the light-emitting element at 50° C., and reset voltage values corresponding to the curve L1 and the curve L2 are equal, and are both less than a reset voltage value corresponding to the curve L3.

For example, as shown in FIG. 28, by comparing the curve L1 and the curve L2, it can be seen that when the temperature of the pixel circuit increases from 30° C. to 50° C., at a same grayscale, the brightness of the light-emitting element has a significant deviation, that is, the brightness of the light-emitting element at 50° C. is greater than the brightness at 30° C. By comparing the curve L1 and the curve L3, it can be seen that when the temperature of the pixel circuit increases from 30° C. to 50° C., by increasing the reset voltage, a brightness deviation of the pixel circuit at 30° C. and 50° C. may be reduced, which is conducive to good uniformity of the brightness of the light-emitting element.

For example, when the temperature or the driving current of the pixel circuit is monitored by a detection manner, the driving current may be changed to a reasonable value by changing a magnitude of the reset signal to reduce the impact of temperature change.

For example, the pixel circuit corresponds to a plurality of display frame cycles, and each display frame cycle includes at least a reset phase, a compensation phase, a data writing phase and a light-emitting phase described in the embodiments of the present disclosure. For example, in some embodiments, a display frame cycle may include at least one refresh frame, for example, may include a plurality of refresh frames, but the embodiments of the present disclosure are not limited thereto. For example, the reset phase, the compensation phase, the data writing phase and the light-emitting phase in the embodiments of the present disclosure are all located within the refresh frame. For example, in some other embodiments, a display frame cycle may include at least one refresh frame and at least one hold frame. For example, the hold frame may include a hold reset phase, a hold stress application phase and a hold light-emitting phase.

For example, when the display frame cycle has only a plurality of refresh frames but no hold frame, a driving mode of a display panel using the pixel circuit is a high refresh driving mode, for example, its refresh frequency is above 120 Hz. For example, when the display frame cycle has a plurality of refresh frames and at least one hold frame, the plurality of refresh frames and at least one hold frame are alternately arranged, and the driving mode of the display panel using the pixel circuit is a low refresh driving mode. For example, a duration of the hold frame may be ½, ⅓, 1/10, 1/20, 1/30 or 1/60 of a duration of the refresh frame, and the embodiments of the present disclosure do not limit this.

For example, in at least one embodiment of the present disclosure, a first reset signal is adjusted to a second reset signal during a reset signal adjustment period. For example, the reset signal adjustment period may be located between two adjacent display frame cycles, so that the second reset signal may be written before a start of a next display frame cycle, and a value of the second reset signal in the next display frame cycle remains as Vini2, and after a certain charging time, the voltage value of the first electrode of the driving transistor is Vs2, where Vs2 is greater than the voltage value Vs1 of the first electrode of the driving transistor corresponding to the first reset signal.

For example, in at least one embodiment of the present disclosure, the reset signal adjustment period is located within a display frame cycle, and the reset signal adjustment period may overlap at least partially with any of the reset phase, the compensation phase, the data writing phase, and the light-emitting phase. For example, within a display frame cycle, the reset signal adjustment period may overlap at least partially with the reset phase. For example, in a part of the reset phase (for example, the second sub-reset phase in the aforementioned embodiment), a value of the reset signal is equal to the value of the first reset signal Vini1, and in another part of the reset phase (for example, the third sub-reset phase in the aforementioned embodiment), the reset signal is adjusted to the second reset signal, and its value is equal to the value of the second reset signal Vini2. Thus, after the reset signal adjustment period, the voltage value of the first electrode of the driving transistor is adjusted from Vs1 to Vs2, where Vs2 is greater than Vs1.

For example, in at least one embodiment of the present disclosure, the reset signal adjustment period is located within a display frame cycle, and the reset signal adjustment period does not overlap with any of the reset phase, the compensation phase, the data writing phase, and the light-emitting phase. For example, the reset adjustment period can be located between the reset phase and the compensation phase. For example, in a part of the reset phase (such as the third sub-reset phase in the aforementioned embodiment), the value of the reset signal is equal to the value of the first reset signal Vini1, and in a part of the compensation phase (such as the first sub-compensation phase in the aforementioned embodiment), the reset signal is adjusted to a second reset signal, and its value is equal to the value of the second reset signal Vini2. Thus, after the reset signal adjustment period, the voltage value of the first electrode of the driving transistor is adjusted from Vs1 to Vs2, where Vs2 is greater than Vs1.

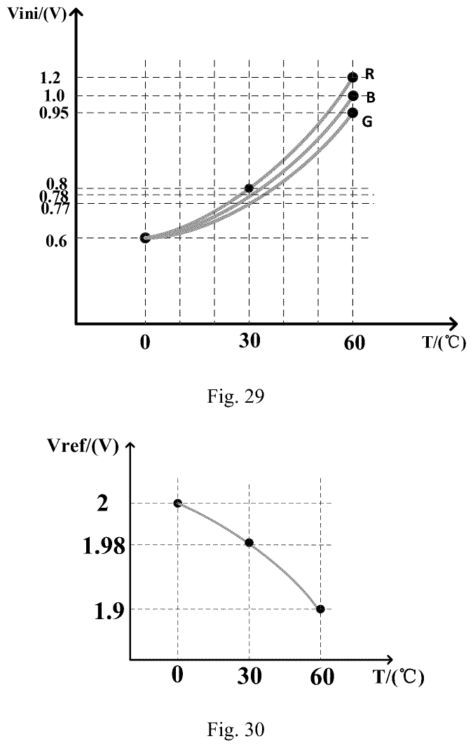

FIG. 29 is a schematic diagram of a reset voltage changing with temperature in at least one embodiment of the present disclosure.

For example, in some embodiments of the present disclosure, when an area of a light-emitting region of the light-emitting element is different, a parasitic capacitance of the light-emitting element itself is different. For example, the larger the light-emitting region of the light-emitting element, the greater the parasitic capacitance of the light-emitting element itself. For example, for some display panels, the display panel includes a first sub-pixel, a second sub-pixel, and a third sub-pixel; the first sub-pixel is configured to emit red light, the second sub-pixel is configured to emit green light, and the third sub-pixel is configured to emit blue light. A light-emitting region of a light-emitting element of the first sub-pixel has a first light-emitting area, a light-emitting region of a light-emitting element of the second sub-pixel has a second light-emitting area, and a light-emitting region of a light-emitting element of the third sub-pixel has a third light-emitting area; and the first light-emitting area is smaller than the second light-emitting area, and the second light-emitting area is smaller than the third light-emitting area. A first parasitic capacitance of the light-emitting element of the first sub-pixel itself is less than a second parasitic capacitance of the light-emitting element of the second sub-pixel itself, and the second parasitic capacitance of the light-emitting element of the second sub-pixel itself is less than a third parasitic capacitance of the light-emitting element of the third sub-pixel itself.

For example, when reset voltages of the first sub-pixel, the second sub-pixel, and the third sub-pixel are all equal to the value of the first reset signal Vini1 in the reset phase, and in a case where driving currents are the same, when the temperature of the pixel circuits of the three sub-pixels increases from the first display temperature to the second display temperature, there is a first voltage increase amount between the first electrode and the second electrode of the light-emitting element of the first sub-pixel, there is a second voltage increase amount between the first electrode and the second electrode of the light-emitting element of the second sub-pixel, there is a third voltage increase amount between the first electrode and the second electrode of the light-emitting element of the third sub-pixel, and the first voltage increase amount is greater than the second voltage increase amount, and the second voltage increase amount is greater than the third voltage increase amount. As a result, a first current increase amount of a driving current of the light-emitting element of the first sub-pixel is greater than a second current increase amount of a driving current of the light-emitting element of the second sub-pixel, and the second current increase amount of the driving current of the light-emitting element of the second sub-pixel is greater than an increase amount of a driving current of the light-emitting element of the third sub-pixel.

In order to balance the impact of temperature increase on the driving current, it is necessary to increase values of the reset signals received by the first sub-pixel, the second sub-pixel and the third sub-pixel respectively, and a reset signal increase amount corresponding to the first sub-pixel is greater than a reset signal increase amount corresponding to the second sub-pixel, and the reset signal increase amount corresponding to the second sub-pixel is greater than a reset signal increase amount corresponding to the third sub-pixel, so that a gate-source voltage reduction amount in the pixel circuit of the first sub-pixel is greater than a gate-source voltage reduction amount in the pixel circuit of the second sub-pixel, and the gate-source voltage reduction amount in the pixel circuit of the second sub-pixel is greater than a gate-source voltage reduction amount in the pixel circuit of the third sub-pixel. Accordingly, a driving current reduction amount of the first sub-pixel is greater than a driving current reduction amount of the second sub-pixel, and the driving current reduction amount of the second sub-pixel is greater than a driving current reduction amount of the third sub-pixel, thereby causing the driving current of each sub-pixel to be in a stable state.

Therefore, when the light-emitting areas of the light-emitting elements of a plurality of pixel circuits are different, and when the temperature at which the pixel circuit is located increases, the impact of the temperature increase on the driving current may be balanced by causing a relatively large increase amount of the reset signal value corresponding to the light-emitting element with a smaller light-emitting area.

For example, in some other embodiments of the present disclosure, for some display panels, the display panel includes a first sub-pixel, a second sub-pixel, and a third sub-pixel; the first sub-pixel is configured to emit red light, the second sub-pixel is configured to emit green light, and the third sub-pixel is configured to emit blue light. The light-emitting element of the first sub-pixel has a first light-emitting efficiency, the light-emitting element of the second sub-pixel has a second light-emitting efficiency, and the light-emitting element of the third sub-pixel has a third light-emitting efficiency, and the first light-emitting efficiency is greater than the second light-emitting efficiency, and the second light-emitting efficiency is greater than the third light-emitting efficiency.

For example, when the reset voltages of the first sub-pixel, the second sub-pixel, and the third sub-pixel are all equal to the value of the first reset signal Vini1 in the reset phase, and in a case where the driving currents are the same, when the temperature of the pixel circuits of the three sub-pixels increases from the first display temperature to the second display temperature, in order to ensure that the luminous brightness remains unchanged, a voltage increase amount required for the light-emitting element of the first sub-pixel is less than a voltage increase amount required for the light-emitting element of the second sub-pixel, and the voltage increase amount required for the light-emitting element of the second sub-pixel is less than a voltage increase amount required for the light-emitting element of the third sub-pixel. Thus, an increase amount in the driving current of the light-emitting element of the first sub-pixel is less than an increase amount in the driving current of the light-emitting element of the second sub-pixel, and the increase amount in the driving current of the light-emitting element of the second sub-pixel is less than an increase amount in the driving current of the light-emitting element of the third sub-pixel.

In order to balance the impact of the temperature increase on the driving current, it is necessary to increase the values of the reset signals received by the first sub-pixel, the second sub-pixel and the third sub-pixel respectively, and the reset signal increase amount corresponding to the first sub-pixel is less than the reset signal increase amount corresponding to the second sub-pixel, and the reset signal increase amount corresponding to the second sub-pixel is less than the reset signal increase amount corresponding to the third sub-pixel, so that the gate-source voltage reduction amount in the pixel circuit of the first sub-pixel is less than the gate-source voltage reduction amount in the pixel circuit of the second sub-pixel, and the gate-source voltage reduction amount in the pixel circuit of the second sub-pixel is less than the gate-source voltage reduction amount in the pixel circuit of the third sub-pixel. Accordingly, the driving current reduction amount of the first sub-pixel is less than the driving current reduction amount of the second sub-pixel, and the driving current reduction amount of the second sub-pixel is less than the driving current reduction amount of the third sub-pixel, thereby causing the driving current of each sub-pixel to be in a stable state.

Therefore, when luminous efficiencies of the light-emitting elements of a plurality of pixel circuits are different, and when the temperature of the pixel current increases, the impact of temperature increase on the driving current may be balanced by causing a relatively large increase amount of the reset signal value corresponding to the light-emitting element with a smaller luminous efficiency.

For example, as shown in FIG. 29, in some embodiments of the present disclosure, the first sub-pixel corresponds to a curve R, the second sub-pixel corresponds to a curve G, and the first sub-pixel corresponds to a curve B. On the one hand, because the first light-emitting area corresponding to the first sub-pixel is smaller than the second light-emitting area of the second sub-pixel, the second light-emitting area of the second sub-pixel is smaller than the third light-emitting area. When the temperature rises, for example, from 30° C. to 60° C., an increase amount in a reset voltage of the first sub-pixel is greater than an increase amount in a reset voltage of the second sub-pixel and an increase amount in a reset voltage of the third sub-pixel. On the other hand, because a luminous efficiency of the light-emitting element of the third sub-pixel is lower than a luminous efficiency of the light-emitting element of the second sub-pixel, and a luminous efficiency of the first sub-pixel is substantially same as the luminous efficiency of the light-emitting element of the second sub-pixel, when the temperature rises, the increase amount in the reset voltage of the third sub-pixel is greater than the increase amount in the reset voltage of the second sub-pixel, thereby causing the driving currents of the sub-pixels emitting different colors of light to be all in a stable state.

For example, in some embodiments of the present disclosure, referring to FIG. 29, because a reset voltage of a first color sub-pixel is relatively close to a reset voltage of a third color sub-pixel, the first color sub-pixel and the third color sub-pixel may correspond to a same reset voltage, and the second color sub-pixel may correspond to a reset voltage alone, thereby reducing difficulty in adjustment.

FIG. 30 is a schematic diagram of a reference voltage changing with temperature in at least one embodiment of the present disclosure.

For example, as shown in FIG. 4A, a value of the reference signal REF may also be adjustable, which may be a direct current signal or may be a non-direct current signal. For example, the reference signal REF may be a reference voltage Vref, and the method for reducing the impact of temperature change on the luminous brightness provided by the embodiment of the present disclosure includes: as the ambient temperature of the pixel circuit increases, setting the reference voltage Vref to decrease accordingly.

For example, as shown in FIG. 4A and FIG. 27, when the temperature of the pixel circuit increases, for example, from 0° C. to 30° C., or from 30° C. to 60° C., the reference voltage Vref may be increased accordingly, for example, from Vref1 to Vref2. For example, when the reset phase is completed, the driving transistor DT approaches the OFF state, so the voltage value of the first electrode of the driving transistor DT is correspondingly reduced from Vref1−Vth to Vref2−Vth, so that the gate-source voltage Vgs of the driving transistor DT may be reduced, and the driving current in the light-emitting phase may decrease.

When the temperature of the pixel circuit increases, the mobility of the driving transistor increases and the driving current increases, therefore, by reducing the reference voltage, the increase of the driving current may be suppressed, and the magnitude of the driving current in the pixel circuit may be within a reasonable range, so that the driving current is more stable.

For example, in at least one embodiment of the present disclosure, the first power supply voltage may be a constant voltage or may be a non-constant voltage. For example, a value of the first power supply voltage may also be adjustable. For example, when the operating requirement of the pixel circuit is met, power consumption may be reduced by lowering the first power supply voltage.

For example, in at least one embodiment of the present disclosure, the second power supply voltage may be a constant voltage or may be a non-constant voltage. For example, a value of the second power supply voltage may also be adjustable. For example, when the operating requirement of the pixel circuit is met, the brightness of the light-emitting element can be adjusted by adjusting the second power supply voltage.

At least one embodiment of the present disclosure further provides a pixel circuit. Referring to FIG. 1, the pixel circuit 10 includes a driving circuit 100, a first compensation circuit 300, a light-emitting element 600, and a reset control circuit 780. That is, the pixel circuit may not include the second light-emitting control circuit of the pixel circuit in the above embodiment. For other structures and driving methods of the pixel circuit, please refer to the relevant description of the above embodiments, which will not be repeated here.

As shown in FIG. 1, the driving circuit 100 includes a control terminal 100m, a first terminal 100a, and a second terminal 100b. The control terminal 100m of the driving circuit 100 is electrically connected to the first node N1, the first terminal 100a of the driving circuit 100 is electrically connected to the second node N2, and the second terminal 100b of the driving circuit 100 is electrically connected to the third node N3. The driving circuit 100 is configured to control the magnitude of the driving current flowing through the first terminal 100a and the second terminal 100b. For example, the driving current may be used to drive the light-emitting element 600 to emit light. For example, in the light-emitting phase, the driving circuit 100 may provide the light-emitting element 600 with the driving current to drive the light-emitting element 600 to emit light.

As shown in FIG. 1, the first compensation circuit 300 includes a control terminal 300m, a first terminal 300a, a second terminal 300b, and a third terminal 300c. The control terminal 300m of the first compensation circuit 300 is configured to receive a first compensation control signal G2, the first terminal 300a of the first compensation circuit 300 is electrically connected to a reference signal terminal REF to receive a reference signal REF, the second terminal 300b of the first compensation circuit 300 is electrically connected to the second node N2, and the third terminal 300c of the first compensation circuit 300 is electrically connected to the first node N1. The first compensation circuit 300 is configured to apply the reference signal REF to the control terminal 100m of the driving circuit 100 in response to the first compensation control signal G2. For example, the first compensation circuit 300 may include a first storage capacitor C1 (see FIG. 2), a first electrode of the first storage capacitor C1 is electrically connected to the control terminal 100m of the driving circuit 100, and a second electrode of the first storage capacitor C1 is electrically connected to the first terminal 100a of the driving circuit 100, but the embodiments of the present disclosure are not limited thereto.

For example, as shown in FIG. 1, the light-emitting element 600 includes a first electrode 600a and a second electrode 600b, the first electrode 600a of the light-emitting element 600 is electrically connected to the first terminal 100a of the driving circuit 100, the second electrode 600b of the light-emitting element 600 is electrically connected to a second voltage terminal VSS to receive a second power supply voltage VSS, and the light-emitting element 600 is configured to emit light driven by the driving current. For example, the second voltage terminal VSS may be grounded, that is, the second power supply voltage VSS may be OV. For example, the second power supply voltage VSS may be a negative voltage. For example, the light-emitting element 600 may be an organic light-emitting diode (OLED). For example, the light-emitting element 600 may also be other types of electroluminescent devices such as inorganic light-emitting diodes, quantum-dot light-emitting elements, etc. The embodiments of the present disclosure do not limit the type of the light-emitting element.

As shown in FIG. 1, the reset control circuit 780 includes a control terminal 780m, a first terminal 780a, a second terminal 780b, and a third terminal 780c. The control terminal 780m of the reset control circuit 780 is configured to receive a reset control signal G3, the first terminal 780a of the reset control circuit 780 is electrically connected to the first terminal 100a of the driving circuit 100, the second terminal 780b of the reset control circuit 780 is electrically connected to a reset signal terminal VINI to receive a reset signal VINI, the third terminal 780c of the reset control circuit 780 is electrically connected to the first electrode 600a of the light-emitting element 600, and the reset control circuit 780 is configured to apply the reset signal VINI to the first electrode 600a of the light-emitting element 600 and/or the first terminal 100a of the driving circuit 100 in response to the reset control signal G3.

As shown in FIG. 1, the first terminal 780a of the reset control circuit 780 is electrically connected to the first terminal 100a of the driving circuit 100, and the second terminal 780b of the reset control circuit 780 is electrically connected to the reset signal terminal VINI. Thus, the reset signal from the reset signal terminal VINI needs to pass through the reset control circuit 780 before it may be applied to the first electrode 600a of the light-emitting element 600 and/or the first terminal of the driving circuit 100, thereby reducing the impact of the fluctuation of the reset signal on the voltage of the first electrode 600a of the light-emitting element 600 and the first terminal 100a of the driving circuit 100, and reducing the risk of introducing noise into the pixel circuit 10, thereby causing the driving current to be more stable to improve the display effect.

With development of an OLED display technology, an oxide process is often used in OLED display products because of its high uniformity. A coupling effect of some capacitors of the pixel driving circuit fabricated by the oxide process will introduce noise in the display phase, so that the driving current output by the pixel driving circuit is unstable, affecting reliability of the pixel driving circuit.

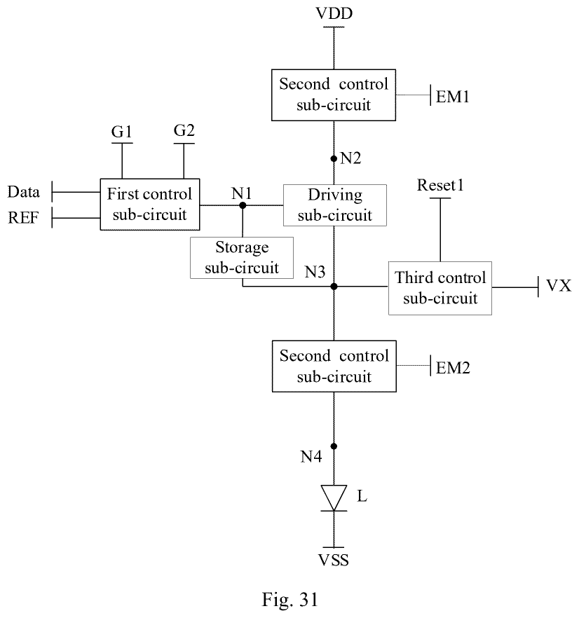

FIG. 31 to FIG. 48 are schematic diagrams of other implementation examples of the pixel circuit shown in FIG. 1.

FIG. 31 is a structural schematic diagram of another pixel driving circuit provided in an embodiment of the present disclosure. As shown in FIG. 31, the pixel driving circuit provided in the embodiment of the present disclosure may include: a driving sub-circuit, a first control sub-circuit, a second control sub-circuit, a third control sub-circuit and a storage sub-circuit.

For example, in some embodiments of the present disclosure, the driving circuit and the connection relationship in FIG. 1 correspond to the driving sub-circuit in FIG. 31 and subsequent embodiments; the data writing circuit and the first compensation circuit and the connection relationship in FIG. 1 correspond to the first control sub-circuit and the storage sub-circuit in FIG. 31 and subsequent embodiments; the first light-emitting control circuit and the second light-emitting control circuit in FIG. 1 correspond to the second control sub-circuit in FIG. 31 and subsequent embodiments; the light-emitting element in FIG. 1 corresponds to the light-emitting device in FIG. 31 and subsequent embodiments; the reset control circuit and the connection relationship in FIG. 1 correspond to the third control sub-circuit in FIG. 31 and subsequent embodiments.

As shown in FIG. 31, the driving sub-circuit is electrically connected to a first node N1, a second node N2 and a third node N3 respectively, and is configured to provide a driving current to the third node N3 under a control of signals of the first node N1 and the second node N2; the first control sub-circuit is electrically connected to a first scan signal line G1, a second scan signal line G2, a data signal line Data, a reference signal line REF and the first node N1 respectively, and is configured to provide a signal of the data signal line Data or the reference signal line REF to the first node N1 under a control of signals of the first scan signal line G1 and the second scan signal line G2; the second control sub-circuit is electrically connected to a first light-emitting signal line EM1, a second light-emitting signal line EM2, a first power line VDD, the second node N2, the third node N3 and a fourth node N4 respectively, and is configured to provide the second node N2 with a signal of the first power line VDD and provide the fourth node N4 with the signal of the third node N3 under control of signals of the first light-emitting signal line EM1 and the second light-emitting signal line EM2; the third control sub-circuit is electrically connected to a first reset signal line Reset1, an auxiliary signal line VX and the third node N3 respectively, and is configured to control a signal of the third node N3 under control of a signal of the first reset signal line Reset1 and a signal of the auxiliary signal line VX; the storage sub-circuit is electrically connected to the first node N1 and the third node N3 respectively, and is configured to store a voltage difference of between the signal of the first node N1 and the signal of third node N3.

In an exemplary implementation, as shown in FIG. 31, the pixel driving circuit is electrically connected to the light-emitting device L through the fourth node N4.

In an exemplary implementation, the light-emitting device L may include a first electrode (anode), an organic light-emitting layer and a second electrode (cathode) stacked on each other. Exemplarily, the anode of the light-emitting device L is electrically connected to the fourth node N4, and the cathode of the light-emitting device L is electrically connected to a second power line VSS.

In an exemplary implementation, the light-emitting device L may include a current driven device, and may use a current light-emitting diode, such as a micro light-emitting diode (Micro LED) or a mini light-emitting diode (Mini LED) or an organic light-emitting diode (OLED) or a quantum-dot light-emitting diode (QLED). A typical size (e.g., length) of the Micro LED may be less than 100 μm, such as 10 μm to 50 μm. A typical size (e.g., length) of the Mini LED may be about 100 μm to 300 μm, such as 120 μm to 260 μm.

In an exemplary implementation, the organic light-emitting layer may include a stacked hole injection layer (HIL), a hole transport layer (HTL), an electron blocking layer (EBL), an emitting layer (EML), a hole blocking layer (HBL), an electron transport layer (ETL), and an electron injection layer (EIL). In an exemplary implementation, the hole injection layer of all sub-pixels may be a common layer connected together, the electron injection layer of all sub-pixels may be a common layer connected together, the hole transport layer of all sub-pixels may be a common layer connected together, the electron transport layer of all sub-pixels may be a common layer connected together, the hole blocking layer of all sub-pixels may be a common layer connected together, emitting layers of adjacent sub-pixels may have a small overlap, or may be isolated, and electron blocking layers of adjacent sub-pixels may have a small overlap, or may be isolated.

In an exemplary implementation, the first power line VDD continuously provides a high-level signal, and the signal of the first power line VDD is a direct current signal.

In an exemplary implementation, the second power line VSS continuously provides a low-level signal, and a signal of the second power line VSS is a direct current signal.

In an exemplary implementation, the reference signal line REF continuously provides a low-level signal, and a signal of the reference signal line REF is a direct current signal. Exemplarily, a voltage of the signal of the reference signal line REF may be OV.

In an exemplary implementation, the pixel driving circuit is located in a display substrate, and content displayed by the display substrate includes a plurality of display frames. In any display frame, a signal of the first scan signal line G1 is a pulse signal, and a signal of the second scan signal line G2 is a pulse signal. A time period in which the signal of the second scan signal line G2 is a valid level signal occurs before a time period in which the signal of the first scan signal line G1 is a valid level signal.

An embodiment of the present disclosure provides a pixel driving circuit, including: a driving sub-circuit, a first control sub-circuit, a second control sub-circuit, a third control sub-circuit and a storage sub-circuit; the driving sub-circuit is electrically connected to a first node, a second node and a third node respectively, and is configured to provide the third node with a driving current under control of signals of the first node and the second node; the first control sub-circuit is electrically connected to a first scan signal line, a second scan signal line, a data signal line, a reference signal line and the first node respectively, and is configured to provide the first node with a signal of a data signal line or a reference signal line under a control of signals of the first scan signal line and the second scan signal line; the second control sub-circuit is electrically connected to the first light-emitting signal line, the second light-emitting signal line, the first power line, the second node, the third node and the fourth node respectively, and is configured to provide the second node with the signal of the first power line and provide the fourth node with the signal of the third node under control of signals of the first light-emitting signal line and the second light-emitting signal line; the third control sub-circuit is electrically connected to the first reset signal line, the auxiliary signal line and the third node respectively, and is configured to control the signal of the third node under control of a signal of the first reset signal line and a signal of the auxiliary signal line; the storage sub-circuit is electrically connected to the first node and the third node respectively, and is configured to store a voltage difference between the signal of the first node and the signal of the third node. In the present disclosure, the signal of the third node may be controlled through the signals of the first reset signal line and the auxiliary signal line by setting the third control sub-circuit, thereby avoiding introduction of noise in the display phase, maintaining stability of the driving current output by the pixel driving circuit, and improving reliability of the pixel driving circuit.

In an exemplary implementation, an operating process of the pixel driving circuit includes a display phase, and the display phase includes: a writing phase and a light-emitting phase, in which the light-emitting phase occurs after the writing phase, and the signal of the first scan signal line G1 is a valid level signal in the writing phase. The signals of the first light-emitting signal line EM1 and the second light-emitting signal line EM2 are both valid level signals in the light-emitting phase, and a time period in which the writing phase occurs is a writing time period.

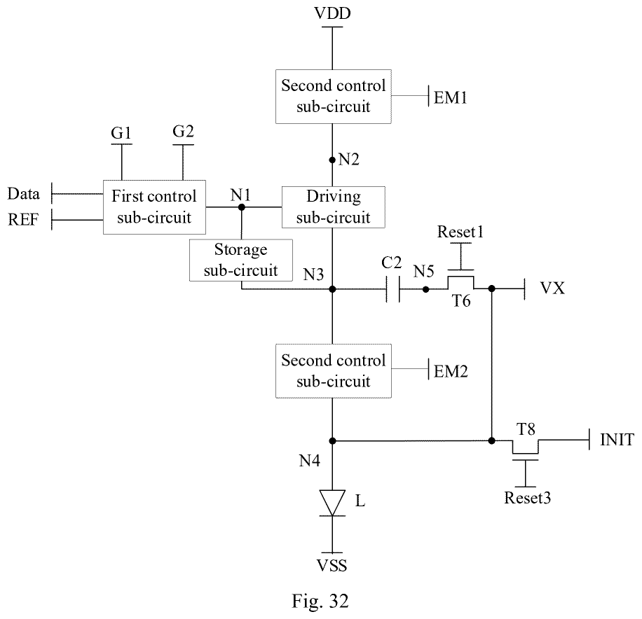

FIG. 32 is an equivalent circuit diagram 1 including the third control sub-circuit shown in FIG. 31. As shown in FIG. 32, in an exemplary implementation, the third control sub-circuit may also be electrically connected to a third reset signal line Reset3 and an initial signal line INIT respectively, and is configured to provide the fourth node N4 with a signal of the initial signal line under a control of a signal of the third reset signal line Reset3. Exemplarily, the third control sub-circuit may include: a sixth transistor T6, an eighth transistor T8 and a second capacitor C2. A control electrode of the sixth transistor T6 is electrically connected to the first reset signal line Reset1, a first electrode of the sixth transistor T6 is electrically connected to the auxiliary signal line VX, and a second electrode of the sixth transistor T6 is electrically connected to a fifth node N5; a first terminal of the second capacitor C2 is electrically connected to the fifth node N5, and a second terminal of the second capacitor C2 is electrically connected to the third node N3; a first electrode of the eighth transistor T8 is electrically connected to the initial signal line INIT, and a second electrode of the eighth transistor T8 is electrically connected to the fourth node N4.

In an exemplary implementation, as shown in FIG. 32, a signal of the auxiliary signal line VX is a non-direct current signal and is electrically connected to the fourth node N4.

For example, in some embodiments, as shown in FIG. 32, a signal value of the initial signal line INIT is adjustable to reduce the impact of temperature change on the magnitude of the driving current. Regarding an adjustment manner of the signal value of the initial signal line INIT, please refer to an adjustment manner for the value of the reset signal in the above embodiment, which will not be repeated here.

In an exemplary implementation, as shown in FIG. 32, in the present disclosure, the third node N3 and the fourth node N4 may be reset before the writing time period by allowing the signal of the second light-emitting signal line EM2 to be a valid level signal in a part of the time period when the signal of the third reset signal line Reset3 is a valid level signal, so as to ensure a display uniformity of the pixel driving circuit. In the present disclosure, the voltage values of the signals at both terminals of the second capacitor C2 in the light-emitting phase may be same by allowing the signals of the first reset signal line Reset1 and the second light-emitting signal line EM2 to be valid level signals in at least part of the time period after the writing time period, which avoids the impact of the second capacitor C2 on the third node N3 in the light-emitting phase, avoids the introduction of noise at the third node N3, maintains the stability of the driving current output by the pixel driving circuit, and improves the reliability of the pixel driving circuit.

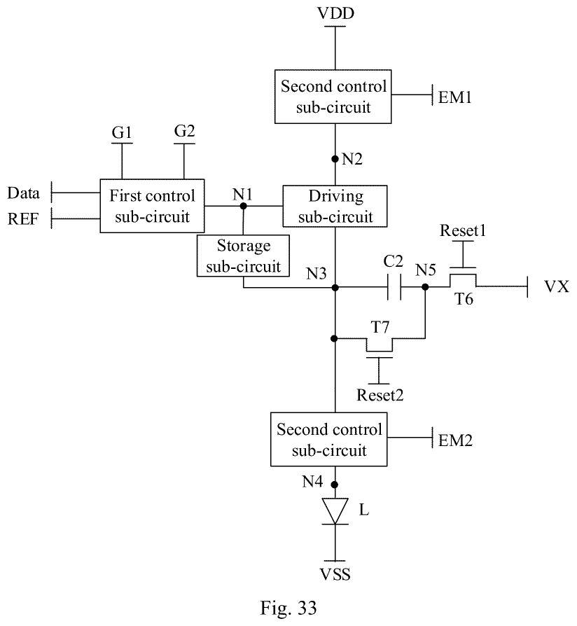

FIG. 33 is an equivalent circuit diagram 2 including the third control sub-circuit shown in FIG. 31. As shown in FIG. 33, in an exemplary implementation, the third control sub-circuit may also be electrically connected to a second reset signal line Reset2, and is also configured to provide the third node N3 with a signal of the fifth node N5 under control of a signal of the second reset signal line Reset2. Exemplarily, the third control sub-circuit may include: a sixth transistor T6, a seventh transistor T7, and a second capacitor C2. A first electrode of the sixth transistor T6 is electrically connected to the auxiliary signal line VX, and a second electrode of the sixth transistor T6 is electrically connected to the fifth node N5; a control electrode of the seventh transistor T7 is electrically connected to the second reset signal line Reset2, a first electrode of the seventh transistor T7 is electrically connected to the fifth node N5, and a second electrode of the seventh transistor T7 is electrically connected to the third node N3; a first terminal of the second capacitor C2 is electrically connected to the fifth node N5, and a second terminal of the second capacitor C2 is electrically connected to the third node N3.

In an exemplary implementation, as shown in FIG. 33, the signal of the auxiliary signal line VX may be a direct current signal, and may be same as the signal of any one of the initial signal line INIT, the reference signal line REF, and the first power line VDD.

For example, in some embodiments, as shown in FIG. 33, a signal value of the auxiliary signal line VX is adjustable to reduce the impact of temperature change on the magnitude of the driving current. For the adjustment manner of the signal value of the auxiliary signal line VX, please refer to the adjustment manner of the reset signal value in the above embodiment, which will not be repeated here.

In an exemplary implementation, as shown in FIG. 33, in the present disclosure, the third node N3 and the fourth node N4 may be reset before the writing time period by allowing the signals of the second reset signal line Reset2 and the second light-emitting signal line EM2 to be valid level signals in a part of the time period when the signal of the first reset signal line Reset1 is a valid level signal, so as to ensure a display uniformity of the pixel driving circuit. In the present disclosure, the voltage values of the signals at both terminals of the second capacitor C2 in the light-emitting phase may be same by allowing the signal of the second reset signal line Reset2 to be a valid level signal in at least part of the time period after the writing time period, which avoids the impact of the second capacitor C2 on the third node N3 in the light-emitting phase, avoids the introduction of noise in the display phase, maintains the stability of the driving current output by the pixel driving circuit, and improves the reliability of the pixel driving circuit.

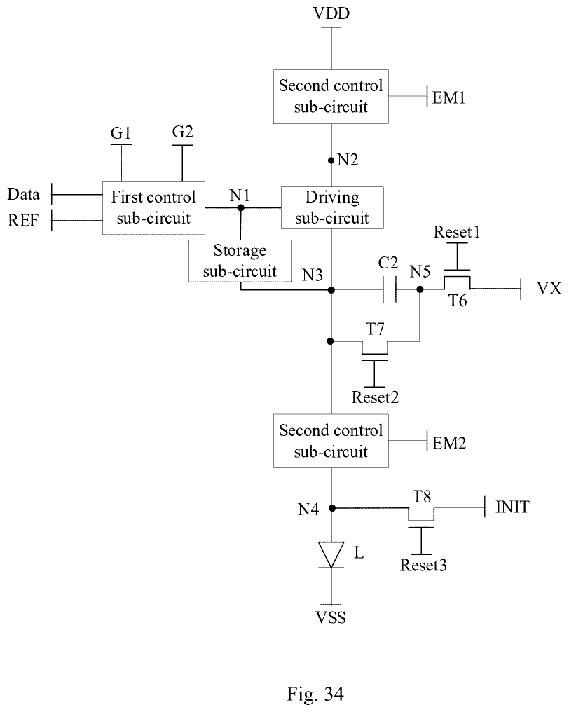

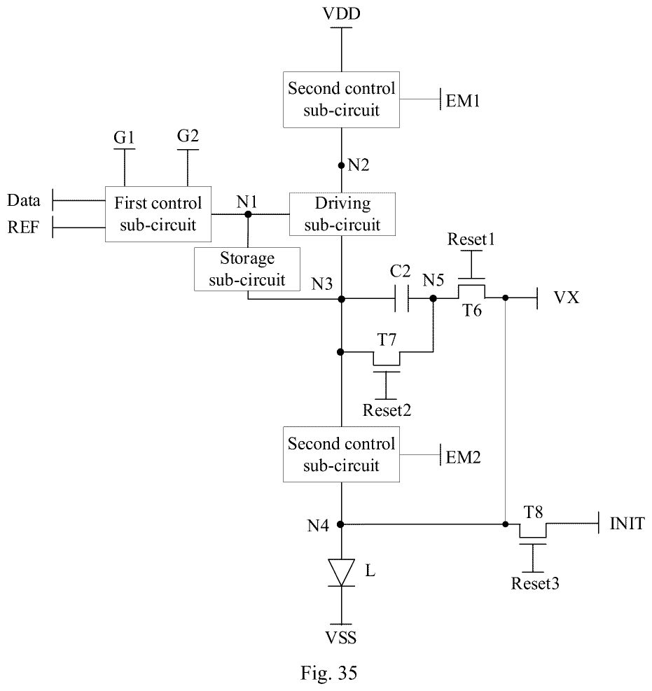

FIG. 34 is an equivalent circuit diagram 3 including the third control sub-circuit shown in FIG. 31, and FIG. 35 is an equivalent circuit diagram 4 including the third control sub-circuit shown in FIG. 31. In an exemplary implementation, as shown in FIG. 34 and FIG. 35, the third control sub-circuit may also be electrically connected to the third reset signal line Reset3 and the initial signal line INIT respectively, and is configured to provide the fourth node N4 with the signal of the initial signal line under the control of the signal of the third reset signal line Reset3. Exemplarily, the third control sub-circuit may also include: an eighth transistor T8, a control electrode of the eighth transistor T8 is electrically connected to the third reset signal line Reset3, a first electrode of the eighth transistor T8 is electrically connected to the initial signal line, and a second electrode of the eighth transistor T8 is electrically connected to the fourth node N4.

In an exemplary embodiment, the signal of the auxiliary signal line VX is a direct current signal, and the signal of the auxiliary signal line VX is the same as the signal of any one of the initial signal line, the reference signal line REF and the first power line VDD; or, the signal of the auxiliary signal line VX is a non-direct current signal, and the signal of the auxiliary signal line VX is electrically connected to the fourth node N4. FIG. 34 is illustrated by taking that the signal of the auxiliary signal line VX is a direct current signal, and FIG. 35 is illustrated by taking that the signal of the auxiliary signal line VX is a no-direct current signal.

For example, in some embodiments, as shown in FIG. 34, the signal value of the auxiliary signal line VX is the same as the signal value of the initial signal line VINI, and the signal value of the initial signal line VINI is adjustable, so as to reduce the impact of temperature change on the magnitude of the driving current. For the adjustment manner of the signal value of the initial signal line VINI, please refer to the adjustment manner of the reset signal value in the above embodiment, which will not be repeated here.

For example, in some embodiments, as shown in FIG. 35, the signal value of the initial signal line VINI is adjustable to reduce the impact of temperature change on the magnitude of the driving current. For the adjustment method of the signal value of the initial signal line VINI, please refer to the adjustment method of the reset signal value in the above embodiment, which will not be repeated here.

In an exemplary embodiment, as shown in FIG. 34 and FIG. 35, when the signal of the first reset signal line Reset1 is a valid level signal, the signal of the third reset signal line is a valid level signal, and the signal of the second reset signal line is an invalid level signal. When the signal of the second reset signal line is a valid level signal, the signal of the first reset signal line is an invalid level signal. In the present disclosure, the third node N3 and the fourth node N4 may be reset before the writing time period by allowing the signal of the second light-emitting signal line EM2 to be a valid level signal in a part of the time period when the signal of the first reset signal line Reset3 is a valid level signal, so as to ensure a display uniformity of the pixel driving circuit. In the present disclosure, the voltage values of the signals at both terminals of the second capacitor C2 in the light-emitting phase may be same by allowing the signal of the second reset signal line Reset2 to be a valid level signal in at least part of the time period after the writing time period, which avoids the impact of the second capacitor C2 on the third node N3 in the light-emitting phase, avoids the introduction of noise in the display phase, maintains the stability of the driving current output by the pixel driving circuit, and improves the reliability of the pixel driving circuit.

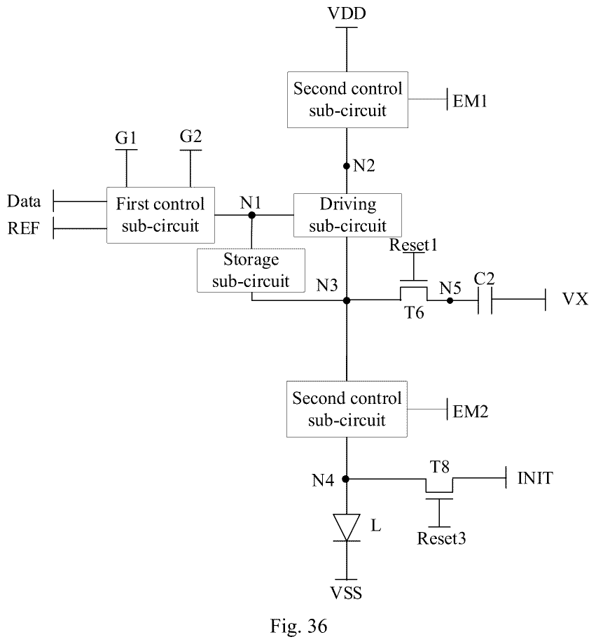

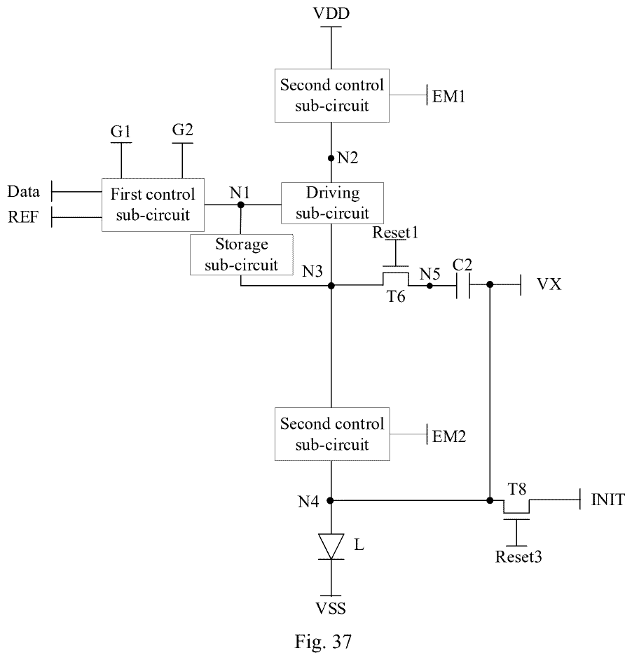

FIG. 36 is an equivalent circuit diagram 5 including the third control sub-circuit shown in FIG. 31, and FIG. 37 is an equivalent circuit diagram 6 including the third control sub-circuit shown in FIG. 31. In an exemplary implementation, as shown in FIG. 36 and FIG. 37, the third control sub-circuit may also be electrically connected to the third reset signal line Reset3 and the initial signal line INIT respectively, and is configured to provide the fourth node N4 with the signal of the initial signal line under the control of the signal of the third reset signal line Reset3. Exemplarily, the third control sub-circuit may also include: a sixth transistor T6, an eighth transistor T8, and a second capacitor C2. A control electrode of the sixth transistor T6 is electrically connected to the first reset signal line Reset1, a first electrode of the sixth transistor T6 is electrically connected to the fifth node N5, and a second electrode of the sixth transistor T6 is electrically connected to the third node N3; a control electrode of the eighth transistor T8 is electrically connected to the third reset signal line Reset3, a first electrode of the eighth transistor T8 is electrically connected to the initial signal line INIT, and a second electrode of the eighth transistor T8 is electrically connected to the fourth node N4; a first terminal of the second capacitor C2 is electrically connected to the auxiliary signal line VX, and a second terminal of the second capacitor C2 is electrically connected to the fifth node N5.

In an exemplary implementation, the signal of the auxiliary signal line VX is a direct current signal, and the signal of the auxiliary signal line VX is the same as the signal of any one of the initial signal line, the reference signal line REF, and the first power line VDD; or, the signal of the auxiliary signal line VX is a non-direct current signal, and the signal of the auxiliary signal line VX is electrically connected to the fourth node N4. FIG. 36 is illustrated by taking the signal of the auxiliary signal line VX being a direct current signal as an example, and FIG. 37 is illustrated by taking the signal of the auxiliary signal line VX being a non-direct current signal as an example.

For example, in some embodiments, as shown in FIG. 36, the signal value of the auxiliary signal line VX is the same as the signal value of the initial signal line VINI, and the signal value of the initial signal line VINI is adjustable, so as to reduce the impact of temperature change on the magnitude of the driving current. For the adjustment manner of the signal value of the initial signal line VINI, please refer to the adjustment manner for the value of the reset signal in the above embodiment, which will not be repeated here.

For example, in some embodiments, as shown in FIG. 37, the signal value of the initial signal line VINI is adjustable to reduce the impact of temperature change on the magnitude of the driving current. For the adjustment manner of the signal value of the initial signal line VINI, please refer to the adjustment manner for the value of the reset signal in the above embodiment, which will not be repeated here.

In an exemplary implementation, as shown in FIG. 36 and FIG. 37, in the present disclosure, the third node N3 and the fourth node N4 may be reset before the writing time period by allowing the signal of the second light-emitting signal line EM2 to be a valid level signal in a part of the time period when the signal of the first reset signal line Reset3 is a valid level signal, so as to ensure the display uniformity of the pixel driving circuit. In the present disclosure, the first reset signal line Reset1 is allowed to be an invalid level signal in a time period after the writing time period, so that the second capacitor C2 will not impact the third node N3, which avoids the introduction of noise in the display phase, maintains the stability of the driving current output by the pixel driving circuit, and improves the reliability of the pixel driving circuit.

In an exemplary implementation, the initial signal line INIT continuously provides a low-level signal, and the signal of the initial signal line INIT is a direct current signal.

In an exemplary implementation, the voltage value of the signal of the initial signal line INIT may be less than the voltage value of the signal of the second power line VSS, which may avoid false light emission of the light-emitting device L, and improve the reliability of the pixel driving circuit.

FIG. 32 to FIG. 37 only show six exemplary structures of the third control sub-circuit. It is easy for those skilled in the art to understand that implementation of the third control sub-circuit is not limited thereto.

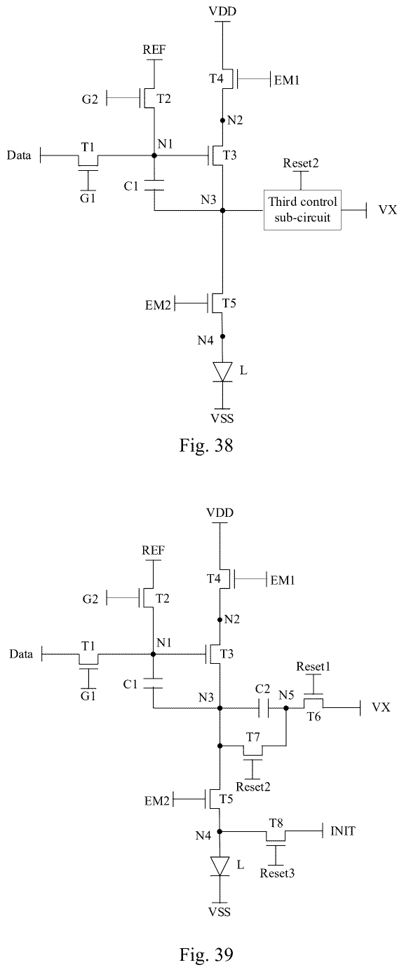

FIG. 38 is a partial equivalent circuit diagram of another pixel driving circuit provided in an embodiment of the present disclosure. As shown in FIG. 38, in an exemplary implementation, the first control sub-circuit may include: a first transistor T1 and a second transistor T2; the driving sub-circuit may include: a third transistor T3; the second control sub-circuit may include: a fourth transistor T4 and a fifth transistor T5; and the storage sub-circuit may include: a first capacitor C1. A control electrode of the first transistor T1 is electrically connected to the first scan signal line G1, a first electrode of the first transistor T1 is electrically connected to the data signal line Data, and a second electrode of the first transistor T1 is electrically connected to the first node N1; a control electrode of the second transistor T2 is electrically connected to the second scan signal line G2, a first electrode of the second transistor T2 is electrically connected to the reference signal line REF, and a second electrode of the second transistor T2 is electrically connected to the first node N1; a control electrode of the third transistor T3 is electrically connected to the first node N1, a first electrode of the third transistor T3 is electrically connected to the second node N2, and a second electrode of the third transistor T3 is electrically connected to the third node N3; a control electrode of the fourth transistor T4 is electrically connected to the first light-emitting signal line EM1, a first electrode of the fourth transistor T4 is electrically connected to the first power supply line VDD, and a second electrode of the fourth transistor T4 is electrically connected to the second node N2; a control electrode of the fifth transistor T5 is electrically connected to the second light-emitting signal line EM2, a first electrode of the fifth transistor T5 is electrically connected to the third node N3, and a second electrode of the fifth transistor T5 is electrically connected to the fourth node N4; a first terminal of the first capacitor C1 is electrically connected to the first node N1, and a second terminal of the first capacitor C1 is electrically connected to the third node N3.

FIG. 38 only shows an exemplary structure of the driving sub-circuit, the first control sub-circuit, the second control sub-circuit and the storage sub-circuit. It is easy for those skilled in the art to understand that implementation of the driving sub-circuit, the first control sub-circuit, the second control sub-circuit and the storage sub-circuit is not limited thereto.

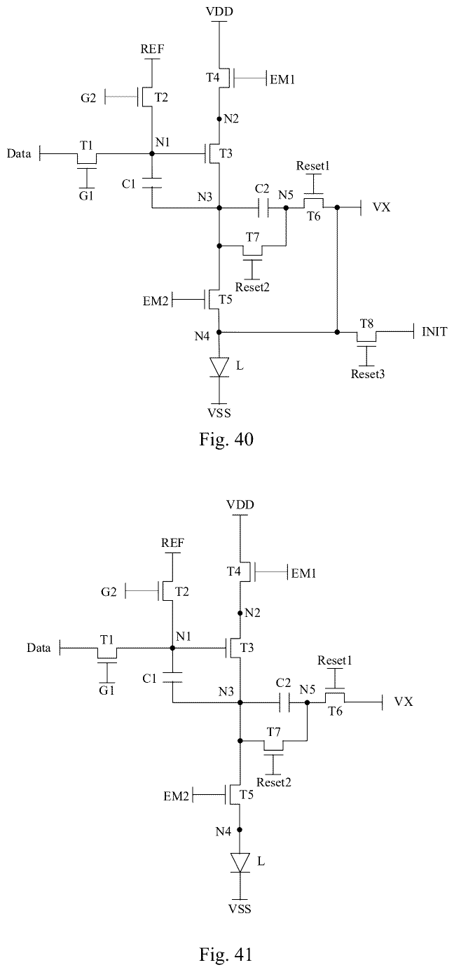

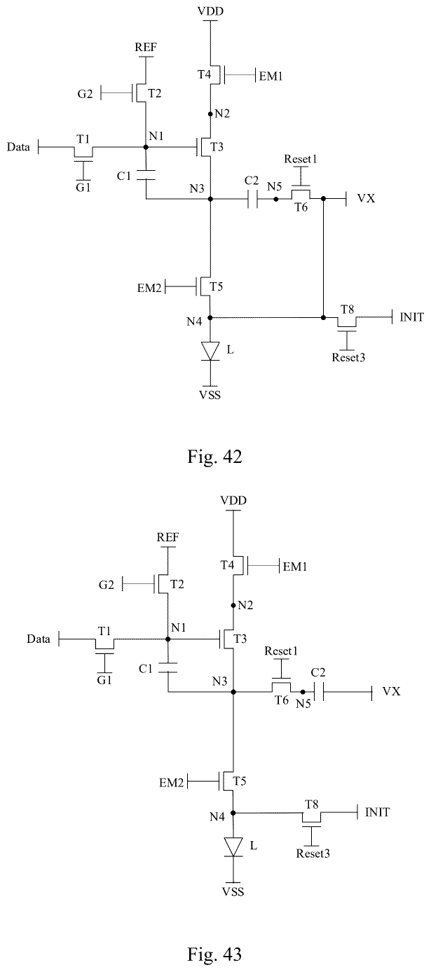

In an exemplary implementation, FIG. 39 is an equivalent circuit diagram 1 of the pixel driving circuit shown in FIG. 38, FIG. 40 is an equivalent circuit diagram 2 of the pixel driving circuit shown in FIG. 38, FIG. 41 is an equivalent circuit diagram 3 of the pixel driving circuit shown in FIG. 38, and FIG. 42 is an equivalent circuit diagram 4 of the pixel driving circuit shown in FIG. 38. As shown in FIG. 39 to FIG. 42, in an exemplary implementation, the first control sub-circuit in the pixel driving circuit includes: a first transistor T1 and a second transistor T2; the driving sub-circuit includes: a third transistor T3; the second control sub-circuit includes: a fourth transistor T4 and a fifth transistor T5; the storage sub-circuit includes: a first capacitor C1; the third control sub-circuit includes a second capacitor C2 and a sixth transistor T6; and the third control sub-circuit also includes: at least one transistor of a seventh transistor T7 and an eighth transistor T8. A control electrode of the first transistor T1 is electrically connected to the first scan signal line G1, a first electrode of the first transistor T1 is electrically connected to the data signal line Data, and a second electrode of the first transistor T1 is electrically connected to the first node N1; a control electrode of the second transistor T2 is electrically connected to the second scan signal line G2, a first electrode of the second transistor T2 is electrically connected to the reference signal line REF, and a second electrode of the second transistor T2 is electrically connected to the first node N1; a control electrode of the third transistor T3 is electrically connected to the first node N1, a first electrode of the third transistor T3 is electrically connected to the second node N2, and a second electrode of the third transistor T3 is electrically connected to the third node N3; a control electrode of the fourth transistor T4 is electrically connected to the first light-emitting signal line EM1, a first electrode of the fourth transistor T4 is electrically connected to the first power supply line VDD, and a second electrode of the fourth transistor T4 is electrically connected to the second node N2; a control electrode of the fifth transistor T5 is electrically connected to the second light-emitting signal line EM2, a first electrode of the fifth transistor T5 is electrically connected to the third node N3, and a second electrode of the fifth transistor T5 is electrically connected to the fourth node N4; a control electrode of the sixth transistor T6 is electrically connected to the first reset signal line Reset1, a first electrode of the sixth transistor T6 is electrically connected to the auxiliary signal line VX, and a second electrode of the sixth transistor T6 is electrically connected to the fifth node N5; a control electrode of the seventh transistor T7 is electrically connected to the second reset signal line Reset2, a first electrode of the seventh transistor T7 is electrically connected to the fifth node N5, and a second electrode of the seventh transistor T7 is electrically connected to the third node N3; a control electrode of the eighth transistor T8 is electrically connected to the third reset signal line Reset3, a first electrode of the eighth transistor T8 is electrically connected to the initial signal line INIT, and a second electrode of the eighth transistor T8 is electrically connected to the fourth node N4; a first terminal of the first capacitor C1 is electrically connected to the first node N1, and a second terminal of the first capacitor C1 is electrically connected to the third node N3; a first terminal of the second capacitor C2 is electrically connected to the fifth node N5, and a second terminal of the second capacitor C2 is electrically connected to the third node N3. FIG. 39 and FIG. 40 are illustrated by taking an example that the third control sub-circuit further includes: a seventh transistor T7 and an eighth transistor T8, FIG. 41 is illustrated by taking an example that the third control sub-circuit further includes: a seventh transistor T7, and FIG. 42 is illustrated by taking an example that the third control sub-circuit further includes: an eighth transistor T8.

In an exemplary implementation, as shown in FIG. 39 and FIG. 40, a signal of the auxiliary signal line VX in the pixel driving circuit in which the third control sub-circuit further includes the seventh transistor T7 and the eighth transistor T8 may be a direct current signal or may be a non-direct current signal. FIG. 39 is an example of the auxiliary signal line VX in the pixel driving circuit being a direct current signal and being the same as the signal of any one of the initial signal line INIT, the reference signal line REF and the first power line VDD. FIG. 40 is an example of the auxiliary signal line VX in the pixel driving circuit being a non-direct current signal and being electrically connected to the fourth node N4.

In an exemplary implementation, as shown in FIG. 41, the signal of the auxiliary signal line VX in the pixel driving circuit in which the third control sub-circuit further includes the seventh transistor T7 is a direct current signal, and is the same as the signal of any one of the initial signal line, the reference signal line and the first power line.

In an exemplary implementation, as shown in FIG. 42, the signal of the auxiliary signal line VX in the pixel driving circuit in which the third control sub-circuit further includes the eighth transistor T8 is a non-direct current signal, and the eighth transistor T8 is electrically connected to the fourth node N4.

In an exemplary implementation, any transistor among the first transistor T1 to the eighth transistor T8 may adopt an oxide thin film transistor. An active layer of the oxide thin film transistor adopts an oxide semiconductor. The oxide thin film transistor has an advantage of low leakage current.

In an exemplary implementation, any transistor among the first transistor T1 to the eighth transistor T8 is an N-type transistor.

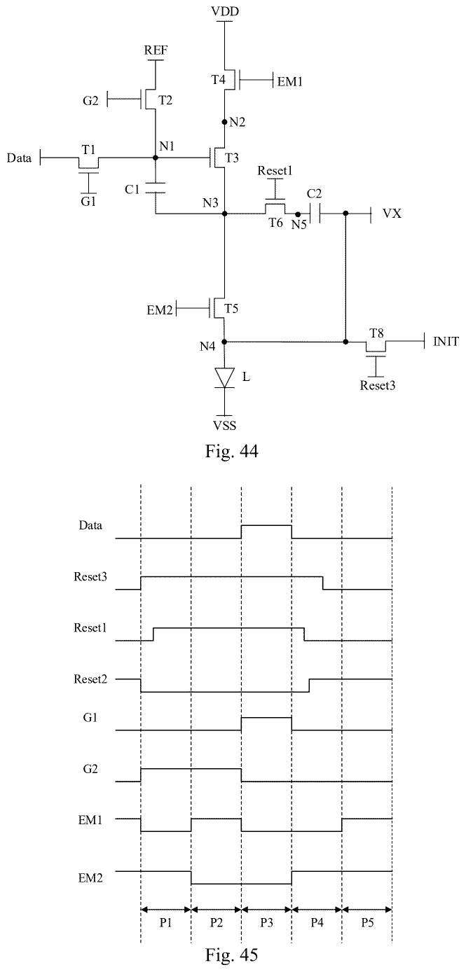

In an exemplary implementation, FIG. 43 is an equivalent circuit diagram 5 of the pixel driving circuit shown in FIG. 38, and FIG. 44 is an equivalent circuit diagram 6 of the pixel driving circuit shown in FIG. 38. As shown in FIG. 43 and FIG. 44, the first control sub-circuit in the pixel driving circuit may include: a first transistor T1 and a second transistor T2; the driving sub-circuit may include: a third transistor T3; the second control sub-circuit may include: a fourth transistor T4 and a fifth transistor T5; the storage sub-circuit may include: a first capacitor C1; and the third control sub-circuit may include a second capacitor C2, a sixth transistor T6 and an eighth transistor T8. A control electrode of the first transistor T1 is electrically connected to the first scan signal line G1, a first electrode of the first transistor T1 is electrically connected to the data signal line Data, and a second electrode of the first transistor T1 is electrically connected to the first node N1; a control electrode of the second transistor T2 is electrically connected to the second scan signal line G2, a first electrode of the second transistor T2 is electrically connected to the reference signal line REF, and a second electrode of the second transistor T2 is electrically connected to the first node N1; a control electrode of the third transistor T3 is electrically connected to the first node N1, a first electrode of the third transistor T3 is electrically connected to the second node N2, and a second electrode of the third transistor T3 is electrically connected to the third node N3; a control electrode of the fourth transistor T4 is electrically connected to the first light-emitting signal line EM1, a first electrode of the fourth transistor T4 is electrically connected to the first power supply line VDD, and a second electrode of the fourth transistor T4 is electrically connected to the second node N2; a control electrode of the fifth transistor T5 is electrically connected to the second light-emitting signal line EM2, a first electrode of the fifth transistor T5 is electrically connected to the third node N3, and a second electrode of the fifth transistor T5 is electrically connected to the fourth node N4; a control electrode of the sixth transistor T6 is electrically connected to the first reset signal line Reset1, a first electrode of the sixth transistor T6 is electrically connected to the fifth node N5, and a second electrode of the sixth transistor T6 is electrically connected to the third node N3; a control electrode of the eighth transistor T8 is electrically connected to the third reset signal line Reset3, a first electrode of the eighth transistor T8 is electrically connected to the initial signal line INIT, and a second electrode of the eighth transistor T8 is electrically connected to the fourth node N4; a first terminal of the first capacitor C1 is electrically connected to the first node N1, and a second terminal of the first capacitor C1 is electrically connected to the third node N3; a first terminal of the second capacitor C2 is electrically connected to the auxiliary signal line VX, and a second terminal of the second capacitor C2 is electrically connected to the fifth node N5.

In an exemplary implementation, as shown in FIG. 43 and FIG. 44, the signal of the auxiliary signal line VX in the pixel driving circuit in which the third control sub-circuit includes the sixth transistor T6, the eighth transistor T8 and the second capacitor C2 may be a direct current signal, or may be a non-direct current signal. FIG. 43 is illustrated by taking an example that the signal of the auxiliary signal line VX in the pixel driving circuit is a direct current signal and is the same as the signal of any one of the initial signal line INIT, the reference signal line REF and the first power line VDD, and FIG. 44 is illustrated by taking an example that the signal of the auxiliary signal line VX in the pixel driving circuit is a non-DC signal and is electrically connected to the fourth node N4.

In an exemplary implementation, any transistor of the first transistor T1, the second transistor T2, the fourth transistor T4, the fifth transistor T5, the sixth transistor T6 and the eighth transistor T8 may be an oxide thin film transistor. An active layer of the oxide thin film transistor adopts an oxide semiconductor. The oxide thin film transistor has an advantage of low leakage current.

In an exemplary implementation, any transistor of the first transistor T1, the second transistor T2, the fourth transistor T4, the fifth transistor T5, the sixth transistor T6, and the eighth transistor T8 is an N-type transistor.

In an exemplary implementation, in the pixel driving circuit provided in FIG. 39 to FIG. 44, a quantity of the first transistor T1, the second transistor T2, and the fourth transistor T4 may be at least one.

In an exemplary implementation, when a quantity of the first transistors T1 may be at least two, control electrodes of all the first transistors are electrically connected to the first scan signal line, at least two first transistors are arranged in series, a first electrode of a first one of the first transistors is electrically connected to the data signal line, and a second electrode of a last one of the first transistors is electrically connected to the first node N1.

In an exemplary implementation, when a quantity of the second transistors T2 may be at least two, control electrodes of all the second transistors T2 are electrically connected to the second scan signal line, at least two second transistors are arranged in series, a first electrode of a first one of the second transistors is electrically connected to the reference signal line, and a second electrode of a last one of the second transistors is electrically connected to the first node N1.

FIG. 45 is an operating timing diagram of the pixel driving circuit provided in FIG. 39 and FIG. 40. An exemplary embodiment of the present disclosure is illustrated below through an operating process of the pixel driving circuit illustrated in FIGS. 39 and 40. The pixel driving circuit in FIGS. 39 and 40 includes eight transistors (a first transistor T1 to an eighth transistor T8) and two capacitors (a first capacitor C1 and a second capacitor C2), and all of the eight transistors are N-type transistors.

In an exemplary implementation, the operating process of the pixel driving circuit provided in FIGS. 39 and 40 may include the following phases.

A first phase P1 is referred to as a first reset phase, the signals of the second scan signal line G2, the second light-emitting signal line EM2, the first reset signal line Reset1 and the third reset signal line Reset3 are high-level signals, and the signals of the first scan signal line G1, the first light-emitting signal line EM1 and the second reset signal line Reset2 are low-level signals. The signal of the second scan signal line G2 is a high-level signal, the second transistor T2 is turned on, the signal of the reference signal line REF is written into the first node N1, the signal of the first node N1 is initialized (reset), and original charges at the first node N1 are cleared. The signal of the first reset signal line Reset1 is a high-level signal, the sixth transistor T6 is turned on, the signal of the auxiliary signal line VX is written into the fifth node N5, the signal of the fifth node N5 is initialized (reset), and original charges at the fifth node N5 are cleared. The signals of the second light-emitting signal line EM2 and the third reset signal line Reset3 are high-level signals, the fifth transistor T5 and the eighth transistor T8 are turned on, and the signal of the initial signal line INIT is written into the third node N3 and the fourth node N4 respectively. Because a voltage difference between the voltage value of the signal of the first node N1 and the voltage value of the signal of the third node N3 are greater than a threshold voltage of the third transistor T3, at this time, the third transistor T3 is turned on, and the signal of the initial signal line INIT is written into the second node N2, and the signals of the second node N2, the third node N3 and the fourth node N4 are initialized (reset), and original charges at the second node N2, the third node N3 and the fourth node N4 are cleared. The signals of the first scan signal line G1, the first light-emitting signal line EM1 and the second reset signal line Reset2 are low-level signals, and the first transistor T1, the fourth transistor T4 and the seventh transistor T7 are turned off. In this phase, the light-emitting device L does not emit light.

A second phase P2 is a threshold compensation phase, the signals of the first reset signal line Reset1, the third reset signal line Reset3, the second scan signal line G2, and the first light-emitting signal line EM1 are high-level signals, and the signals of the second reset signal line Reset2, the first scan signal line G1, and the second light-emitting signal line EM2 are low-level signals. The signal of the first reset signal line Reset1 is a high-level signal, the sixth transistor T6 is turned on, the signal of the auxiliary signal line VX is continuously written into the fifth node N5, and the signal of the fifth node N5 is continuously initialized (reset). The signal of the third reset signal line Reset3 is a high-level signal, the eighth transistor T8 is turned on, the signal of the initial signal line INIT is continuously written into the fourth node N4, and the signal of the fourth node N4 is continuously initialized (reset). The signal of the second scan signal line G2 is a high-level signal, the second transistor T2 is turned on, the signal of the reference signal line REF is continuously provided to the first node N1, the signal of the first light-emitting signal line EM1 is a high-level signal, the fourth transistor T4 is turned on, and the signal of the first power line VDD is written into the third node N3 through the turned-on fourth transistor T4, the second node N2 and the turned-on third transistor T3, until the voltage of the signal of the third node N3 is V3=Vref−Vth, where Vref is a voltage value of the signal of the initial signal line REF, Vth is a threshold voltage of the third transistor T3, at this time, the first capacitor C1 stores a voltage difference Vth of the signals of the first node N1 and the third node N3. The signals of the second reset signal line Reset2, the first scan signal line G1 and the second light-emitting signal line EM2 are low-level signals, and the first transistor T1, the fifth transistor T5 and the seventh transistor are turned off. In this phase, the light-emitting device L does not emit light.

A third phase P3 is a data writing phase, the signals of the first reset signal line Reset1, the third reset signal line Reset3 and the first scan signal line G1 are high-level signals, the signals of the second reset signal line Reset2, the second scan signal line G2, the first light-emitting signal line EM1 and the second light-emitting signal line EM2 are low-level signals, and the data signal line Data outputs the data voltage. The signal of the first reset signal line Reset1 is a high-level signal, the sixth transistor T6 is turned on, the signal of the auxiliary signal line VX is continuously written into the fifth node N5, and the signal of the fifth node N5 is continuously initialized (reset). The signal of the third reset signal line Reset3 is a high-level signal, the eighth transistor T8 is turned on, the signal of the initial signal line INIT is continuously written into the fourth node N4, and the signal of the fourth node N4 is continuously initialized (reset). The signal of the first scan signal line G1 is a high-level signal, the first transistor T1 is turned on, and the data voltage of the data signal line Data is written into the first node N1. At this time, the voltage value of the first node N1 is V1=Vdata, where Vdata is a data voltage of the data signal line, and the signal of the first node N1 has a voltage jump from a voltage value of this phase compared to a voltage value of a previous phase. Therefore, under an action of the first capacitor C1 and the second capacitor C2, the signal of the third node N3 also has a voltage jump. At this time, the voltage value of the signal of the third node N3 is V3=Vref−Vth+(Vdata−Vref)*C1/(C1+C2), where C1 is a capacitance value of the first capacitor and C2 is a capacitance value of the second capacitor. The signals of the second reset signal line Reset2, the second scan signal line G2, the first light-emitting signal line EM1 and the second light-emitting signal line EM2 are low-level signals, and the second transistor T2, the fourth transistor T4, the fifth transistor T5 and the seventh transistor T7 are turned off. In this phase, the light-emitting device L does not emit light.

A fourth phase P4 is referred to as a second reset phase. The signals of the second reset signal line Reset2, the third reset signal line Reset3 and the second light-emitting signal line EM2 are high-level signals, and the signals of the first reset signal line Reset1, the first light-emitting signal line EM1, the first scan signal line G1 and the second scan signal line G2 are low-level signals. The signal of the third reset signal line Reset3 is a high-level signal, the eighth transistor T8 is turned on, and the signal of the initial signal line INIT is continuously written into the fourth node N4, and the signal of the fourth node N4 is continuously initialized (reset). The signal of the second light-emitting signal line EM2 is a high-level signal, the fifth transistor T5 is turned on, the voltage of the signal of the third node N3 is V3=Vinit, where Vinit is a voltage value of the signal of the initial signal line, at this time, the first node N1 is pulled down under an action of the first capacitor C1, so that a voltage of the signal of the first node N1 is V1=Vdata−[Vref−Vth+(Vdata−Vref)*C1/(C1+C2)]+Vinit, the signal of the second reset signal line Reset2 is a high-level signal, the seventh transistor T7 is turned on, and the voltages of the signals of the third node N3 and the fifth node N5 remain consistent. The signals of the first reset signal line Reset1, the first light-emitting signal line EM1, the first scan signal line G1 and the second scan signal line G2 are low-level signals, and the first transistor T1, the second transistor T2, the fourth transistor T4 and the sixth transistor T6 are turned off. In this phase, the light-emitting device L does not emit light.

A fifth phase P5 is a light-emitting phase, the signals of the second reset signal line Reset2, the first light-emitting signal line EM1, and the second light-emitting signal line EM2 are high-level signals, and the signals of the first reset signal line Reset1, the third reset signal line Reset3, the first scan signal line G1, and the second scan signal line G2 are low-level signals. The signals of the first light-emitting signal line EM1 and the second light-emitting signal line Reset2 are high-level signals, the fourth transistor T4 and the fifth transistor T5 are turned on, and the power supply voltage output by the first power line VDD provides a driving voltage to the first electrode of the light-emitting device L through the turned-on fourth transistor T4, the third transistor T3, and the fifth transistor T5, to drive the light-emitting device L to emit light, the signal of the second reset signal line Reset2 is a high-level signal, the seventh transistor T7 is turned on, and the voltages of the signals of the third node N3 and the fifth node N5 remain consistent. The signals of the first reset signal line Reset1, the third reset signal line Reset3, the first scan signal line G1, and the second scan signal line G2 are low-level signals, the first transistor T1, the second transistor T2, the sixth transistor T6, and the eighth transistor T8 are turned off. In this phase, the light-emitting device L emits light.

During a driving process of the pixel driving circuit, the driving current flowing through the third transistor T3 (a driving transistor) is determined by a voltage difference between the control electrode (also the first node N1) and the second electrode (also the third node N3) thereof. Because the voltage value V1 of the signal of the first node is equal to Vdata−[Vref−Vth+(Vdata−Vref)*C1/(C1+C2)]+Vinit, the voltage value V3 of the signal of the third node N3 is equal to Vinit, so the driving current of the third transistor T3 is:

I=K*(Vgs−Vth)²=K*[Vdata−[Vref−Vth+(Vdata−Vref)*C1/(C1+C2)]−Vth]²=K*[(C2/(C1+C2))*(Vdata−Vref)]².

Where I is a driving current flowing through the third transistor T3, that is, the driving current for driving the light-emitting device L, K is a constant, and Vgs is a voltage difference between the control electrode of the third transistor T3 and the second electrode of the third transistor T3.

It can be seen from a derivation result of the above current formula that in the light-emitting phase, the driving current of the third transistor T3 is no longer affected by a threshold voltage of the third transistor T3, thereby eliminating the impact of the threshold voltage of the third transistor T3 on the driving current, which can ensure a uniform display brightness of a display product and improve the display effect of the entire display product.

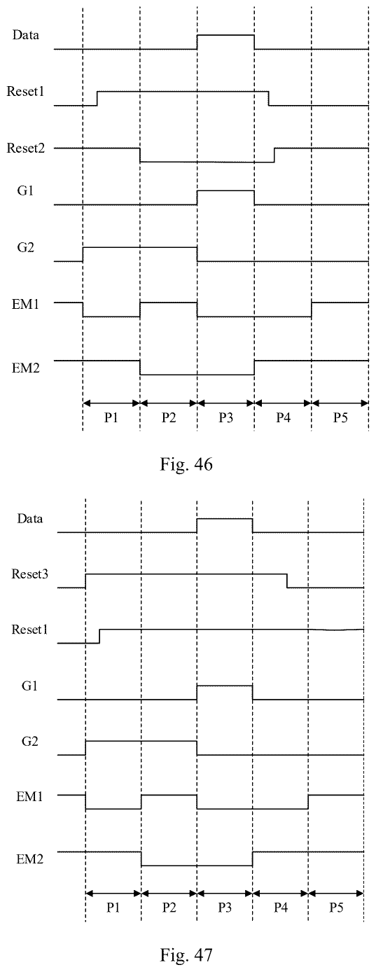

FIG. 46 is an operating timing diagram of the pixel driving circuit provided in FIG. 41. An exemplary embodiment of the present disclosure is illustrated below through the operating process of the pixel driving circuit shown in FIG. 41. The pixel driving circuit in FIG. 41 includes seven transistors (a first transistor T1 to a seventh transistor T7) and two capacitors (a first capacitor C1 and a second capacitor C2), and all the seven transistors are N-type transistors.

In an exemplary implementation, the operating process of the pixel driving circuit provided in FIG. 41 may include the following phases.

A first phase P1 is referred to as a first reset phase, the signals of the second scan signal line G2, the second light-emitting signal line EM2, the first reset signal line Reset1 and the second reset signal line Reset2 are high-level signals, and the signals of the first scan signal line G1 and the first light-emitting signal line EM1 are low-level signals. The signal of the second scan signal line G2 is a high-level signal, the second transistor T2 is turned on, the signal of the reference signal line REF is written into the first node N1, the signal of the first node N1 is initialized (reset), and original charges in the first node N1 are cleared. The signals of the first reset signal line Reset1, the second reset signal line Reset2, and the second light-emitting signal line EM2 are high-level signals, the fifth transistor T5, the sixth transistor T6, and the seventh transistor T7 are turned on, the signal of the auxiliary signal line VX is sequentially written into the fifth node N5, the third node N3, and the fourth node N4, the signals of the third node N3, the fourth node N4, and the fifth node N5 are initialized (reset), and original charges in the third node N3, the fourth node N4, and the fifth node N5 are cleared. The signals of the first scan signal line G1 and the first light-emitting signal line EM1 are low-level signals, and the first transistor T1 and the fourth transistor T4 are turned off. In this phase, the light-emitting device L does not emit light.

A second phase P2 is a threshold compensation phase, the signals of the first reset signal line Reset1, the second scan signal line G2, and the first light-emitting signal line EM1 are high-level signals, and the signals of the second reset signal line Reset2, the first scan signal line G1, and the second light-emitting signal line EM2 are low-level signals. The signal of the first reset signal line Reset1 is a high-level signal, the sixth transistor T6 is turned on, and the signal of the auxiliary signal line VX is continuously written into the fifth node N5, and the signal of the fifth node N5 is continuously initialized (reset). The signal of the second scan signal line G2 is a high-level signal, the second transistor T2 is turned on, the signal of the reference signal line REF is continuously provided to the first node N1, the signal of the first light-emitting signal line EM1 is a high-level signal, the fourth transistor T4 is turned on, and the signal of the first power line VDD is written into the third node N3 through the turned-on fourth transistor T4, the second node N2 and the turned-on third transistor T3, until the voltage V3 of the signal of the third node N3 is equal to Vref−Vth, where Vref is a voltage value of the signal of the initial signal line REF, Vth is a threshold voltage of the third transistor T3, at this time, the first capacitor C1 stores a voltage difference Vth of the signals of the first node N1 and the third node N3. The signals of the second reset signal line Reset2, the first scan signal line G1 and the second light-emitting signal line EM2 are low-level signals, and the first transistor T1, the fifth transistor T5 and the seventh transistor are turned off. In this phase, the light-emitting device L does not emit light.

A third phase P3 is a data writing phase, the signals of the first reset signal line Reset1 and the first scan signal line G1 are high-level signals, the signals of the second reset signal line Reset2, the second scan signal line G2, the first light-emitting signal line EM1 and the second light-emitting signal line EM2 are low-level signals, and the data signal line Data outputs the data voltage. The signal of the first reset signal line Reset1 is a high-level signal, the sixth transistor T6 is turned on, the signal of the auxiliary signal line VX is continuously written into the fifth node N5, and the signal of the fifth node N5 is continuously initialized (reset). The signal of the first scan signal line G1 is a high-level signal, the first transistor T1 is turned on, and the data voltage of the data signal line Data is written into the first node N1. At this time, the voltage value of the first node N1 V1 is equal to Vdata, where Vdata is a data voltage of the data signal line, and the signal of the first node N1 has a voltage jump from the voltage value of this phase compared to the voltage value of a previous phase. Therefore, under an action of the first capacitor C1 and the second capacitor C2, the signal of the third node N3 also has a voltage jump. At this time, the voltage value V3 of the signal of the third node N3 is equal to Vref−Vth+(Vdata−Vref)*C1/(C1+C2), where C1 is a capacitance value of the first capacitor and C2 is a capacitance value of the second capacitor. The signals of the second reset signal line Reset2, the second scan signal line G2, the first light-emitting signal line EM1 and the second light-emitting signal line EM2 are low-level signals, and the second transistor T2, the fourth transistor T4, the fifth transistor T5 and the seventh transistor T7 are turned off. In this phase, the light-emitting device L does not emit light.

A fourth phase P4 is referred to as a second reset phase. The signals of the second reset signal line Reset2 and the second light-emitting signal line EM2 are high-level signals, and the signals of the first reset signal line Reset1, the first light-emitting signal line EM1, the first scan signal line G1, and the second scan signal line G2 are low-level signals. The signal of the second light-emitting signal line EM2 is a high-level signal, the fifth transistor T5 is turned on, the voltage V3 of the signal of the third node N3 is equal to Vinit, Vinit is a voltage value of the signal of the initial signal line, at this time, the first node N1 is pulled down under the action of the first capacitor C1, so that the voltage V1 of the signal of the first node N1 is equal to Vdata−[Vref−Vth+(Vdata−Vref)*C1/(C1+C2)]+Vinit, the signal of the second reset signal line Reset2 is a high-level signal, the seventh transistor T7 is turned on, and the voltages of the signals of the third node N3 and the fifth node N5 remain consistent. The signals of the first reset signal line Reset1, the first light-emitting signal line EM1, the first scan signal line G1 and the second scan signal line G2 are low-level signals, and the first transistor T1, the second transistor T2, the fourth transistor T4 and the sixth transistor T6 are turned off. In this phase, the light-emitting device L does not emit light.

A fifth phase P5 is a light-emitting phase, the signals of the second reset signal line Reset2, the first light-emitting signal line EM1 and the second light-emitting signal line EM2 are high-level signals, and the signals of the first reset signal line Reset1, the first scan signal line G1 and the second scan signal line G2 are low-level signals. The signals of the first light-emitting signal line EM1 and the second light-emitting signal line EM2 are high-level signals, the fourth transistor T4 and the fifth transistor T5 are turned on, and the power supply voltage output by the first power line VDD provides a driving voltage to the first electrode of the light-emitting device L through the turned-on fourth transistor T4, the third transistor T3 and the fifth transistor T5, to drive the light-emitting device L to emit light, the signal of the second reset signal line Reset2 is a high-level signal, the seventh transistor T7 is turned on, and the voltages of the signals of the third node N3 and the fifth node N5 remain consistent. The signals of the first reset signal line Reset1, the first scan signal line G1 and the second scan signal line G2 are low-level signals, and the first transistor T1, the second transistor T2 and the sixth transistor T6 are turned off. In this phase, the light-emitting device L emits light.

During a driving process of the pixel driving circuit, the driving current flowing through the third transistor T3 (a driving transistor) is determined by a voltage difference between the control electrode (also the first node N1) and the second electrode (also the third node N3) thereof. Because the voltage value V1 of the signal of the first node is equal to Vdata−[Vref−Vth+(Vdata−Vref)*C1/(C1+C2)]+Vinit, the voltage value V3 of the signal of the third node N3 is equal to Vinit, the driving current of the third transistor T3 is:

I=K*(Vgs−Vth)²=K*[Vdata−[Vref−Vth+(Vdata−Vref)*C1/(C1+C2)]−Vth]²=K*[(C2/(C1+C2))*(Vdata−Vref)]².

Where I is a driving current flowing through the third transistor T3, that is, the driving current for driving the light-emitting device L, K is a constant, and Vgs is a voltage difference between the control electrode and the second electrode of the third transistor T3.

It can be seen from a derivation result of the above current formula that in the light-emitting phase, the driving current of the third transistor T3 is no longer affected by a threshold voltage of the third transistor T3, thereby eliminating the impact of the threshold voltage of the third transistor T3 on the driving current, which may ensure a uniform display brightness of a display product and improve the display effect of the entire display product.

FIG. 47 is an operating timing diagram of the pixel driving circuit provided in FIG. 42. An exemplary embodiment of the present disclosure is illustrated below by an operating process of the pixel driving circuit shown in FIG. 42. The pixel driving circuit in FIG. 42 includes seven transistors (a first transistor T1 to a sixth transistor T6, and an eighth transistor T8) and two capacitors (a first capacitor C1 and a second capacitor C2), and all the seven transistors are N-type transistors.

In an exemplary embodiment, the operating process of the pixel driving circuit provided in FIG. 42 may include the following phases.

A first phase P1 is referred to as a first reset phase, the signals of the second scan signal line G2, the second light-emitting signal line EM2, the first reset signal line Reset1 and the third reset signal line Reset3 are high-level signals, and the signals of the first scan signal line G1 and the first light-emitting signal line EM1 are low-level signals. The signal of the second scan signal line G2 is a high-level signal, the second transistor T2 is turned on, the signal of the reference signal line REF is written into the first node N1, the signal of the first node N1 is initialized (reset), and original charges at the first node N1 are cleared. The signal of the first reset signal line Reset1 is a high-level signal, the sixth transistor T6 is turned on, the signal of the auxiliary signal line VX is written into the fifth node N5, the signal of the fifth node N5 is initialized (reset), and original charges at the fifth node N5 are cleared. The signals of the second light-emitting signal line EM2 and the third reset signal line Reset3 are high-level signals, the fifth transistor T5 and the eighth transistor T8 are turned on, and the signal of the initial signal line INIT is written into the third node N3 and the fourth node N4 respectively. Because the difference between the voltage value of the signal of the first node N1 and the voltage value of the signal of the third node N3 are greater than the threshold voltage of the third transistor T3, at this time, the third transistor T3 is turned on, the signal of the initial signal line INIT is written into the second node N2, the signals of the second node N2, the third node N3 and the fourth node N4 are initialized (reset), and original charges in the second node N2, the third node N3 and the fourth node N4 are cleared. The signals of the first scan signal line G1 and the first light-emitting signal line EM1 are low-level signals, and the first transistor T1 and the fourth transistor T4 are turned off. In this phase, the light-emitting device L does not emit light.

A second phase P2 is a threshold compensation phase, the signals of the first reset signal line Reset1, the third reset signal line Reset3, the second scan signal line G2 and the first light-emitting signal line EM1 are high-level signals, and the signals of the first scan signal line G1 and the second light-emitting signal line EM2 are low-level signals. The signal of the first reset signal line Reset1 is a high-level signal, the sixth transistor T6 is turned on, the signal of the auxiliary signal line VX is continuously written into the fifth node N5, and the signal of the fifth node N5 is continuously initialized (reset). The signal of the third reset signal line Reset3 is a high-level signal, the eighth transistor T8 is turned on, the signal of the initial signal line INIT is continuously written into the fourth node N4, and the signal of the fourth node N4 is continuously initialized (reset). The signal of the second scan signal line G2 is a high-level signal, the second transistor T2 is turned on, the signal of the reference signal line REF is continuously provided to the first node N1, the signal of the first light-emitting signal line EM1 is a high-level signal, the fourth transistor T4 is turned on, and the signal of the first power line VDD is written into the third node N3 through the turned-on fourth transistor T4, the second node N2 and the turned-on third transistor T3, until the voltage V3 of the signal of the third node N3 is equal to Vref−Vth, Vref is a voltage value of the signal of the initial signal line REF, Vth is a threshold voltage of the third transistor T3, at this time, the first capacitor C1 stores a voltage difference Vth of the signals of the first node N1 and the third node N3. The signals of the first scan signal line G1 and the second light-emitting signal line EM2 are low-level signals, and the first transistor T1 and the fifth transistor T5 are turned off. In this phase, the light-emitting device L does not emit light.

A third phase P3 is a data writing phase, the signals of the first reset signal line Reset1, the third reset signal line Reset3 and the first scan signal line G1 are high-level signals, the signals of the second scan signal line G2, the first light-emitting signal line EM1 and the second light-emitting signal line EM2 are low-level signals, and the data signal line Data outputs the data voltage. The signal of the first reset signal line Reset1 is a high-level signal, the sixth transistor T6 is turned on, the signal of the auxiliary signal line VX is continuously written into the fifth node N5, and the signal of the fifth node N5 is continuously initialized (reset). The signal of the third reset signal line Reset3 is a high-level signal, the eighth transistor T8 is turned on, the signal of the initial signal line INIT is continuously written into the fourth node N4, and the signal of the fourth node N4 is continuously initialized (reset). The signal of the first scan signal line G1 is a high-level signal, the first transistor T1 is turned on, and the data voltage of the data signal line Data is written into the first node N1. At this time, the voltage value V1 of the first node N1 is equal to Vdata, Vdata is a data voltage of the data signal line, and the signal of the first node N1 has a voltage jump from a voltage value of this phase compared to the voltage value of a previous phase. Therefore, under an action of the first capacitor C1 and the second capacitor C2, the signal of the third node N3 also has a voltage jump. At this time, the voltage value V3 of the signal of the third node N3 is equal to Vref−Vth+(Vdata−Vref)*C1/(C1+C2), where C1 is a capacitance value of the first capacitor and C2 is a capacitance value of the second capacitor. The signals of the second scan signal line G2, the first light-emitting signal line EM1 and the second light-emitting signal line EM2 are low-level signals, and the second transistor T2, the fourth transistor T4 and the fifth transistor T5 are turned off. In this phase, the light-emitting device L does not emit light.

A fourth phase P4 is referred to as a second reset phase. The first reset signal line Reset1, the third reset signal line Reset3 and the second light-emitting signal line EM2 are high-level signals, and the signals of the first light-emitting signal line EM1, the first scan signal line G1 and the second scan signal line G2 are low-level signals. The signal of the third reset signal line Reset3 is a high-level signal, the eighth transistor T8 is turned on, and the signal of the initial signal line INIT is continuously written into the fourth node N4, and the signal of the fourth node N4 is continuously initialized (reset). The signal of the second light-emitting signal line EM2 is a high-level signal, the fifth transistor T5 is turned on, and the voltage of the signal of the third node N3 is V3, which is equal to Vinit, Vinit is a voltage value of the signal of the initial signal line. At this time, the first node N1 is pulled down under the action of the first capacitor C1, so that the voltage of the signal of the first node N1 is V1, which is equal to Vdata−[Vref−Vth+(Vdata−Vref)*C1/(C1+C2)]+Vinit, the signal of the first reset signal line Reset1 is a high-level signal, the sixth transistor T6 is turned on, and the voltages of the third node N3 and the fifth node N5 signals remain consistent. The signals of the first reset signal line Reset1, the first light-emitting signal line EM1, the first scan signal line G1 and the second scan signal line G2 are low-level signals, and the first transistor T1, the second transistor T2 and the fourth transistor T4 are turned off. In this phase, the light-emitting device L does not emit light.

A fifth phase P5 is a light-emitting phase, the signals of the first reset signal line Reset1, the first light-emitting signal line EM1 and the second light-emitting signal line EM2 are high-level signals, and the signals of the third reset signal line Reset3, the first scan signal line G1 and the second scan signal line G2 are low-level signals. The signals of the first light-emitting signal line EM1 and the second light-emitting signal line EM2 are high-level signals, the fourth transistor T4 and the fifth transistor T5 are turned on, and the power supply voltage output by the first power line VDD provides a driving voltage to the first electrode of the light-emitting device L through the turned-on fourth transistor T4, the third transistor T3 and the fifth transistor T5, to drive the light-emitting device L to emit light, the signal of the first reset signal line Reset1 is a high-level signal, the sixth transistor T6 is turned on, and the voltages of the signals of the third node N3 and the fifth node N5 remain consistent. The signals of the third reset signal line Reset3, the first scan signal line G1 and the second scan signal line G2 are low-level signals, and the first transistor T1, the second transistor T2 and the eighth transistor T8 are turned off. In this phase, the light-emitting device L emits light.

During a driving process of the pixel driving circuit, the driving current flowing through the third transistor T3 (a driving transistor) is determined by a voltage difference between the control electrode of the third transistor T3 (also the first node N1) and the second electrode of the third transistor T3 (also the third node N3). Because the voltage value of the signal of the first node is V1, which is equal to Vdata−[Vref−Vth+(Vdata−Vref)*C1/(C1+C2)]+Vinit, and the voltage value V3 of the signal of the third node N3 is equal to Vinit, the driving current of the third transistor T3 is:

I=K*(Vgs−Vth)²=K*[Vdata−[Vref−Vth+(Vdata−Vref)*C1/(C1+C2)]−Vth]²=K*[(C2/(C1+C2))*(Vdata−Vref)]².

Where I is a driving current flowing through the third transistor T3, that is, the driving current for driving the light-emitting device L, K is a constant, and Vgs is a voltage difference between the control electrode of the third transistor T3 and the second electrode of the third transistor T3.

It can be seen from a derivation result of the above current formula that in the light-emitting phase, the driving current of the third transistor T3 is no longer affected by a threshold voltage of the third transistor T3, thereby eliminating the impact of the threshold voltage of the third transistor T3 on the driving current, which can ensure a uniform display brightness of a display product and improve the display effect of the entire display product.

For the pixel driving circuit provided in FIGS. 39 to 42, in the fourth and fifth phases, the signals of the third node N3 and the fifth node N5 at both terminals of the second capacitor C2 remain consistent, so that the third node of the pixel driving circuit will not be affected by a coupling effect of the second capacitor C2 in the fifth phase, which may improve the stability of the driving current of the pixel driving circuit and improve the reliability of the pixel driving circuit.

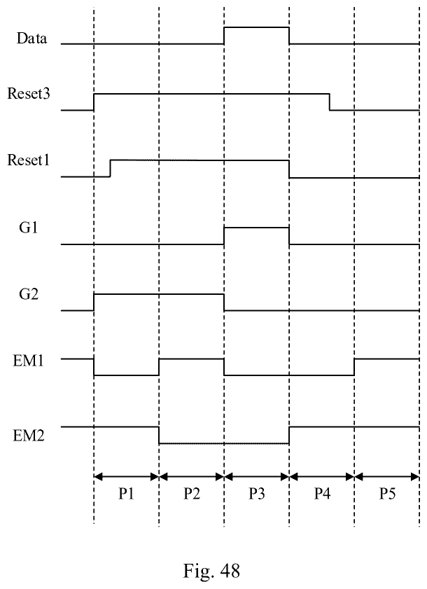

FIG. 48 is an operating timing diagram of the pixel driving circuit provided in FIG. 43 and FIG. 44. An exemplary embodiment of the present disclosure is illustrated by an operating process of the pixel driving circuit shown in FIG. 43 and FIG. 44. The pixel driving circuit in FIG. 43 and FIG. 44 includes seven transistors (a first transistor T1 to a sixth transistor T6, and an eighth transistor T8) and two capacitors (a first capacitor C1 and a second capacitor C2), and all the seven transistors are N-type transistors.

In an exemplary implementation, the operating process of the pixel driving circuit provided in FIG. 43 and FIG. 44 may include the following phases.

A first phase P1 is referred to as a first reset phase, the signals of the second scan signal line G2, the second light-emitting signal line EM2, the first reset signal line Reset1 and the third reset signal line Reset3 are high-level signals, and the signals of the first scan signal line G1 and the first light-emitting signal line EM1 are low-level signals. The signal of the second scan signal line G2 is a high-level signal, the second transistor T2 is turned on, the signal of the reference signal line REF is written into the first node N1, the signal of the first node N1 is initialized (reset), and original charges at the first node N1 are cleared. The signal of the first reset signal line Reset1 is a high-level signal, the sixth transistor T6 is turned on, the signal of the auxiliary signal line VX is written into the fifth node N5, the signal of the fifth node N5 is initialized (reset), and original charges at the fifth node N5 are cleared. The signals of the second light-emitting signal line EM2 and the third reset signal line Reset3 are high-level signals, the fifth transistor T5 and the eighth transistor T8 are turned on, and the signal of the initial signal line INIT is written into the third node N3 and the fourth node N4 respectively. Because difference between the voltage value of the signal of the first node N1 and the voltage value of the signal of the third node N3 are greater than the threshold voltage of the third transistor T3, at this time, the third transistor T3 is turned on, and the signal of the initial signal line INIT is written into the second node N2, and the signals of the second node N2, the third node N3 and the fourth node N4 are initialized (reset), and original charges in the second node N2, the third node N3 and the fourth node N4 are cleared. The signals of the first scan signal line G1 and the first light-emitting signal line EM1 are low-level signals, and the first transistor T1 and the fourth transistor T4 are turned off. In this phase, the light-emitting device L does not emit light.

A second phase P2 is a threshold compensation phase, the signals of the first reset signal line Reset1, the third reset signal line Reset3, the second scan signal line G2, and the first light-emitting signal line EM1 are high-level signals, and the signals of the first scan signal line G1 and the second light-emitting signal line EM2 are low-level signals. The signal of the first reset signal line Reset1 is a high-level signal, the sixth transistor T6 is turned on, the signal of the auxiliary signal line VX is continuously written into the fifth node N5, and the signal of the fifth node N5 is continuously initialized (reset). The signal of the third reset signal line Reset3 is a high-level signal, the eighth transistor T8 is turned on, the signal of the initial signal line INIT is continuously written into the fourth node N4, and the signal of the fourth node N4 is continuously initialized (reset). The signal of the second scan signal line G2 is a high-level signal, the second transistor T2 is turned on, the signal of the reference signal line REF is continuously provided to the first node N1, the signal of the first light-emitting signal line EM1 is a high-level signal, the fourth transistor T4 is turned on, and the signal of the first power line VDD is written into the third node N3 through the turned-on fourth transistor T4, the second node N2 and the turned-on third transistor T3, until the voltage V3 of the signal of the third node N3 is equal to Vref−Vth, Vref is a voltage value of the signal of the initial signal line REF, Vth is a threshold voltage of the third transistor T3, at this time, the first capacitor C1 stores a voltage difference Vth between the signal of the first node N1 and the signal of the third node N3. The signals of the first scan signal line G1 and the second light-emitting signal line EM2 are low-level signals, and the first transistor T1 and the fifth transistor T5 are turned off. In this phase, the light-emitting device L does not emit light.

A third phase P3 is a data writing phase, the signals of the first reset signal line Reset1, the third reset signal line Reset3 and the first scan signal line G1 are high-level signals, and the signals of the second scan signal line G2, the first light-emitting signal line EM1 and the second light-emitting signal line EM2 are low-level signals, and the data signal line Data outputs the data voltage. The signal of the first reset signal line Reset1 is a high-level signal, the sixth transistor T6 is turned on, the signal of the auxiliary signal line VX is continuously written into the fifth node N5, and the signal of the fifth node N5 is continuously initialized (reset). The signal of the third reset signal line Reset3 is a high-level signal, the eighth transistor T8 is turned on, the signal of the initial signal line INIT is continuously written into the fourth node N4, and the signal of the fourth node N4 is continuously initialized (reset). The signal of the first scan signal line G1 is a high-level signal, the first transistor T1 is turned on, and the data voltage of the data signal line Data is written into the first node N1. At this time, the voltage value V1 of the first node N1 is equal to Vdata, Vdata is a data voltage of the data signal line, and the signal of the first node N1 has a voltage jump from a voltage value of this phase compared to a voltage value of a previous phase. Therefore, under an action of the first capacitor C1 and the second capacitor C2, the signal of the third node N3 also has a voltage jump. At this time, the voltage value V3 of the signal of the third node N3 is equal to Vref−Vth+(Vdata−Vref)*C1/(C1+C2), C1 is a capacitance value of the first capacitor and C2 is a capacitance value of the second capacitor. The signals of the second scan signal line G2, the first light-emitting signal line EM1 and the second light-emitting signal line EM2 are low-level signals, and the second transistor T2, the fourth transistor T4 and the fifth transistor T5 are turned off. In this phase, the light-emitting device L does not emit light.

A fourth phase P4 is referred to as a second reset phase. The signals of the third reset signal line Reset3 and the second light-emitting signal line EM2 are high-level signals, and the signals of the first reset signal line Reset1, the first light-emitting signal line EM1, the first scan signal line G1, and the second scan signal line G2 are low-level signals. The signal of the third reset signal line Reset3 is a high-level signal, the eighth transistor T8 is turned on, and the signal of the initial signal line INIT is continuously written into the fourth node N4, and the signal of the fourth node N4 is continuously initialized (reset). The signal of the second light-emitting signal line EM2 is a high-level signal, the fifth transistor T5 is turned on, and the voltage V3 of the signal of the third node N3 is equal to Vinit, and Vinit is a voltage value of the signal of the initial signal line. At this time, the first node N1 is pulled down under an action of the first capacitor C1, so that the voltage V1 of the signal of the first node N1 is equal to Vdata−[Vref−Vth+(Vdata−Vref)*C1/(C1+C2)]+Vinit. The signals of the first reset signal line Reset1, the first light-emitting signal line EM1, the first scan signal line G1 and the second scan signal line G2 are low-level signals, and the first transistor T1, the second transistor T2, the fourth transistor T4 and the sixth transistor T6 are turned off. In this phase, the light-emitting device L does not emit light.

A fifth phase P5 is a light-emitting phase, the signals of the first light-emitting signal line EM1 and the second light-emitting signal line EM2 are high-level signals, and the signals of the first reset signal line Reset1, the third reset signal line Reset3, the first scan signal line G1 and the second scan signal line G2 are low-level signals. The signals of the first light-emitting signal line EM1 and the second light-emitting signal line EM2 are high-level signals, the fourth transistor T4 and the fifth transistor T5 are turned on, and the power supply voltage output by the first power line VDD provides a driving voltage to the first electrode of the light-emitting device L through the turned-on fourth transistor T4, the third transistor T3 and the fifth transistor T5, to drive the light-emitting device L to emit light, the signal of the first reset signal line Reset1 is a high-level signal, the sixth transistor T6 is turned on, and the voltages of the signals of the third node N3 and the fifth node N5 remain consistent. The signals of the first reset signal line Reset1, the third reset signal line Reset3, the first scan signal line G1 and the second scan signal line G2 are low-level signals, and the first transistor T1, the second transistor T2, the sixth transistor T6 and the eighth transistor T8 are turned off. In this phase, the light-emitting device L emits light.

During a driving process of the pixel driving circuit, the driving current flowing through the third transistor T3 (a driving transistor) is determined by a voltage difference between the control electrode of the third transistor T3 (also the first node N1) and the second electrode (also the third node N3) of the third transistor T3. Because the voltage value V1 of the signal of the first node is equal to Vdata−[Vref−Vth+(Vdata−Vref)*C1/(C1+C2)]+Vinit, and the voltage value V3 of the signal of the third node N3 is equal to Vinit, the driving current of the third transistor T3 is:

I=K*(Vgs−Vth)²=K*[Vdata−[Vref−Vth+(Vdata−Vref)*C1/(C1+C2)]−Vth]²=K*[(C2/(C1+C2))*(Vdata−Vref)]².

Where I is a driving current flowing through the third transistor T3, that is, the driving current for driving the light-emitting device L, K is a constant, and Vgs is a voltage difference between the control electrode of the third transistor T3 and the second electrode of the third transistor T3.

It can be seen from a derivation result of the above current formula that in the light-emitting phase, the driving current of the third transistor T3 is no longer affected by a threshold voltage of the third transistor T3, thereby eliminating the impact of the threshold voltage of the third transistor T3 on the driving current, which may ensure a uniform display brightness of a display product and improve the display effect of the entire display product.

For the pixel driving circuit provided in FIG. 43 and FIG. 44, in the fourth phase and the fifth phase, the second capacitor C2 is disconnected from the third node N3 through the sixth transistor T6 which is turned-off, so that the third node of the pixel driving circuit will not be affected by a coupling effect of the second capacitor C2 in the fifth phase, which may improve the stability of the driving current of the pixel driving circuit and improve the reliability of the pixel driving circuit.

An embodiment of the present disclosure further provides a driving method for a pixel driving circuit, which is configured to drive the pixel driving circuit. The driving method for the pixel driving circuit may include:
Step 100, providing, by a driving sub-circuit, a driving current to a third node under a control of signals of a first node and a second node.
Step 200, providing, by a first control sub-circuit, a signal of a data signal line or a reference signal line to the first node N1 under a control of signals of a first scan signal line and a second scan signal line.
Step 300, providing, by a second control sub-circuit, a signal of a first power line to the second node and providing a signal of the third node to a fourth node under a control of signals of a first light-emitting signal line and a second light-emitting signal line.
Step 400, controlling, by a third control sub-circuit, the signal of the third node under a control of a signal of a first reset signal line and a signal of an auxiliary signal line.
Step 500, storing, by a storage sub-circuit, a voltage difference between the signal of the first node and the signal of the third node.

An embodiment of the present disclosure further provides a driving method of a pixel driving circuit, which is configured to drive the pixel driving circuit provided in FIG. 41. An operating process of the pixel driving circuit includes: a first phase to a fifth phase. The driving method of the pixel driving circuit provided in FIG. 41 may include:
Step 110, in the first phase, valid level signals are provided to the second scan signal line, the second light-emitting signal line, the first reset signal line and the second reset signal line, the first control sub-circuit provides the signal of the reference signal line to the first node, the third control sub-circuit provides the signal of the auxiliary signal line to the fifth node, and provides the signal of the fifth node to the third node, and the second control sub-circuit provides the signal of the fourth node to the third node.
Step 120, in the second phase, valid level signals are provided to the first reset signal line, the second scan signal line and the first light-emitting signal line, the first control sub-circuit provides the signal of the reference signal line to the first node, the third control sub-circuit provides the signal of the auxiliary signal line to the fifth node, the second control sub-circuit provides the signal of the first power line to the second node to charge the first node, and the storage sub-circuit stores the voltage difference between the signal of the first node and the signal of the third node.
Step 130, in the third phase, the signals provided to the first reset signal line and the first scan signal line are high-level signals, the first control sub-circuit provides the signal of the data signal line to the first node, and the third control sub-circuit provides the signal of the auxiliary signal line to the fifth node.
Step 140, in the fourth phase, valid level signals are provided to the second reset signal line and the second light-emitting signal line, the third control sub-circuit provides the signal of the third node to the fifth node, and the second control sub-circuit provides the signal of the fourth node to the third node.
Step 150, in the fifth phase, valid level signals are provided to the second reset signal line, the first light-emitting signal line and the second light-emitting signal line, the second control sub-circuit provides the signal of the first power line to the second node, and provides the signal of the third node to the fourth node, the driving sub-circuit provides a driving current to the third node under control of the signal of the first node and the signal of the second node, and the third control sub-circuit provides the signal of the third node to the fifth node.

An embodiment of the present disclosure further provides a driving method of a pixel driving circuit, which is configured to drive the pixel driving circuit provided in FIG. 42. An operating process of the pixel driving circuit includes: the first phase to the fifth phase. The driving method of the pixel driving circuit provided in FIG. 42 may include:
Step 210, in the first phase, valid level signals are provided to the second scan signal line, the second light-emitting signal line, the first reset signal line and the third reset signal line, the first control sub-circuit provides the signal of the reference signal line to the first node, the third control sub-circuit provides the signal of the auxiliary signal line to the fifth node, and provides the signal of the initial signal line to the fourth node, and the second control sub-circuit provides the signal of the fourth node to the third node;
Step 220, in the second phase, providing valid level signals to the first reset signal line, the third reset signal line, the second scan signal line and the first light-emitting signal line, the first control sub-circuit provides the signal of the reference signal line to the first node, the third control sub-circuit provides the signal of the auxiliary signal line to the fifth node, and provides the signal of the initial signal line to the fourth node, the second control sub-circuit provides the signal of the first power line to the second node to charge the first node, and the storage sub-circuit stores the voltage difference between the signal of the first node and the signal of the third node.
Step 230: in the third phase, the signals provided to the first reset signal line, the third reset signal line and the first scan signal line are high-level signals, the first control sub-circuit provides the signal of the data signal line to the first node, the third control sub-circuit provides the signal of the auxiliary signal line to the fifth node, and provides the signal of the initial signal line to the fourth node.
Step 240: in the fourth phase, valid level signals are provided to the first reset signal line, the third reset signal line and the second light-emitting signal line, the third control sub-circuit provides the signal of the initial signal line to the fourth node, and provides the signal of the auxiliary signal line to the fifth node, the second control sub-circuit provides the signal of the fourth node to the third node.
Step 250: in the fifth phase, valid level signals are provided to the first reset signal line, the first light-emitting signal line and the second light-emitting signal line, the second control sub-circuit provides the signal of the first power line to the second node, and the signal of the third node to the fourth node, the driving sub-circuit provides the driving current to the third node under the control of the signal of the first node and the signal of the second node, and the third control sub-circuit provides the signal of the auxiliary signal line to the fifth node.

An embodiment of the present disclosure further provides a driving method of a pixel driving circuit, which is configured to drive the pixel driving circuit provided in FIG. 39 and FIG. 40. An operating process of the pixel driving circuit includes: a first phase to a fifth phase. The driving method of the pixel driving circuit provided in FIG. 39 and FIG. 40 may include:
Step 310, in the first phase, valid level signals are provided to the second scan signal line, the second light-emitting signal line, the first reset signal line and the third reset signal line, the first control sub-circuit provides the signal of the reference signal line to the first node, the third control sub-circuit provides the signal of the auxiliary signal line to the fifth node, and provides the signal of the initial signal line to the fourth node, and the second control sub-circuit provides the signal of the fourth node to the third node.
Step 320, in the second phase, valid level signals are provided to the first reset signal line, the third reset signal line, the second scan signal line and the first light-emitting signal line, the first control sub-circuit provides a signal of the reference signal line to the first node, the third control sub-circuit provides a signal of the auxiliary signal line to the fifth node, and provides a signal of the initial signal line to the fourth node, the second control sub-circuit provides a signal of the first power line to the second node to charge the first node, and the storage sub-circuit stores the voltage difference between the signal of the first node and the signal of the third node.
Step 330, in the third phase, the signals to the first reset signal line, the third reset signal line and the first scan signal line are high-level signals, the first control sub-circuit provides the signal of the data signal line to the first node, the third control sub-circuit provides the signal of the auxiliary signal line to the fifth node, and provides the signal of the initial signal line to the fourth node.
Step 340, in the fourth phase, the second reset signal line, the third reset signal line and the second light-emitting signal line are provided with valid level signals, the third control sub-circuit provides the signal of the initial signal line to the fourth node, and provides the signal of the third node to the fifth node, and the second control sub-circuit provides the signal of the fourth node to the third node.
Step 350, in the fifth phase, the second reset signal line, the first light-emitting signal line and the second light-emitting signal line are provided with valid level signals, the second control sub-circuit provides the signal of the first power line to the second node, and provides the signal of the third node to the fourth node. The driving sub-circuit provides a driving current to the third node under the control of the signal of the first node and of the signal of the second node, and the third control sub-circuit provides the signal of the third node to the fifth node.

An embodiment of the present disclosure further provides a driving method of a pixel driving circuit, which is configured to drive the pixel driving circuit provided in FIG. 43 and FIG. 44. An operating process of the pixel driving circuit includes: a first phase to a fifth phase. The driving method of the pixel driving circuit provided in FIG. 43 and FIG. 44 may include:
Step 410, in the first phase, the second scan signal line, the second light-emitting signal line, the first reset signal line and the third reset signal line are provided with valid level signals, the first control sub-circuit provides the signal of the reference signal line to the first node, the third control sub-circuit provides the signal of the third node to the fifth node, and provides the signal of the initial signal line to the fourth node, and the second control sub-circuit provides the signal of the fourth node to the third node.
Step 420, in the second phase, valid level signals are provided to the first reset signal line, the third reset signal line, the second scan signal line and the first light-emitting signal line, the first control sub-circuit provides the signal of the reference signal line to the first node, the third control sub-circuit provides the signal of the third node to the fifth node, and provides the signal of the initial signal line to the fourth node, the second control sub-circuit provides the signal of the first power line to the second node to charge the first node, and the storage sub-circuit stores the voltage difference between the signal of the first node and the signal of the third node.
Step 430, in the third phase, the signals provided to the first reset signal line, the third reset signal line and the first scan signal line are high-level signals, the first control sub-circuit provides the signal of the data signal line to the first node, the third control sub-circuit provides the signal of the initial signal line to the fourth node, and provides the signal of the third node to the fifth node.
Step 440: in the fourth phase, valid level signals are provided to the third reset signal line and the second light-emitting signal line, the third control sub-circuit provides the signal of the initial signal line to the fourth node, and the second control sub-circuit provides the signal of the fourth node to the third node.
Step 450: in the fifth phase, valid level signals are provided to the first light-emitting signal line and the second light-emitting signal line, the second control sub-circuit provides the signal of the first power line to the second node, and provides the signal of the third node to the fourth node. The driving sub-circuit provides a driving current to the third node under the control of the signal of the first node and the signal of the second node.

At least one embodiment of the present disclosure further provides a display apparatus, which includes a pixel circuit provided by any embodiment of the present disclosure. The display apparatus may be, for example, an organic light-emitting diode display apparatus, a quantum-dot light-emitting diode display apparatus, or other types of apparatuses with display functions. The embodiments of the present disclosure do not limit this.

Other structures and functions of the display apparatus provided by the embodiments of the present disclosure may be implemented with reference to conventional technologies, and the embodiments of the present disclosure are not limited thereto. For technical effects of the display apparatus provided by the embodiments of the present disclosure, please refer to the above description of the technical effects of the pixel circuit provided by the embodiments of the present disclosure, which will not be repeated here.

For example, the display apparatus provided by at least one embodiment of the present disclosure may be a display panel, a mobile phone, a tablet computer, a television, a display, a laptop, a digital photo frame, a navigator, or any other product or component with a display function, and the embodiments of the present disclosure do not limit this.

For example, the display apparatus provided by the embodiments of the present disclosure has a display region, and the display region is provided with a plurality of pixel driving circuits.

In an exemplary embodiment, the display apparatus may include a timing controller, a data driver, a scan driver, a light-emitting driver, and a pixel array, the timing controller is connected to the data driver respectively, the scan driver, and the light-emitting driver, the data driver is connected to a plurality of data signal lines respectively, the scan driver is connected to a plurality of scan signal lines respectively, and the light-emitting driver is connected to a plurality of light-emitting signal lines respectively. The pixel array may include a plurality of sub-pixels, at least one sub-pixel may include a circuit unit and a light-emitting device connected to the circuit unit, the circuit unit may include a pixel driving circuit, and the pixel driving circuit may be respectively connected to the scan signal line, the light-emitting signal line, and the data signal line.

The scan signal line includes: a first scan signal line, a second scan signal line, a first reset signal line, a second reset signal line, and a third reset signal line. The light-emitting signal line includes: a first light-emitting signal line and a second light-emitting signal line.

In an exemplary implementation, the timing controller may provide a grayscale value and a control signal suitable for a specification of the data driver to the data driver, provide a clock signal, a scan start signal, and the like suitable for a specification of the scan driver to the scan driver, and provide a clock signal, an emission stop signal, and the like suitable for a specification of the light-emitting driver to the light-emitting driver.

In an exemplary implementation, the data driver may generate a data voltage to be provided to the data signal line using the grayscale value and the control signal received from the timing controller. For example, the data driver may sample the grayscale value using the clock signal, and apply the data voltage corresponding to the grayscale value to the data signal line in units of pixel rows.

In an exemplary implementation, the scan driver may generate a scan signal to be provided to the scan signal line by receiving a clock signal, a scan start signal, and the like from the timing controller. For example, the scan driver may sequentially provide a scan signal having a turn-on level pulse to the scan signal line. For example, the scan driver may be constructed in a form of a shift register, and may generate a scan signal by sequentially transmitting a scan start signal provided in a form of a turn-on level pulse to a next-level circuit under control of a clock signal.

In an exemplary implementation, the light-emitting driver may generate an emission signal to be provided to the light-emitting signal line by receiving a clock signal, an emission stop signal and the like from a timing controller. For example, the light-emitting driver may sequentially provide an emission signal having a turn-off level pulse to the light-emitting signal line. For example, the light-emitting driver may be constructed in the form of a shift register, and may generate an emission signal by sequentially transmitting an emission stop signal provided in a form of an turn-off level pulse to a next-level circuit under the control of a clock signal.

In an exemplary implementation, the display substrate may include a plurality of pixel units P arranged in a matrix, at least one of the plurality of pixel units P includes a first sub-pixel emitting a first color light, a second sub-pixel emitting a second color light, and a third sub-pixel emitting a third color light, and the first sub-pixel, the second sub-pixel, and the third sub-pixel each include a pixel driving circuit and a light-emitting device. The pixel driving circuits in the first sub-pixel, the second sub-pixel, and the third sub-pixel are respectively connected to the scan signal line, the data signal line, and the light-emitting signal line, and the pixel driving circuit is configured to receive a data voltage transmitted by the data signal line under a control of the scan signal line and the light-emitting signal line, and output a corresponding current to the light-emitting device. The light-emitting devices in the first sub-pixel, the second sub-pixel, and the third sub-pixel are respectively connected to the pixel driving circuits of the sub-pixels, and the light-emitting device is configured to emit light of corresponding brightness in response to the current output by the pixel driving circuit of the sub-pixel.

In an exemplary implementation, the first sub-pixel may be a red sub-pixel (R) emitting red light, the second sub-pixel may be a blue sub-pixel (B) emitting blue light, and the third sub-pixel may be a green sub-pixel (G) emitting green light. In an exemplary implementation, a shape of the sub-pixel may be rectangular, rhombus, pentagonal, or hexagonal.

In an exemplary implementation, the pixel unit may include three sub-pixels, and the three sub-pixels may be arranged in a horizontal parallel, a vertical parallel or in a square manner, etc., which is not limited in the present disclosure.

In an exemplary implementation, the pixel unit may include four sub-pixels, and the four sub-pixels may be arranged in a horizontal parallel, a vertical parallel or a square manner, etc., which is not limited in the present disclosure.

On a plane perpendicular to the display substrate, the display substrate may include a driving structure layer arranged on a substrate, a light-emitting structure layer arranged on a side of the driving structure layer away from the substrate, and an encapsulation structure layer arranged on a side of the light-emitting structure layer away from the substrate. In some possible implementations, the display substrate may include other film layers, such as a touch structure layer, etc., which is not limited in the present disclosure.

In an exemplary implementation, the substrate may be a rigid substrate or a flexible substrate, the rigid substrate may be, but not limited to, one or more of glass and conductive foil; the flexible substrate may be, but not limited to, one or more of polyethylene terephthalate, ethylene glycol terephthalate, polyether ether ketone, polystyrene, polycarbonate, polyarylate, polyarylester, polyimide, polyvinyl chloride, polyethylene, and textile fiber.

In an exemplary implementation, the driving structure layer may include a plurality of transistors and storage capacitors constituting a pixel driving circuit, and the light-emitting structure layer may include an anode, a pixel definition layer, an organic light-emitting layer and a cathode, the anode is connected to a drain electrode of the transistor through a via hole, the organic light-emitting layer is connected to the anode, and the cathode is connected to the organic light-emitting layer, and the organic light-emitting layer emits light of corresponding colors driven by the anode and the cathode.

In an exemplary implementation, the encapsulation structure layer may include a first encapsulation layer, a second encapsulation layer and a third encapsulation layer stacked on each other, the first encapsulation layer and the third encapsulation layer may be made of inorganic materials, and the second encapsulation layer may be made of organic materials, and the second encapsulation layer is arranged between the first encapsulation layer and the third encapsulation layer, so as to ensure that external water vapor cannot enter the light-emitting structure layer.

In an exemplary implementation, a touch structure layer may include a first touch insulating layer disposed on the encapsulation structure layer, a first touch metal layer disposed on the first touch insulating layer, a second touch insulating layer covering the first touch metal layer, a second touch metal layer disposed on the second touch insulating layer, and a touch protection layer covering the second touch metal layer, the first touch metal layer may include a plurality of bridging electrodes, the second touch metal layer may include a plurality of first touch electrodes and second touch electrodes, and the first touch electrode or the second touch electrode may be connected to the bridging electrode through a via hole.

The drawings of the embodiments of the present disclosure only relate to the structures involved in the embodiments of the present disclosure, and for other structures, please refer to a general design.

To ensure clarity, in the accompanying drawings used to describe the embodiments of the present disclosure, thickness and dimensions of the layers or microstructures are exaggerated. It should be understood that when an element such as a layer, a film, a region or a substrate is referred to as being “on” or “under” another element, the element may be “directly” “on” or “under” another element, or there may be an intermediate element.

Proportions of the drawings in the present disclosure may be used as a reference for actual processes, but are not limited thereto. For example, a width-to-length ratio of the channel, a thickness and spacing of each film layer, a width and spacing of each signal line, may be adjusted according to actual needs. A quantity of pixels in the display substrate and a quantity of sub-pixels in each pixel are not limited to quantities shown in the drawings. The drawings described in the present disclosure are only structural schematic diagrams, and one method of the present disclosure is not limited to the shape or value shown in the drawings.

Ordinal numbers such as “first”, “second”, and “third” in this specification are set to avoid confusion among components and are not intended to limit quantities.

In this specification, for convenience, terms indicating the orientation or positional relationships such as “middle”, “upper”, “lower”, “front”, “back”, “vertical”, “horizontal”, “top”, “bottom”, “inner”, “outer” and the like are used to illustrate the positional relationships of the components with reference to the drawings. These terms are solely for purpose of describing the specification and simplifying the description, and do not imply or suggest that the indicated apparatus or component must have a specific orientation, or be constructed and operated in a specific orientation, so it cannot be understood as a limitation of this present disclosure. The positional relationships of components may change depending on the described orientation of each component. Thus, the terms used in the specification are not limitative and may be replaced or adjusted as appropriate according to specific circumstances.

In this specification, unless otherwise clearly specified and limited, terms “install”, “connect” and “link” should be understood in a broad sense. For example, it may be a fixed connection, or a detachable connection, or an integral connection; it may be a mechanical connection, or an electrical connection; it may be a direct connection, or an indirect connection through an intermediate, or a communicative connection between two elements. For a person of ordinary skill in the art, specific meanings of the above terms in this disclosure may be understood according to specific circumstances.

In this specification, a transistor refers to an element including at least three terminals: a gate electrode, a drain electrode and a source electrode. The transistor has a channel region between the drain electrode (a drain electrode terminal, a drain region or a drain electrode) and the source electrode (a source electrode terminal, a source region or a source electrode), and current can flow through the drain electrode, the channel region and the source electrode. Note that in this specification, the channel region refers to a region where the current mainly flows.

In this specification, “electrical connection” includes a case where components are connected together through an element having a certain electrical function. “Elements having a certain electrical function” are not particularly limited as long as they can transmit and receive electrical signals between the connected components. Examples of “elements having a certain electrical function” include not only electrodes and wirings, but also a switching element such as a transistor, a resistor, an inductor, a capacitor, and other elements having various functions.

In this specification, “arranged on a same layer” used refers to a structure formed by patterning two (or more) structures through a same patterning process, and these structures may be made of same or different materials. For example, materials of precursors used to form multiple structures arranged on the same layer may be the same, while final materials may either be same or different.

Although the implementations disclosed in the present disclosure are as described above, the contents described are only embodiments adopted to facilitate understanding of the present disclosure and are not intended to limit the present disclosure. Any modifications or variations in the form and details of implementation made by those skilled in the art, without departing from the spirit and scope of the disclosure, are considered to fall within the scope of the present disclosure, but the scope of patent protection of the present disclosure shall still be subject to the scope defined by the appended claims.

There are the following points to be clarified:
(1) The accompanying drawings of the embodiments of the present disclosure relate only to the structures involved with the embodiments of the present disclosure, and other structures can be referred to the usual design.
(2) Features in the same embodiment and different embodiments of the present disclosure may be combined with each other without conflict.

The foregoing is only an exemplary embodiment of the present disclosure and is not intended to limit the scope of protection of the present disclosure, which is determined by the appended rights.

1. A pixel circuit, comprising:
a driving circuit, comprising a control terminal, a first terminal and a second terminal, and configured to control a magnitude of a driving current flowing through the first terminal and the second terminal;
a first compensation circuit, configured to apply a reference signal to the control terminal of the driving circuit in response to a first compensation control signal, the first compensation circuit comprising a first storage capacitor, a first electrode of the first storage capacitor being electrically connected to the control terminal of the driving circuit, and a second electrode of the first storage capacitor being electrically connected to the first terminal of the driving circuit;
a light-emitting element, configured to emit light driven by the driving current, a second electrode of the light-emitting element being electrically connected to a second voltage terminal to receive a second power supply voltage;
a second light-emitting control circuit, wherein a control terminal of the second light-emitting control circuit is configured to receive a second light-emitting control signal, a first terminal of the second light-emitting control circuit is electrically connected to the first terminal of the driving circuit, a second terminal of the second light-emitting control circuit is electrically connected to a first electrode of the light-emitting element, and the second light-emitting control circuit is configured to apply the driving current to the light-emitting element in response to the second light-emitting control signal and allow a reset signal to be applied to the first terminal of the driving circuit; and
a reset control circuit, wherein a control terminal of the reset control circuit is configured to receive a reset control signal, a first terminal of the reset control circuit is electrically connected to the first terminal of the driving circuit, a second terminal of the reset control circuit is electrically connected to a reset signal terminal to receive the reset signal, a third terminal of the reset control circuit is electrically connected to the first electrode of the light-emitting element, and the reset control circuit is configured to apply the reset signal to the first electrode of the light-emitting element and/or the first terminal of the driving circuit in response to the reset control signal.

2. The pixel circuit according to claim 1, wherein the reset control circuit comprises:
a second compensation circuit, comprising a second storage capacitor, wherein the second storage capacitor is electrically connected between the first terminal of the driving circuit and the reset signal terminal; and
a reset circuit, wherein a control terminal of the reset circuit serves as the control terminal of the reset control circuit and is configured to receive the reset control signal, a first terminal of the reset circuit serves as the third terminal of the reset control circuit and is electrically connected to the first electrode of the light-emitting element, and a second terminal of the reset circuit serves as the second terminal of the reset control circuit and is electrically connected to the reset signal terminal to receive the reset signal.

3. The pixel circuit according to claim 1, wherein a value of the reset signal is adjustable.

4. The pixel circuit according to claim 3, wherein the reset signal comprises at least a first reset signal and a second reset signal, the first reset signal corresponds to a in first display temperature, the second reset signal corresponds to a second display temperature, the first display temperature is lower than the second display temperature, and a value of the first reset signal is lower than a value of the second reset signal,
the first reset signal is adjusted to the second reset signal during a reset signal adjustment period, and the pixel circuit corresponds to a plurality of display frame cycles,
the reset signal adjustment period is located between two adjacent display frame cycles of the plurality of display frame cycles; or
the reset signal adjustment period is within one display frame cycle of the plurality of display frame cycles; the one display frame cycle comprises at least a reset phase, a compensation phase, a data writing phase and a light-emitting phase; and the reset signal adjustment period overlaps at least partially or does not overlap with any one selected from a group consisting of the reset phase, the compensation phase, the data writing phase and the light-emitting phase.

5. (canceled)

6. The pixel circuit according to claim 1, wherein a value of the reference signal is adjustable.

7. The pixel circuit according to claim 2, wherein a first electrode of the second storage capacitor serves as the first terminal of the reset control circuit and is electrically connected to the first terminal of the driving circuit, and a second electrode of the second storage capacitor is electrically connected to the first terminal of the reset circuit,
the pixel circuit further comprises a first light-emitting control circuit, a control terminal of the first light-emitting control circuit is configured to receive a first light-emitting control signal, a first terminal of the first light-emitting control circuit is electrically connected to the second terminal of the driving circuit, a second terminal of the first light-emitting control circuit is electrically connected to a first voltage terminal to receive a first power supply voltage, and the first light-emitting control circuit is configured to apply the first power supply voltage to the second terminal of the driving circuit in response to the first light-emitting control signal.

8-9. (canceled)

10. The pixel circuit according to claim 2, wherein the second terminal of the driving circuit is directly electrically connected to a first voltage terminal to receive a first power supply voltage.

11. The pixel circuit according to claim 7, wherein the reset circuit comprises a reset transistor, a gate electrode of the reset transistor is electrically connected to a reset control terminal to receive the reset control signal, a first electrode of the reset transistor is electrically connected to the second electrode of the second storage capacitor and the first terminal of the driving circuit, and a second electrode of the reset transistor is electrically connected to the reset signal terminal to receive the reset signal,
the second light-emitting control circuit comprises a second light-emitting control transistor, a gate electrode of the second light-emitting control transistor is electrically connected to a second light-emitting control terminal to receive the second light-emitting control signal, a first electrode of the second light-emitting control transistor is electrically connected to the first terminal of the driving circuit, and a second electrode of the second light-emitting control transistor is electrically connected to the first electrode of the light-emitting element.

12. (canceled)

13. The pixel circuit according to claim 11, wherein the pixel circuit further comprises an auxiliary compensation circuit, a control terminal of the auxiliary compensation circuit is configured to receive an auxiliary compensation control signal, a first terminal of the auxiliary compensation circuit is electrically connected to the second electrode of the second storage capacitor, and a second terminal of the auxiliary compensation circuit is electrically connected to the first electrode of the light-emitting element.

14. The pixel circuit according to claim 13, wherein the first terminal of the auxiliary compensation circuit is also electrically connected to the second terminal of the second light-emitting control circuit and the first terminal of the reset circuit.

15. The pixel circuit according to claim 14, wherein the auxiliary compensation circuit comprises an auxiliary compensation transistor, a gate electrode of the auxiliary compensation transistor serves as the control terminal of the auxiliary compensation circuit to receive the auxiliary compensation control signal, a first electrode of the auxiliary compensation transistor is electrically connected to the second electrode of the second storage capacitor and the second electrode of the second light-emitting control transistor, and a second electrode of the auxiliary compensation transistor is electrically connected to the first electrode of the light-emitting element,
the gate electrode of the auxiliary compensation transistor is electrically connected to the gate electrode of the second light-emitting control transistor, the auxiliary compensation transistor and the second light-emitting control transistor share a gate electrode, the second light-emitting control signal serves as the auxiliary compensation control signal, and a type of the auxiliary compensation transistor is same as a type of the second light-emitting control transistor; or
the gate electrode of the auxiliary compensation transistor and the gate electrode of the second light-emitting control transistor are independent of each other and not electrically connected.

16. The pixel circuit according to claim 13, wherein the first terminal of the auxiliary compensation circuit is also electrically connected to the first terminal of the reset circuit, and the second terminal of the auxiliary compensation circuit is also electrically connected to the second terminal of the second light-emitting control circuit.

17. The pixel circuit according to claim 16, wherein the auxiliary compensation circuit comprises an auxiliary compensation transistor, a gate electrode of the auxiliary compensation transistor is electrically connected to an auxiliary compensation control terminal to receive the auxiliary compensation control signal, a first electrode of the auxiliary compensation transistor is electrically connected to the second electrode of the second storage capacitor and the first electrode of the reset transistor, and a second electrode of the auxiliary compensation transistor is electrically connected to the first electrode of the light-emitting element,
the gate electrode of the auxiliary compensation transistor is electrically connected to the gate electrode of the reset transistor, the auxiliary compensation transistor and the reset transistor share a gate electrode, the reset control signal serves as the auxiliary compensation control signal, and a type of the auxiliary compensation transistor is same as a type of the reset transistor; or
the gate electrode of the auxiliary compensation transistor and the gate electrode of the reset transistor are independent of each other and not electrically connected.

18-19. (canceled)

20. The pixel circuit according to claim 2, wherein the driving circuit comprises a driving transistor, a gate electrode of the driving transistor serves as the control terminal of the driving circuit and is electrically connected to a first node, a first electrode of the driving transistor serves as the first terminal of the driving circuit and is electrically connected to a first electrode of the second storage capacitor at a second node, and a second electrode of the driving transistor serves as the second terminal of the driving circuit and is electrically connected to a first voltage terminal to receive a first power supply voltage;
the pixel circuit further comprises: a data writing circuit, a control terminal of the data writing circuit is configured to receive a data scanning signal, a first terminal of the data writing circuit is electrically connected to a data signal terminal to receive a data signal, a second terminal of the data writing circuit is electrically connected to the first node, and the data writing circuit is configured to write the data signal to the control terminal of the driving circuit in response to the data scanning signal,
a control terminal of the first compensation circuit is configured to receive the first compensation control signal, a first terminal of the first compensation circuit is electrically connected to a reference signal terminal to receive the reference signal, and a second terminal of the first compensation circuit is electrically connected to the second node,
wherein, the first compensation circuit further comprises a first compensation transistor, a gate electrode of the first compensation transistor serves as the control terminal of the first compensation circuit and is electrically connected to a first compensation control signal terminal to receive the first compensation control signal, a first electrode of the first compensation transistor serves as the first terminal of the first compensation circuit and is electrically connected to the reference signal terminal to receive the reference signal, and a second electrode of the first compensation transistor is electrically connected to the first node,
the data writing circuit comprises a data writing transistor, a gate electrode of the data writing transistor is electrically connected to a data scanning signal terminal to receive the data scanning signal, a first electrode of the data writing transistor is electrically connected to the data signal terminal to receive the data signal, and a second electrode of the data writing transistor is electrically connected to the first node,
the data writing transistor and the first compensation transistor are transistors controlled independently of each other, the data scanning signal terminal and the first compensation control signal terminal are different signal terminals independent of each other, and the data signal terminal and the reference signal terminal are different signal terminals independent of each other; or
the data writing transistor also serves the first compensation transistor, the data scanning signal also serves as the first compensation control signal, the first electrode of the data writing transistor is also electrically connected to the reference signal terminal to receive the reference signal, and the data signal terminal also serves the reference signal terminal and is configured to provide the data signal or the reference signal in different time periods.

21-22. (canceled)

23. A display apparatus, comprising a pixel circuit, wherein the pixel circuit comprises:
a driving circuit, comprising a control terminal, a first terminal and a second terminal, and configured to control a magnitude of a driving current flowing through the first terminal and the second terminal;
a first compensation circuit, configured to apply a reference signal to the control terminal of the driving circuit in response to a first compensation control signal, the first compensation circuit comprising a first storage capacitor, a first electrode of the first storage capacitor being electrically connected to the control terminal of the driving circuit, and a second electrode of the first storage capacitor being electrically connected to the first terminal of the driving circuit;
a light-emitting element, configured to emit light driven by the driving current, a second electrode of the light-emitting element being electrically connected to a second voltage terminal to receive a second power supply voltage;
a second light-emitting control circuit, wherein a control terminal of the second light-emitting control circuit is configured to receive a second light-emitting control signal, a first terminal of the second light-emitting control circuit is electrically connected to the first terminal of the driving circuit, a second terminal of the second light-emitting control circuit is electrically connected to a first electrode of the light-emitting element, and the second light-emitting control circuit is configured to apply the driving current to the light-emitting element in response to the second light-emitting control signal and allow a reset signal to be applied to the first terminal of the driving circuit; and
a reset control circuit, wherein a control terminal of the reset control circuit is configured to receive a reset control signal, a first terminal of the reset control circuit is electrically connected to the first terminal of the driving circuit, a second terminal of the reset control circuit is electrically connected to a reset signal terminal to receive the reset signal, a third terminal of the reset control circuit is electrically connected to the first electrode of the light-emitting element, and the reset control circuit is configured to apply the reset signal to the first electrode of the light-emitting element and/or the first terminal of the driving circuit in response to the reset control signal.

24. A driving method for a pixel circuit, applicable to a pixel circuit, wherein the pixel circuit comprises:
a driving circuit, comprising a control terminal, a first terminal and a second terminal, and configured to control a magnitude of a driving current flowing through the first terminal and the second terminal;
a first compensation circuit, configured to apply a reference signal to the control terminal of the driving circuit in response to a first compensation control signal, the first compensation circuit comprising a first storage capacitor, a first electrode of the first storage capacitor being electrically connected to the control terminal of the driving circuit, and a second electrode of the first storage capacitor being electrically connected to the first terminal of the driving circuit;
a light-emitting element, configured to emit light driven by the driving current, a second electrode of the light-emitting element being electrically connected to a second voltage terminal to receive a second power supply voltage;
a second light-emitting control circuit, wherein a control terminal of the second light-emitting control circuit is configured to receive a second light-emitting control signal, a first terminal of the second light-emitting control circuit is electrically connected to the first terminal of the driving circuit, a second terminal of the second light-emitting control circuit is electrically connected to a first electrode of the light-emitting element, and the second light-emitting control circuit is configured to apply the driving current to the light-emitting element in response to the second light-emitting control signal and allow a reset signal to be applied to the first terminal of the driving circuit; and
a reset control circuit, wherein a control terminal of the reset control circuit is configured to receive a reset control signal, a first terminal of the reset control circuit is electrically connected to the first terminal of the driving circuit, a second terminal of the reset control circuit is electrically connected to a reset signal terminal to receive the reset signal, a third terminal of the reset control circuit is electrically connected to the first electrode of the light-emitting element, and the reset control circuit is configured to apply the reset signal to the first electrode of the light-emitting element and/or the first terminal of the driving circuit in response to the reset control signal,
the driving method comprises:
setting the reset control signal as an On signal so that the reset signal is applied to the first electrode of the light-emitting element and/or the first terminal of the driving circuit through the reset control circuit.

25. The driving method of the pixel circuit according to claim 24, wherein the reset control circuit comprises a second compensation circuit and a reset circuit, and the second compensation circuit comprises a second storage capacitor, wherein a first electrode of the second storage capacitor serves as the first terminal of the reset control circuit and is electrically connected to the first terminal of the driving circuit, and a second electrode of the second storage capacitor is electrically connected to a first terminal of the reset circuit; a control terminal of the reset circuit serves as the control terminal of the reset control circuit and is configured to receive the reset control signal, a first terminal of the reset circuit serves as the third terminal of the reset control circuit and is electrically connected to the first electrode of the light-emitting element, a second terminal of the reset circuit serves as the second terminal of the reset control circuit and is electrically connected to the reset signal terminal to receive the reset signal,
the driving method comprises a reset phase, a compensation phase, a data writing phase and a light-emitting phase,
in the reset phase, the reset control signal is set to be an ON signal in at least part of a time period so that the first terminal and the second terminal of the reset circuit are turned on, and the reset signal is applied to the second electrode of the second storage capacitor, the first terminal of the driving circuit and the first electrode of the light-emitting element through the second terminal and the first terminal of the reset circuit in sequence;
in the compensation phase and the data writing phase, the reset control signal is set to be an ON signal, and the reset signal is applied to the second electrode of the second storage capacitor and the first electrode of the light-emitting element through the second terminal and the first terminal of the reset circuit in sequence; and
in the light-emitting phase, the reset control signal is set to be an OFF signal in at least part of a time period of the light-emitting phase, so that the second electrode of the second storage capacitor is electrically disconnected from the reset signal terminal.

26. The driving method of the pixel circuit according to claim 25, wherein the pixel circuit further comprises a data writing circuit and a first light-emitting control circuit; a control terminal of the data writing circuit is configured to receive a data scanning signal, a first terminal of the data writing circuit is electrically connected to a data signal terminal to receive a data signal, and a second terminal of the data writing circuit is electrically connected to the control terminal of the driving circuit; a control terminal of the first light-emitting control circuit is configured to receive a first light-emitting control signal, a first terminal of the first light-emitting control circuit is electrically connected to the second terminal of the driving circuit, and a second terminal of the first light-emitting control circuit is electrically connected to a first voltage terminal so that the second terminal of the driving circuit receives a first power supply voltage;
in the light-emitting phase, the driving method comprises sequentially performing steps S101 to S104:
step S101: setting the data scanning signal as an OFF signal to turn off the data writing circuit;
step S102: setting the second light-emitting control signal to an ON signal to turn on the second light-emitting control circuit, and keeping the first light-emitting control signal as an OFF signal to turn off the first light-emitting control circuit; and
step S104: setting the first light-emitting control signal to an ON signal to turn on the first light-emitting control circuit, so that the second terminal of the driving circuit receives the first power supply voltage from the first voltage terminal through the first light-emitting control circuit,
wherein in the compensation phase, the driving method comprises sequentially performing steps S2010 to S2020:
step S2010: setting the second light-emitting control signal as an OFF signal to turn off the second light-emitting control circuit, and keeping the first light-emitting control signal as an OFF signal to turn off the first light-emitting control circuit; and
step S2020: setting the first light-emitting control signal as an ON signal to turn on the first light-emitting control circuit, and keeping the second light-emitting control signal as an OFF signal;
and, in the compensation phase, the data scanning signal remains as an OFF signal to keep the data writing circuit turned off, and the first compensation control signal remains as an ON signal to keep the first compensation circuit turned on.

27. The driving method of the pixel circuit according to claim 25, wherein
the pixel circuit further comprises a data writing circuit and a first light-emitting control circuit; a control terminal of the data writing circuit is configured to receive a data scanning signal, a first terminal of the data writing circuit is electrically connected to a data signal terminal to receive a data signal, and a second terminal of the data writing circuit is electrically connected to the control terminal of the driving circuit; a control terminal of the first light-emitting control circuit is configured to receive a first light-emitting control signal, a first terminal of the first light-emitting control circuit is electrically connected to the second terminal of the driving circuit, and a second terminal of the first light-emitting control circuit is electrically connected to a first voltage terminal so that the second terminal of the driving circuit receives a first power supply voltage;
in the reset phase, the driving method comprises sequentially performing steps S1010 to S1030:
step S1010: electrically disconnecting the second terminal of the driving circuit from the first voltage terminal;
step S1020: setting the reset control signal as an ON signal to turn on the reset circuit; and
step S1030: setting the first compensation control signal as an ON signal to turn on the first compensation circuit,
and, in the reset phase, the data scanning signal remains as an OFF signal to turn off the data writing circuit, and the second light-emitting control signal remains as an ON signal to turn on the second light-emitting control circuit.

28. (canceled)

29. The driving method of the pixel circuit according to claim 25, wherein the pixel circuit further comprises a data writing circuit, a control terminal of the data writing circuit is configured to receive a data scanning signal, a first terminal of the data writing circuit is electrically connected to a data signal terminal to receive a data signal, and a second terminal of the data writing circuit is electrically connected to the control terminal of the driving circuit,
wherein, in the data writing phase, the driving method comprises sequentially performing steps S3010 to S3030:
step S3010: setting the first compensation control signal as an OFF signal to turn off the first compensation circuit, and keeping the second terminal of the driving circuit receiving a first power supply voltage; and
step S3030: setting the data scanning signal as an ON signal to turn on the data writing circuit,
wherein, in the data writing phase, the second light-emitting control signal remains as an OFF signal to keep the second light-emitting control circuit turned off,
the pixel circuit further comprises a first light-emitting control circuit, a control terminal of the first light-emitting control circuit is configured to receive a first light-emitting control signal, a first terminal of the first light-emitting control circuit is electrically connected to the second terminal of the driving circuit, and a second terminal of the first light-emitting control circuit is electrically connected to a first voltage terminal so that the second terminal of the driving circuit receives a first power supply voltage; and
the step S3030 further comprises: setting the first light-emitting control signal as an ON signal to turn on the first light-emitting control circuit, so that the second terminal of the driving circuit receives the first power supply voltage.

30. (canceled)
